(19) United States
(12) Patent Application Publication
(10) Pub. No.: US 2025/0265581 A1
(43) Pub. Date: Aug. 21, 2025

(54) SECURE CONDITIONAL TRANSFERS OF CRYPTOGRAPHIC KEY DATA AND/OR DIGITAL ASSETS

(71) Applicant: Block, Inc., Oakland, CA (US)

(72) Inventors: Alexander Schoof, Leesburg, VA (US); Arvin Aminpour, New York, NY (US); Thomas Aaron Kilbride, Seattle, WA (US); Maxwell James Vandervelde, Columbia Heights, MN (US); Undine Rubeze, London (GB)

(21) Appl. No.: 19/202,649

(22) Filed: May 8, 2025

Related U.S. Application Data
(63) Continuation-in-part of application No. 18/501,876, filed on Nov. 3, 2023.
Application No. 18/501,876 is a continuation-in-part of application No. 18/223,486, filed on Jul. 18, 2023.
(60) Provisional application No. 63/392,208, filed on Jul. 26, 2022.

(51) Int. Cl. G06Q 20/38; G06Q 20/40; G06Q 40/02; H04L 9/08

(52) U.S. Cl. CPC G06Q 20/3829; G06Q 20/401; G06Q 40/02; H04L 9/0825; G06Q 2220/00

(57) ABSTRACT

Systems and methods for cryptographic key transfer are disclosed. A system receives an encrypted private key that is encrypted using a private key encryption key. The system receives an encrypted private key encryption key that is encrypted using a trusted contact encryption key. The system receives an indication that a condition is satisfied. The system sends the encrypted private key and the encrypted private key encryption key to a transferee device. The system receives, from the transferee device, a request for a transfer of funds. The request is signed using a private key, the private key having been decrypted from the encrypted private key using the private key encryption key, the private key encryption key having been decrypted from the encrypted private key encryption key using a trusted contact decryption key corresponding to the trusted contact encryption key. The system facilitates the transfer of funds in response to the request.

### CROSS-REFERENCE TO RELATED APPLICATIONS

This application claims priority to and is a Continuation-in-Part of U.S. patent application Ser. No. 18/501,876, filed on Nov. 3, 2023, entitled “Conditional Transfers of Digital Assets,” which is a Continuation-in-Part of U.S. patent application Ser. No. 18/223,486, filed on Jul. 18, 2023, entitled “Methods and Systems for Managing Cryptocurrency,” which claims the benefit of, and priority to, U.S. Provisional Patent Application No. 63/392,208, filed Jul. 26, 2022, entitled “Cryptocurrency Management Systems and Methods,” the full disclosures of which are expressly incorporated herein by reference in their entireties.

### TECHNICAL FIELD

Cryptocurrency, such as Bitcoin, is increasing in popularity and has many advantages. In this regard, cryptocurrency provides a digital form of currency that may be transferred from one party to another through a global computer network, such as the Internet, thereby facilitating the storage and transfer of financial assets for financial transactions. This digital nature allows cryptocurrency to provide numerous benefits not possible through more traditional currency. However, the digital nature of cryptocurrency also raises unique challenges. For example, the use of cryptographic keys to access and control cryptocurrency assets may involve users maintaining and storing these keys. This may cause increased complexity to users and may increase the possibility a user loses access to their cryptocurrency assets through loss of their stored cryptographic keys. Additionally, storage of these cryptographic keys may also raise the possibility of malicious actors gaining access to a user's stored cryptographic keys and subsequently stealing the user's cryptocurrency assets.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A is a block diagram of an exemplary cryptocurrency management system, in accordance with some examples.

FIG. 3B is another block diagram illustrating additional features of the exemplary cryptocurrency management system, in accordance with some examples.

FIG. 2 is a flowchart of an exemplary method of using social recovery, in accordance with some examples.

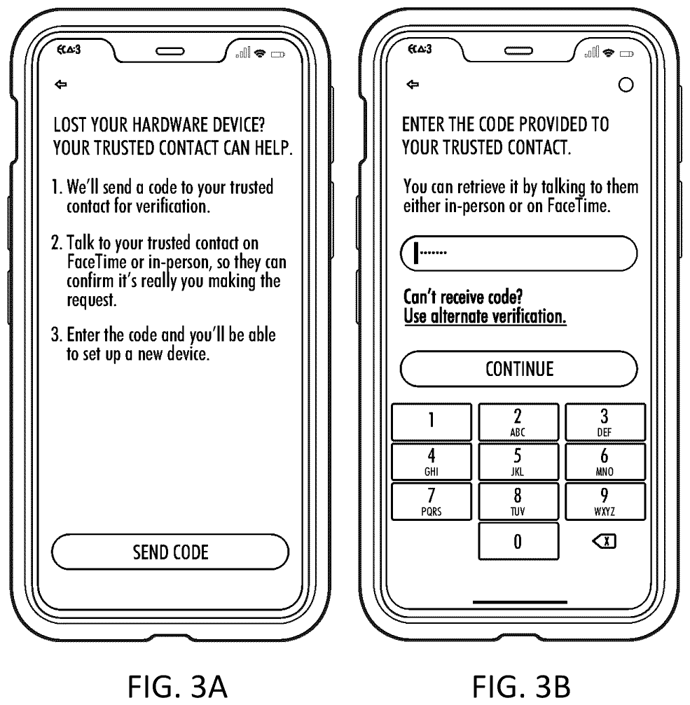

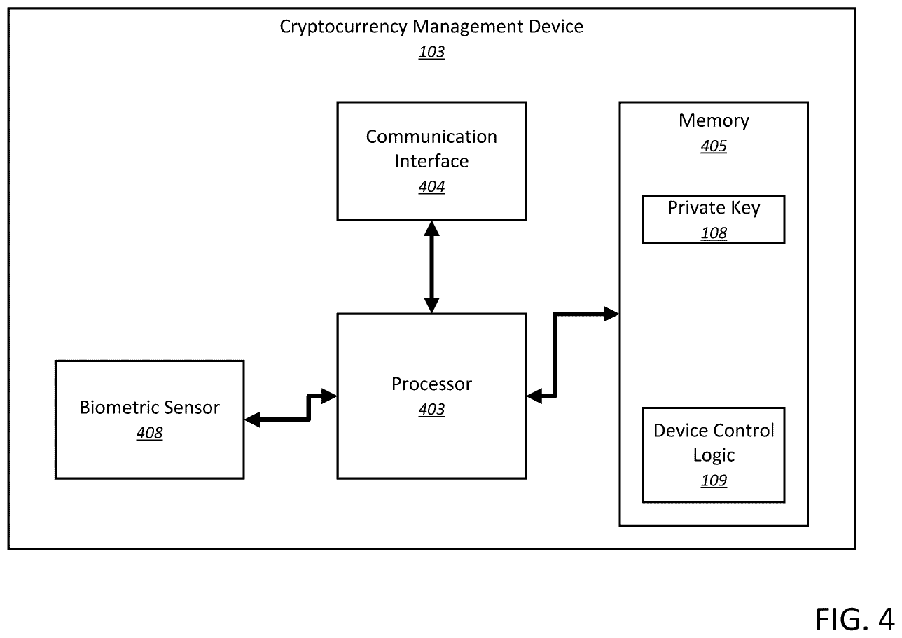

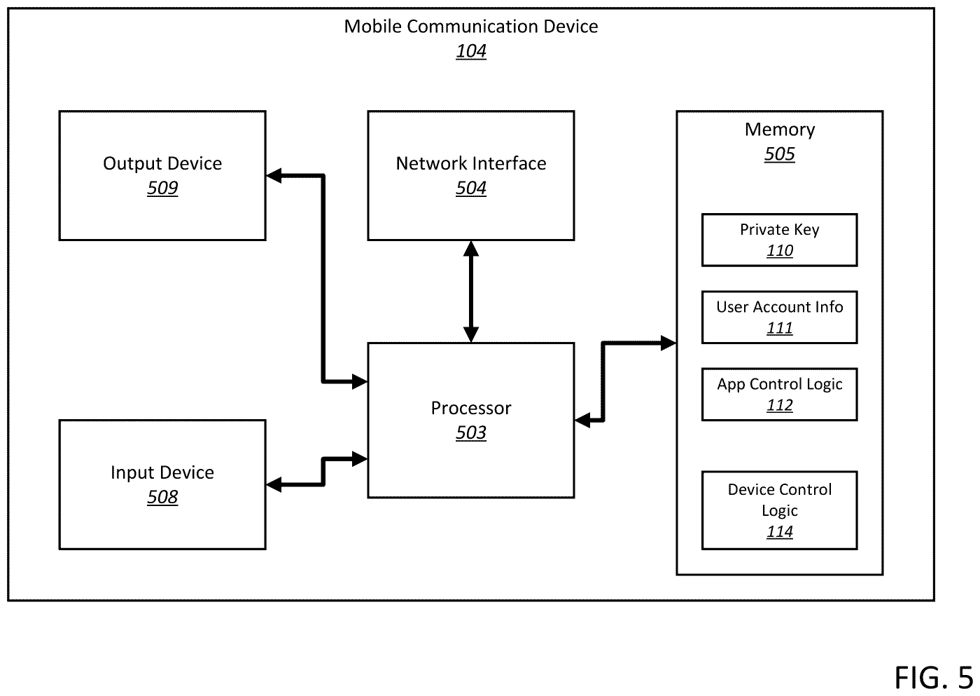

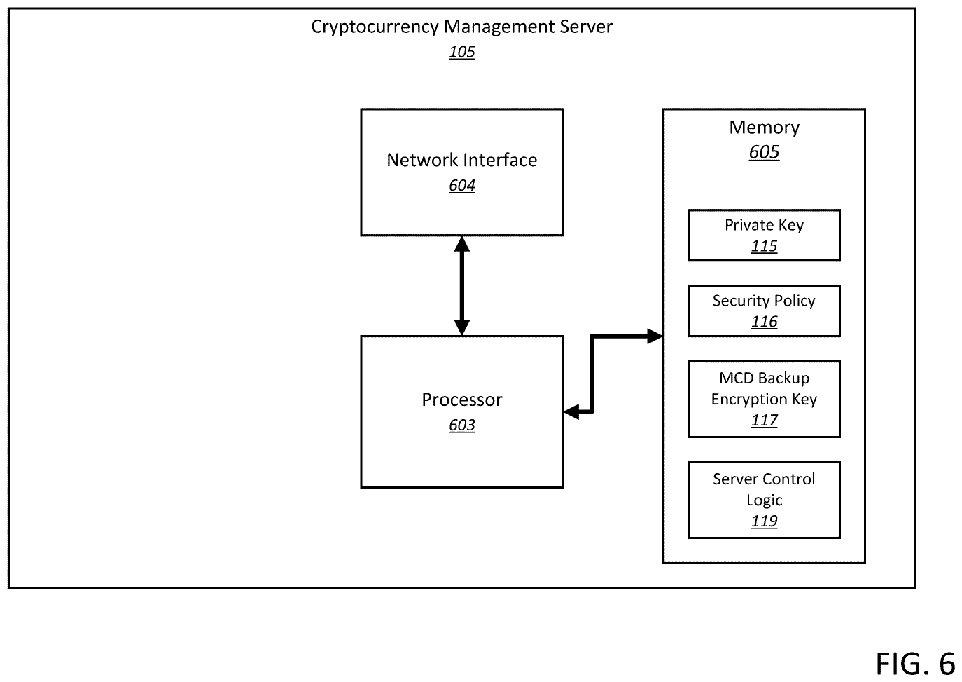

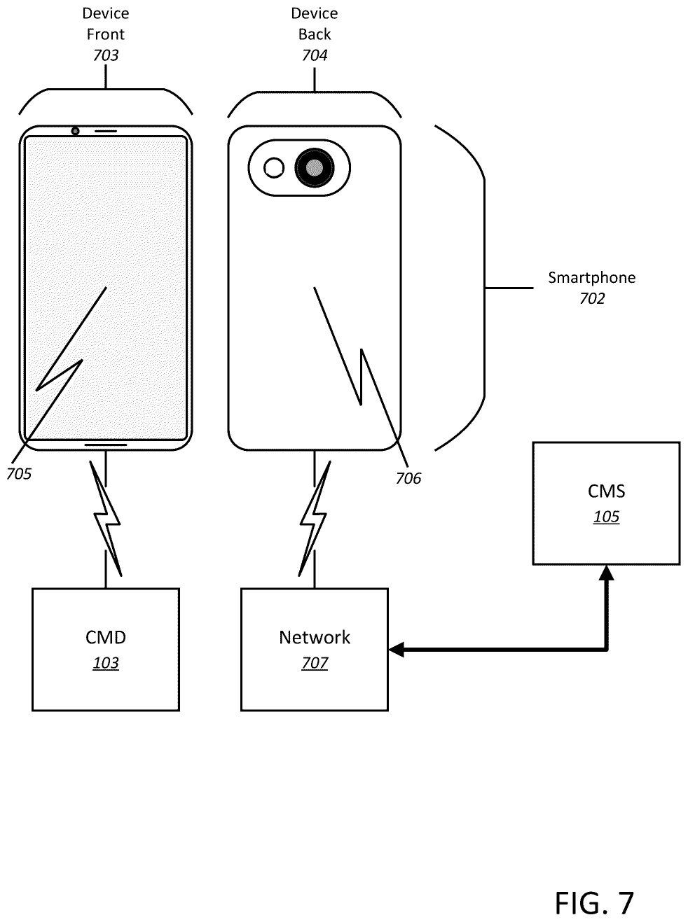

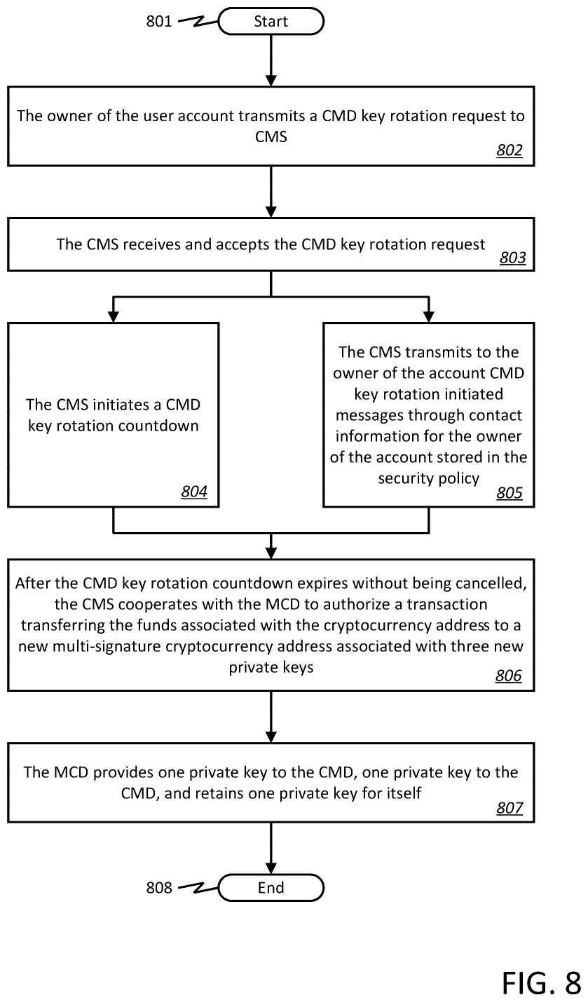

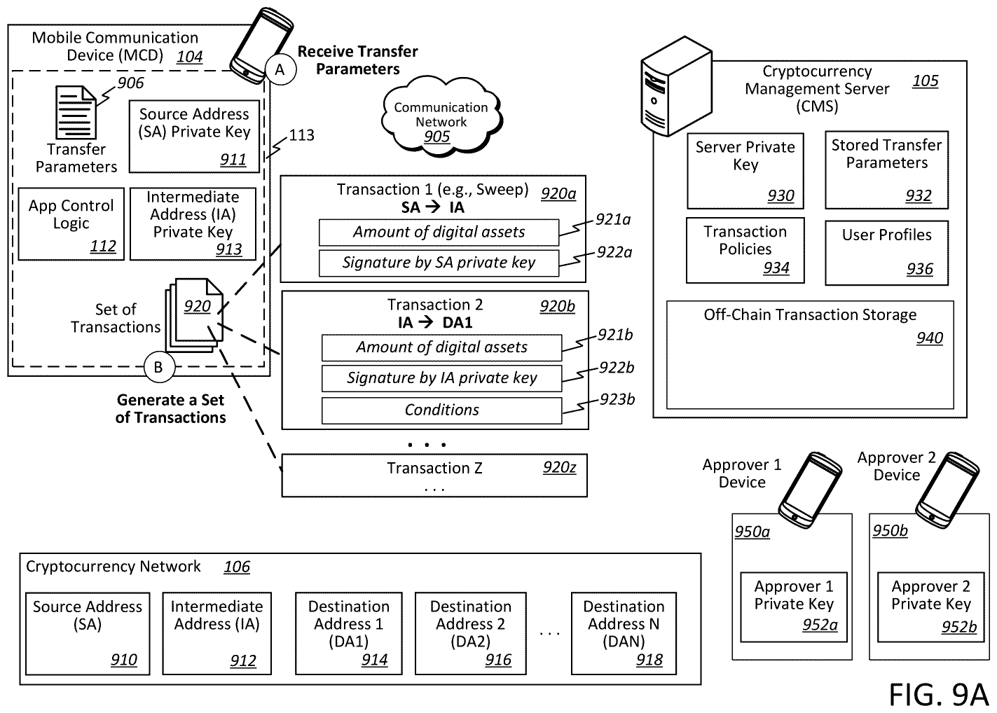

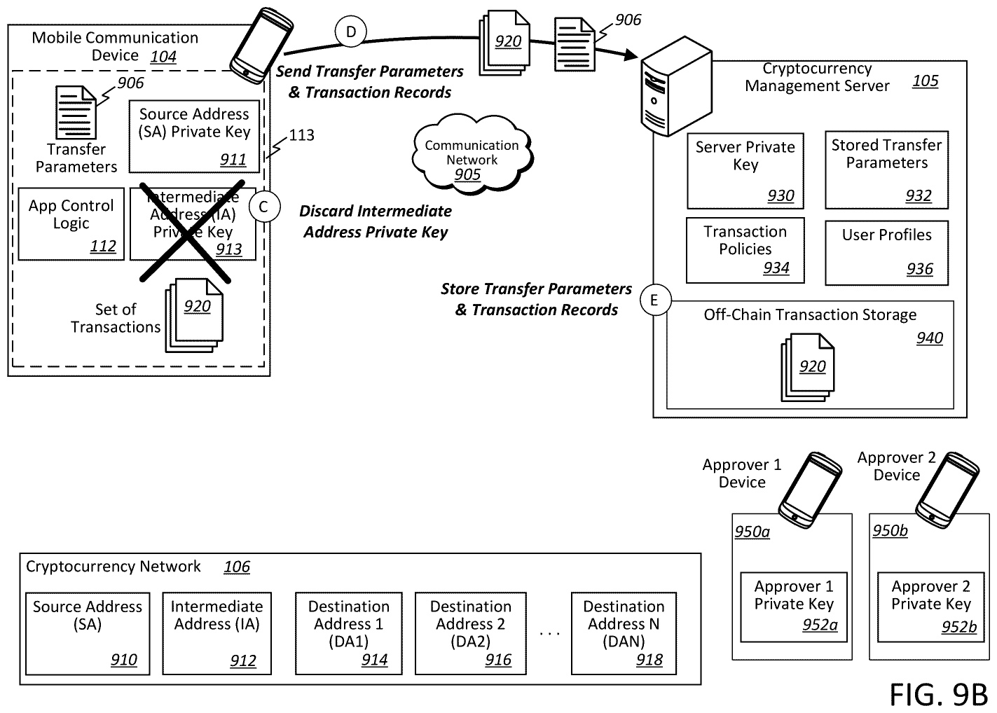

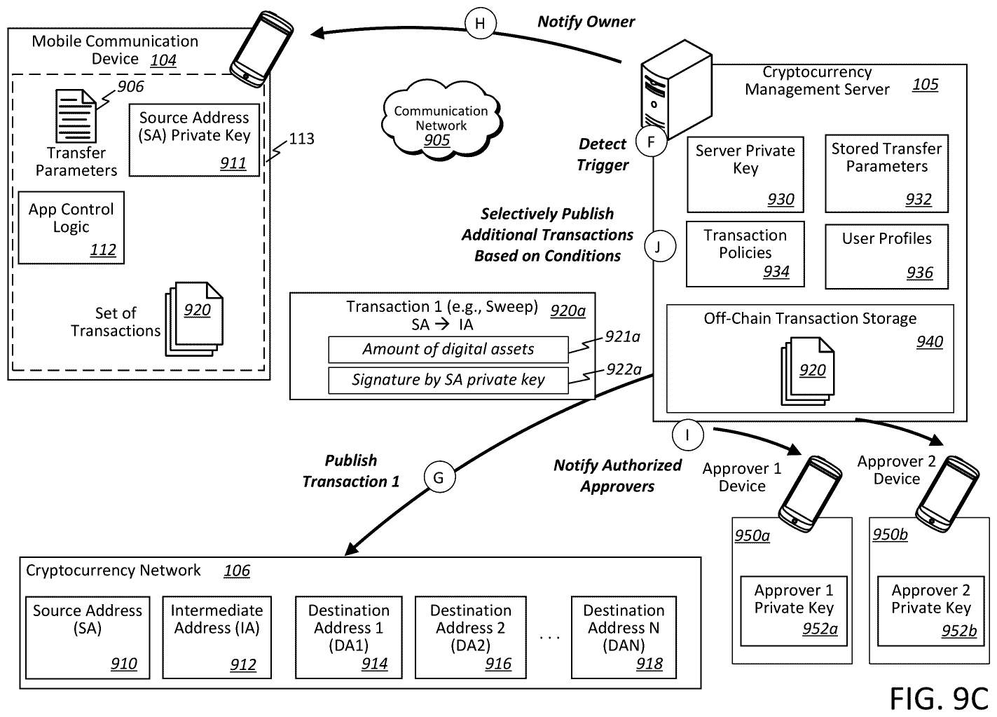

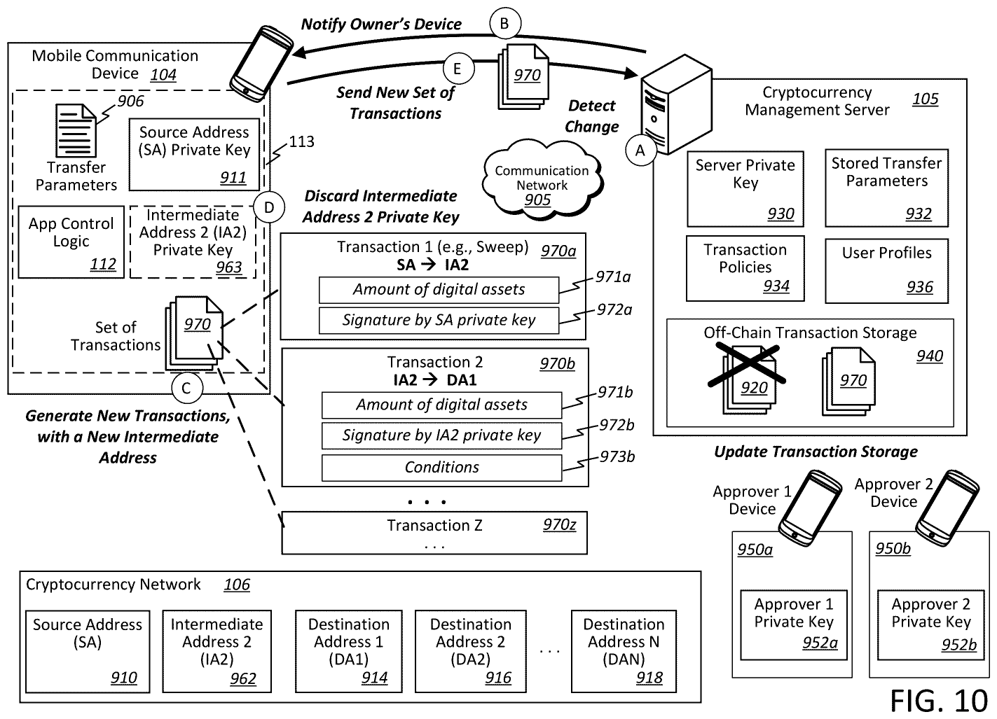

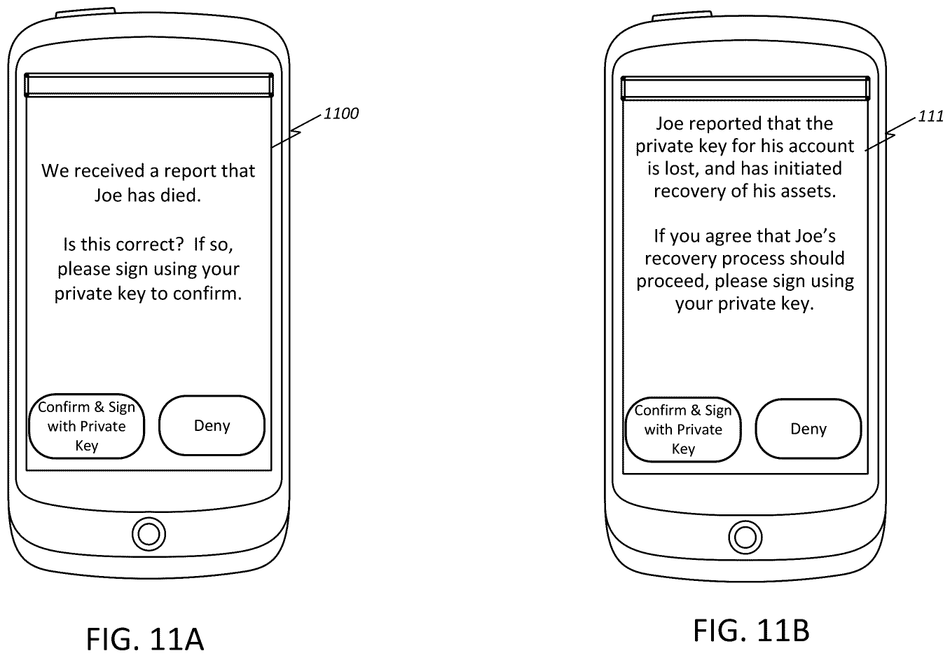

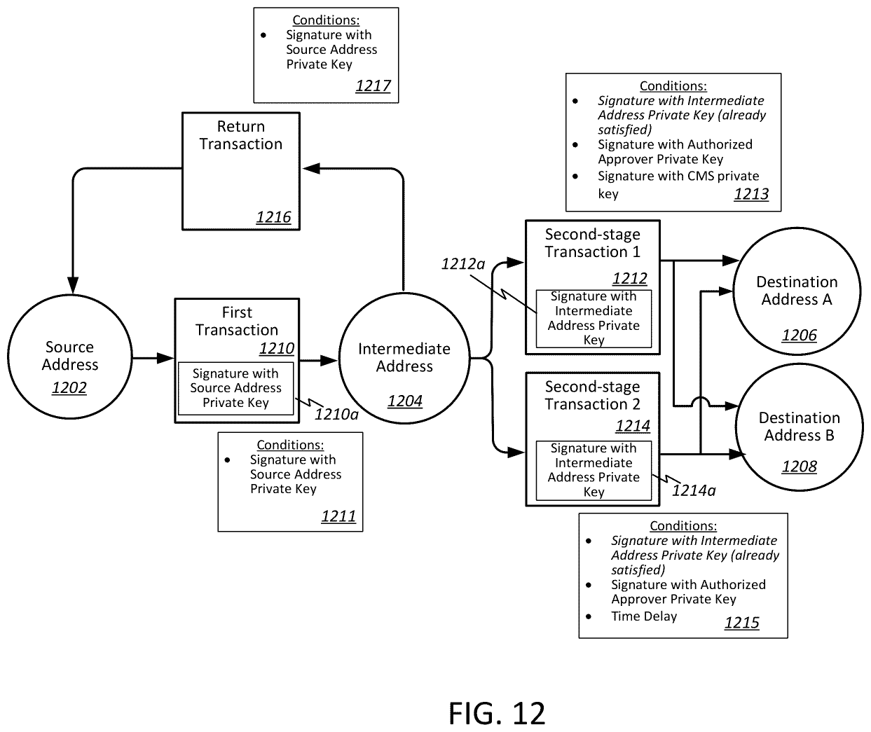

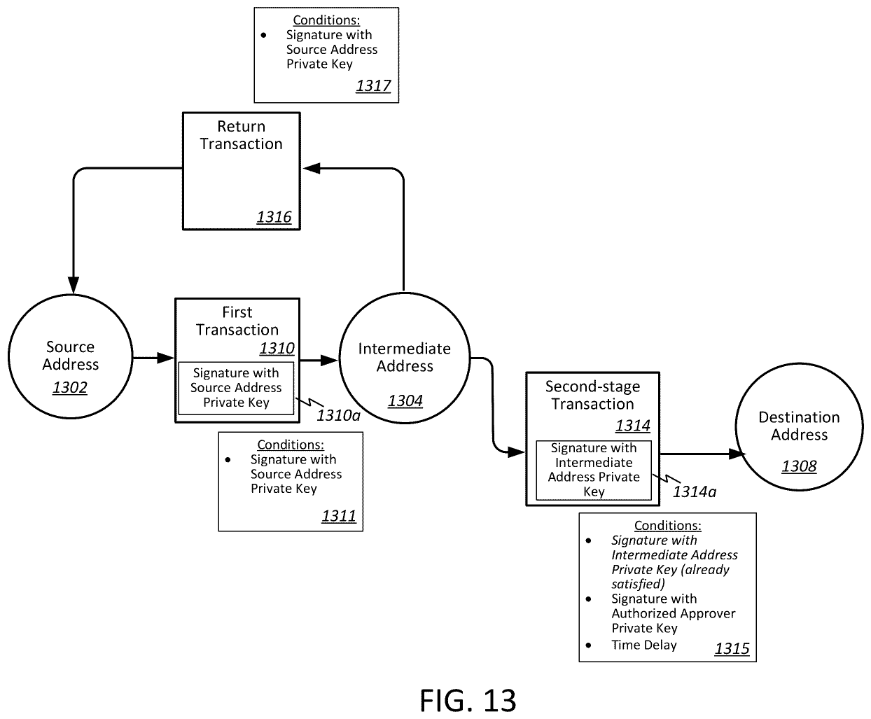

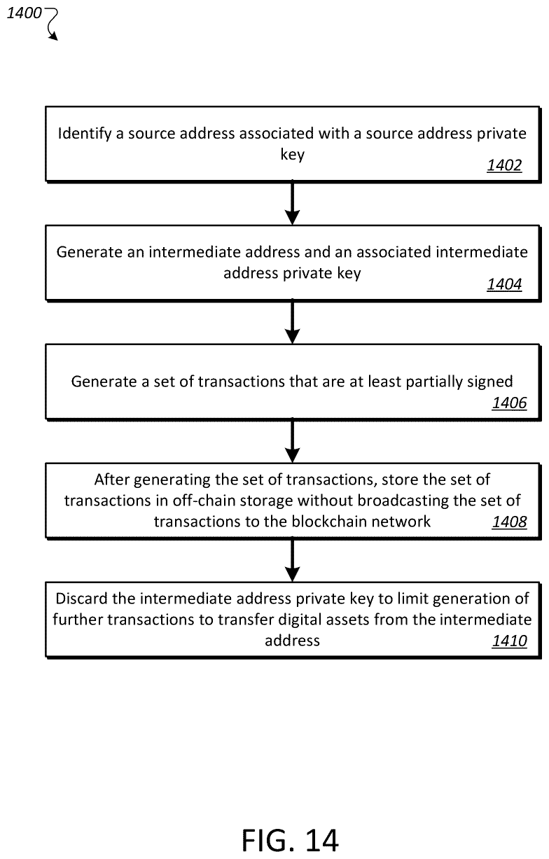

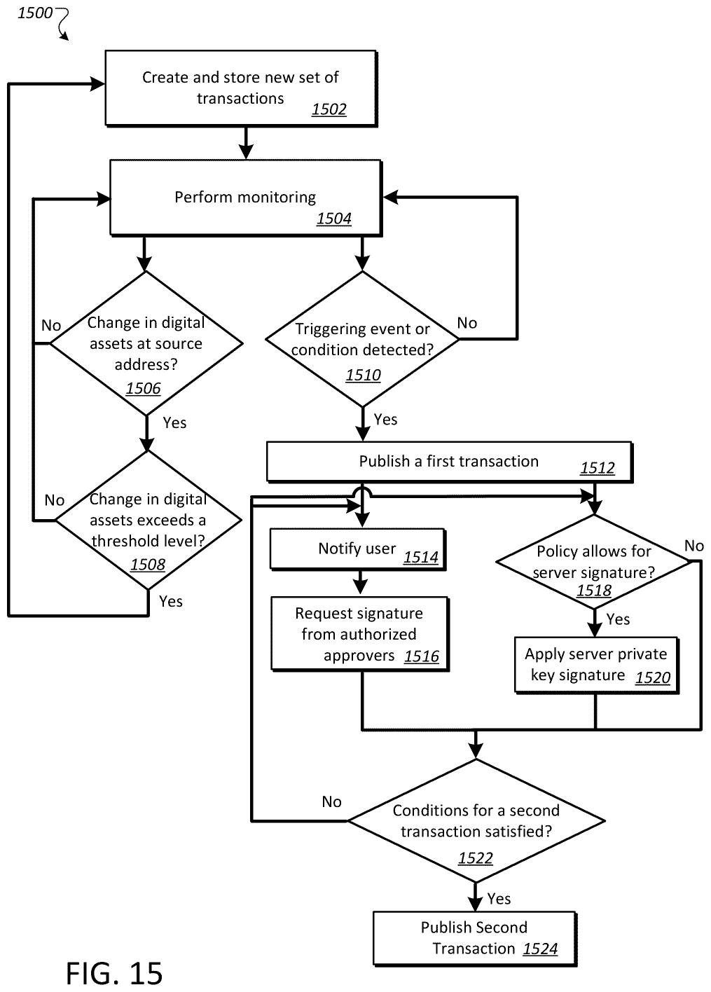

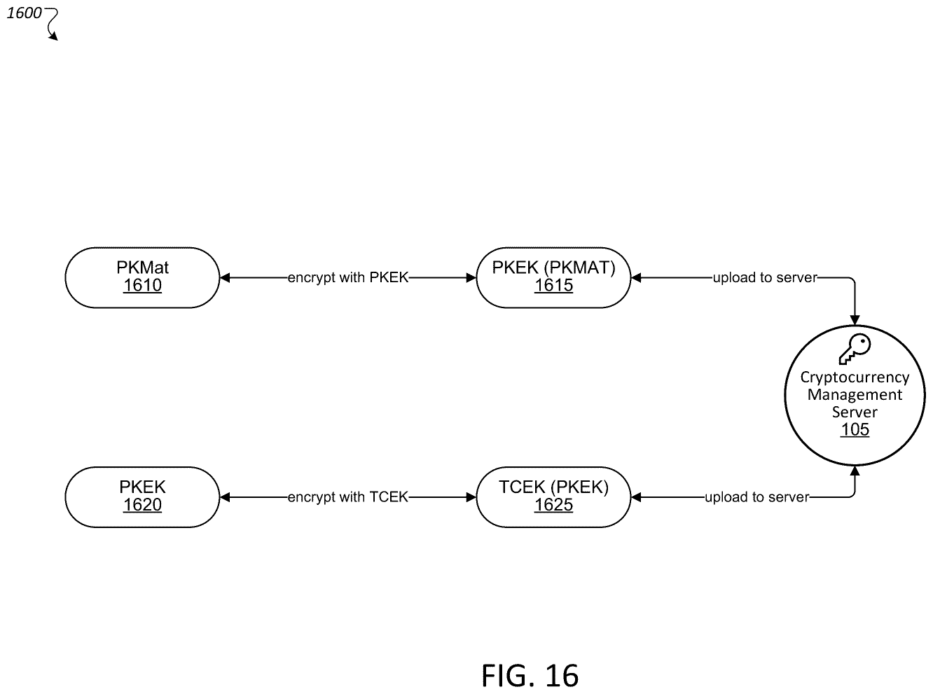

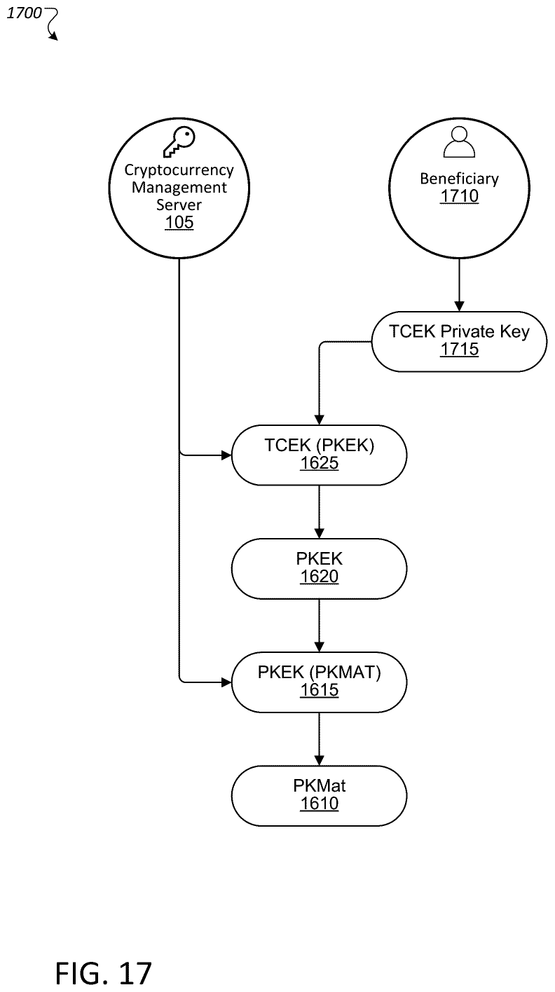

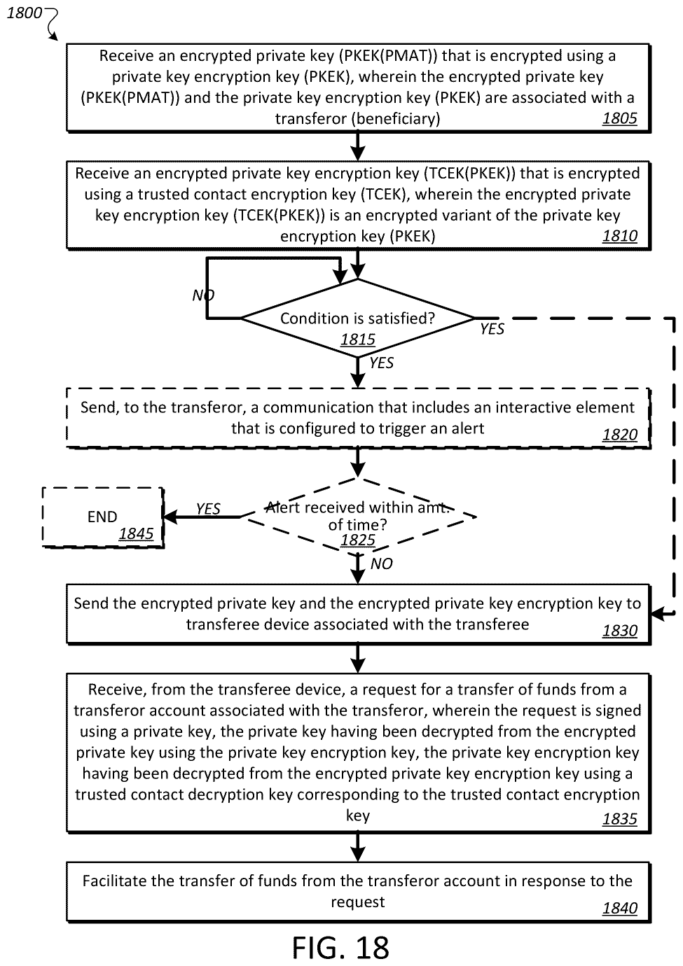

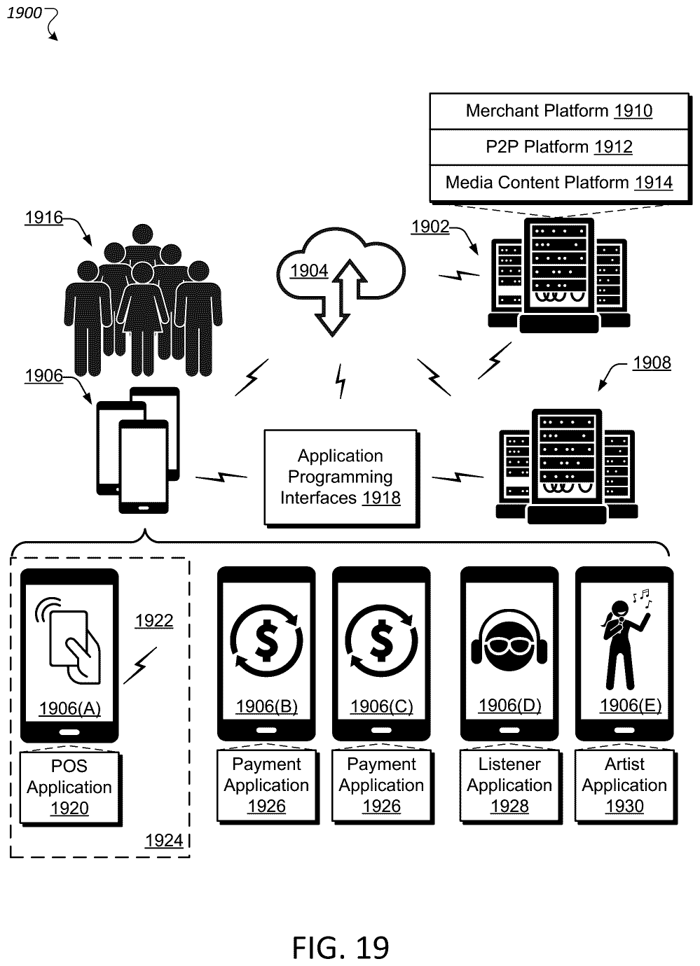

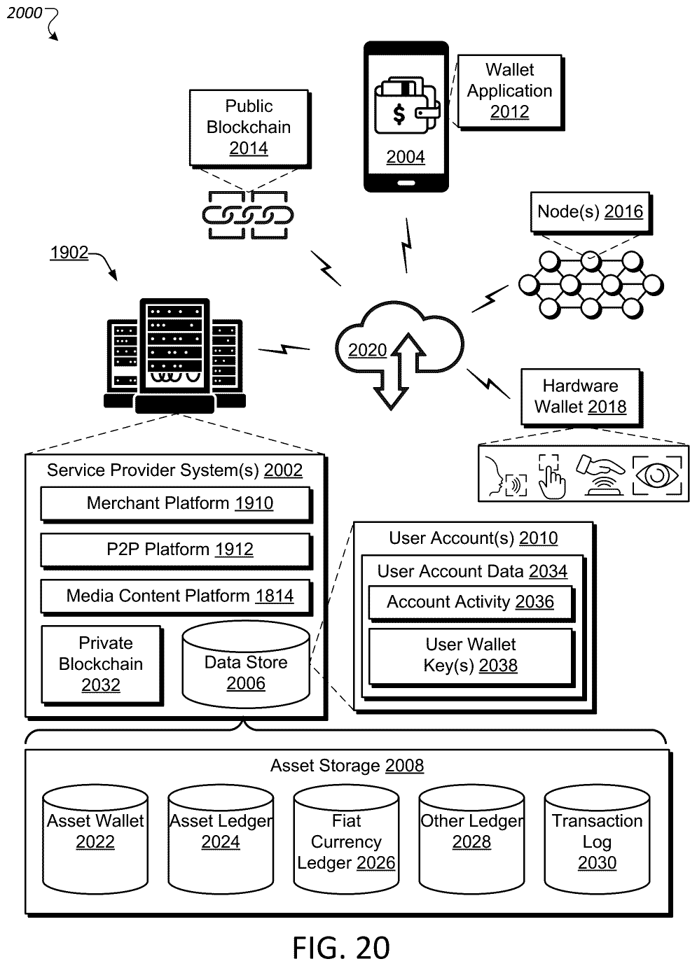

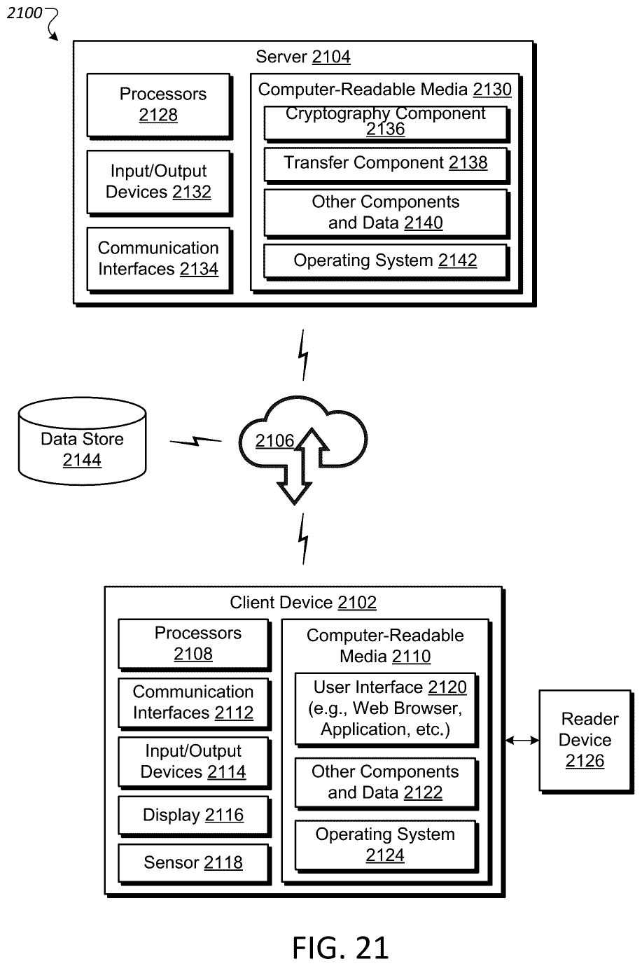

FIGS. 3A-3B is an illustration of a graphic user interface (GUI) for using social recovery, in accordance with some examples.

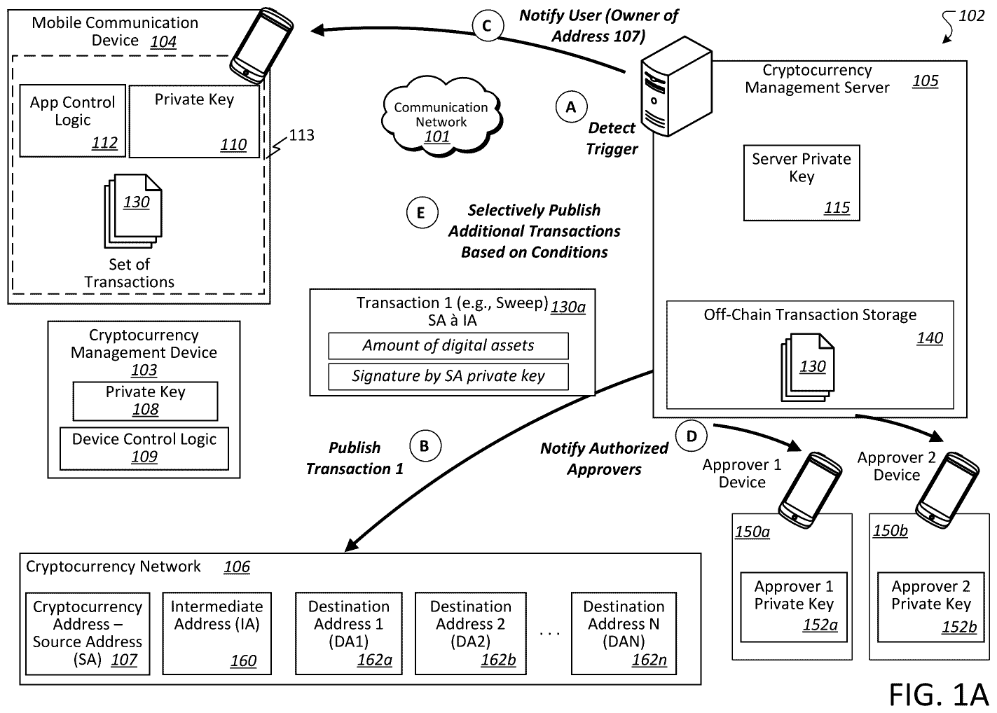

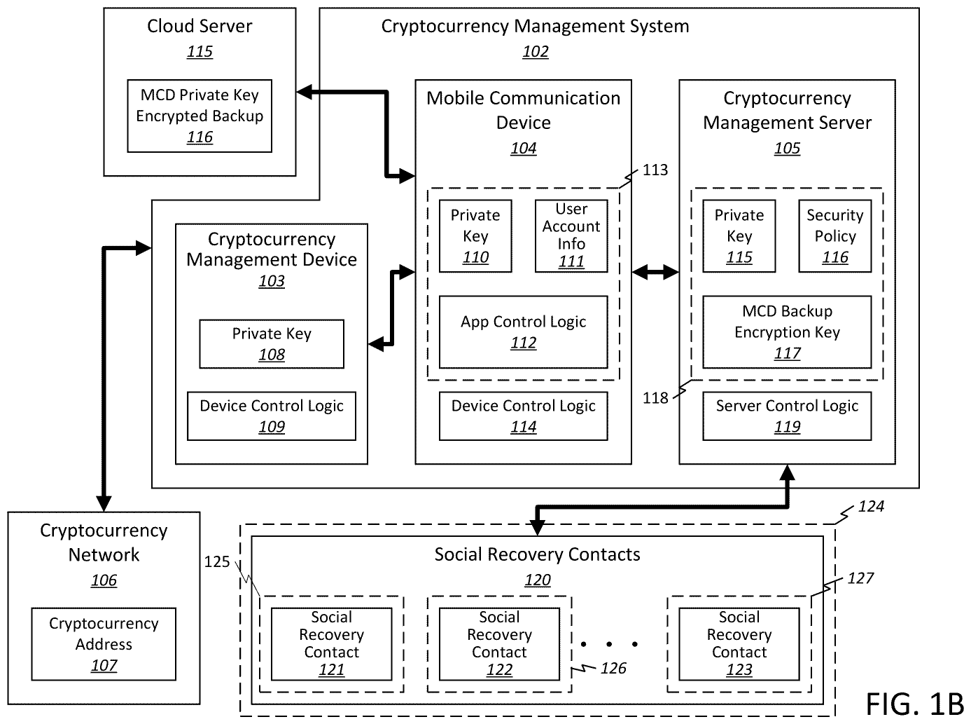

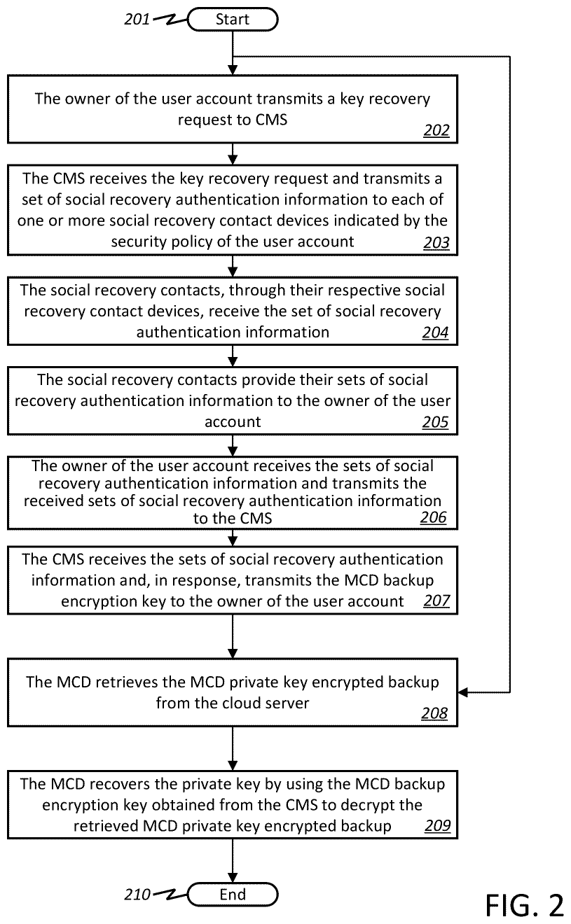

FIG. 4 is a block diagram of a cryptocurrency management device (CMD), such as is depicted by FIGS. 1A-1B, in accordance with some examples.

FIG. 5 is a block diagram of a mobile communication device (MCD), such as is depicted by FIGS. 3A-3B, in accordance with some examples.

FIG. 6 is a block diagram of a cryptocurrency management server (CMS), such as is depicted by FIG. 1A-1B, in accordance with some examples.

FIG. 7 is a diagram illustrating a front view and back view of an exemplary mobile communication device, such as is depicted in FIG. 5 in accordance with some examples.

FIG. 8 is a flowchart of an exemplary method of using delay and notify, in accordance with some examples.

FIGS. 9A-9C are block diagrams of another example of a cryptocurrency management system that is configured to set up and perform conditional transfers, in accordance with some examples.

FIG. 10 is a block diagram showing an example of the cryptocurrency management system of FIGS. 9A-9C refreshing or updating a set of transactions, in accordance with some examples.

FIGS. 11A-11B illustrate examples of user interfaces showing notifications to users who are authorized to approve transactions as part of conditional transfers, in accordance with some examples.

FIG. 12 shows an example of various transactions and addresses that can be used to implement a conditional transfer, in accordance with some examples.

FIG. 13 shows another example of various transactions and addresses that can be used to implement a conditional transfer, in accordance with some examples.

FIG. 14 is a flow diagram that illustrates a process for implementing conditional transfers, in accordance with some examples.

FIG. 15 is a flow diagram that illustrates a process for managing conditional transfers, in accordance with some examples.

FIG. 16 is a block diagram that illustrates a process for setting up a transfer of key material to a beneficiary, in accordance with some examples.

FIG. 17 is a flow diagram that illustrates a process for performing a transfer of key material to a beneficiary, in accordance with some examples.

FIG. 18 is a flow diagram illustrating a process for key material transfer, in accordance with some examples;

FIG. 19 is a block diagram illustrating an example environment for providing an application and/or for customizing the application for different platforms, in accordance with some examples;

FIG. 20 is a block diagram illustrating an example environment including a service provider system which may be associated with the server(s) of FIG. 19, in accordance with some examples; and

FIG. 21 is a block diagram illustrating a system for performing techniques described herein, in accordance with some examples.

### DETAILED DESCRIPTION

The present disclosure generally pertains to systems and methods for managing and using digital financial assets, such as cryptocurrency. M any cryptocurrency networks, e.g., blockchain networks, offer limited support for conditional transfers of digital assets. In many cases, users may desire to create transfers that will be executed automatically when user-defined conditions are satisfied, but the cryptocurrency network does not facilitate this type of transfer. The present disclosure provides techniques that can be used to enable conditional transfers in a cryptocurrency network, even when the cryptocurrency network does not natively support conditional transfers. For example, a system can create a set of transactions in advance, where the transactions are at least partially signed. The transactions are not initially published to the cryptocurrency network, but are instead held in off-chain storage until a predetermined event or condition has occurred. Then, when the predetermined event or condition is detected, the system publishes at least some of the transactions to the blockchain network. The system can selectively publish the transactions as the conditions associated with the respective transactions are satisfied (e.g., as signatures are obtained, as timing conditions are met, etc.). The set of transactions can be structured to provide different options or alternative transactions for transferring cryptocurrency, while still restricting any transactions other than those defined by the user or authorized by the user. As a result, even when a server system or third party is used to carry out the conditional transfer, cryptographic requirements block any transaction that is not authorized using the user's private key.

In further detail, many cryptocurrency networks do not provide a robust framework for making transactions contingent on events or conditions that may occur in the future. In many situations, a user may desire to arrange for certain transactions to be executed automatically in the future, but only under the conditions the user specifies. A though smart contracts can provide capabilities for conditional transfers, smart contracts are not available in all cryptocurrency networks. In addition, smart contracts incur significant costs to deploy or revoke, and smart contracts become publicly available for inspection when deployed, which may not be desirable. As a result, there is a need for improved techniques to support conditional transfers of digital assets.

Systems and methods for cryptographic key transfer are disclosed. In some examples, a system receives an encrypted private key that is encrypted using a private key encryption key. The system receives an encrypted private key encryption key that is encrypted using a trusted contact encryption key. The system receives an indication that a condition is satisfied. The system sends the encrypted private key and the encrypted private key encryption key to a transferee device associated with the transferee. The system receives, from the transferee device, a request for a transfer of funds from a transferor account associated with the transferor. The request is signed using a private key, the private key having been decrypted from the encrypted private key using the private key encryption key, the private key encryption key having been decrypted from the encrypted private key encryption key using a trusted contact decryption key corresponding to the trusted contact encryption key. The system facilitates the transfer of funds from the transferor account in response to the request.

FIG. 1A is a block diagram of an exemplary cryptocurrency management system 102, which includes a cryptocurrency management device (CMD) 103, a mobile communication device (MCD) 104, and a cryptocurrency management server (CMS) 105 that are each configured to store a respective private key 108, 110, 115 for use in generating a respective authenticating signature for a multi-signature address of a cryptocurrency network 106. Any two of the three authenticating signatures capable of being generated by the CMD 103, MCD 104, and CMS 105 may be combined to generate a fully authenticated request for transferring cryptocurrency associated with the multi-signature address. The system 102 provides the user with a flexible self-custody solution that permits him or her to transfer cryptocurrency without having to access the private key stored at the CMS 105. Additionally, the CMS 105 enables recovery in the event of loss or unavailability of one or both of the CMD 103 and/or the MCD 104.

The cryptocurrency management system 102 can be used to set up and manage conditional transfers that the system 102 can carry out for a user in response to the occurrence of a predetermined triggering event or condition. This process can include creating a set of transactions that the CMS 105 stores and publishes to the cryptocurrency network 106 in response to appropriate conditions being satisfied. For example, the MCD 104 can create a set of transactions 130, which specify types of transfers to be performed at different times or under different conditions. The cryptocurrency management system 102 provides the versatility to align the timing of transfers to future-arising conditions, while also providing a secure implementation that disallows transfers other than those defined in advance or approved with the user's private key. The conditional transfers set up by the MCD 104 and carried out by the CMS 105 can be used in a variety of situations, such as to recover digital assets in the event that a key is lost, to transfer assets in the event that an asset owner dies, and so on.

The cryptocurrency management system 102 enables conditional transfers to be performed even if the cryptocurrency network 106 does not natively support conditional transfers. The conditional transfers can be implemented using the fundamental technology of any appropriate cryptocurrency network 106, but can make use of a separate server or system such as the CMS 105 to facilitate the transfers. Even though the CMS 105 handles processing of the conditional transfers, the conditional transfers are structured to still provide security that the CMS 105 cannot transfer any digital assets subject to the conditional transfer without the user's authorization. For example, a user can use the MCD 104 (and/or CMD 103) to create, in advance, a defined set of transactions that can be valid if the corresponding conditions occur. Subsequently, the CMS 105 operating on behalf of the user can carry out the transactions the user defined, but cryptographic requirements block the CMS 105 from making any other transactions that the user has not authorized.

The cryptocurrency management system 102 also increases versatility by expanding the range of events and conditions that can trigger a conditional transaction. For example, the cryptocurrency network 106 may be configured to accept a transaction if cryptographic requirements are met, or reject a transaction if the cryptographic requirements are not met. The cryptocurrency network 106 may permit a limited set of other conditions, such as timelocks. However, the cryptocurrency network 106 may not support the wide range of other conditions that users may desire to trigger a conditional transaction, such as the loss of a private key, the death of a user, or other conditions that are not verifiable from the information in a blockchain. The cryptocurrency management system 102 allows a broad range of conditional transfers to be implemented with existing cryptocurrency networks, by employing the CMS 105 to assist in monitoring for events and conditions, while maintaining security by limiting the CMS 105 to being able to automatically carry out a limited set of previously-signed transactions unless the user's private key is used.

The conditional transfers that the CMS 105 facilitates provide advantages over the use of smart contracts. Unlike the deployment of a smart contract, setting up a conditional transfer using the MCD 104 (and/or CMD 103) and CMS 105 does not cause resource consumption (e.g., publication and validation by computing nodes) in the cryptocurrency network 106. In addition, while revoking a smart contract would require resource consumption in a cryptocurrency network, revoking or replacing a conditional transfer using the MCD 104 (and/or CMD 103) and CMS 105 does not. In terms of computation, arranging conditional transfers is significantly more efficient than the deployment of a smart contract. This efficiency also allows the conditional transfer techniques herein to avoid the cryptocurrency costs for deploying or revoking smart contracts. As another benefit, the MCD 104 (and/or CMD 103) and CMS 105 can implement conditional transfers that are kept private until the conditions for triggering the conditional transfer process are satisfied. The fact that a conditional transfer exists, and the parameters (e.g., amounts, recipients, conditions, etc.) can be kept private until the initial triggering event or condition occurs. Even after the initial triggering event or condition, the later stages of the conditional transfer that transfer digital assets to the final destinations are not made public until full authorization is obtained and the CMS 105 publishes those transactions to the cryptocurrency network 106. By contrast, smart contracts are typically deployed and made public before any event or condition that triggers execution of the smart contract, and this property makes the smart contract code open to public inspection, which can facilitate attacks or exploitation by malicious actors.

One way that conditional transfers can be implemented in the cryptocurrency management system 102 is for the MCD 104 (and/or CMD 103) to create a set of transactions 130 that is designed to be executed in multiple stages. For example, for each set of transactions 130, the MCD 104 (and/or CMD 103) can create an intermediate address 160 to be used for temporary storage of digital assets. The first stage of a conditional transfer can include a first transaction 130a that transfers digital assets from a user's source address 107 to the intermediate address 160. The second stage can include one or more transactions for transferring digital assets from the intermediate address 160 to one or more destination addresses 162a-162n. The MCD 104 (and/or CMD 103) can structure the second stage transaction(s) so they can be authorized by any of multiple different sets of conditions. For example, the intermediate address 160 can be a multi-signature address for which signatures using different combinations of private keys may be able to authorize a transaction. As another example, second-stage transactions with different sets of conditions can be generated. For example, the MCD 104 (and/or CMD 103) can define one transaction to transfer the digital assets from the intermediate address to a recipient if a first set of conditions are satisfied, including a time delay set relative to the completion of the first transaction 130a. The MCD 104 (and/or CMD 103) can define another transaction to transfer the digital assets from the intermediate address to the recipient under a second set of conditions, or to transfer the digital assets to a different recipient under different conditions.

When the MCD 104 generates the transactions for the second stage, the MCD 104 signs the transactions with a private key for the intermediate address 160. After signing, the MCD 104 discards the private key for the intermediate address 160, so that the private key for the intermediate address 160 is no longer available for any party to use in creating or editing transactions transferring digital assets from the intermediate address 160. In effect, this limits the options for transfer so that, once the conditional transfer process is initiated and without the user's private key, the digital assets can only be transferred using one or more of the predefined, pre-signed transactions that have been generated and stored in the set of transactions 130. This provides increased security by ensuring that the CMS 105 or any other system that obtains the set of transactions 130 will not be able to perform any transfer of the digital assets except using the digital asset quantities, conditions on execution, and destinations that the predefined transactions specify, unless a transaction is signed by the user's private key 108 and/or private key 110. As a result, when the user allows the CMS 105 to carry out functions of the conditional transfer on the user's behalf, the user can have confidence that the CMS 105 cannot transfer the digital assets in any way the user has not authorized. The arrangement retains the flexibility to respond to different conditions, because the CMS 105 retains the ability to selectively publish transactions to the cryptocurrency network 106, and the set of transactions 130 itself can provide alternative transfers to be used when different sets of conditions are satisfied. Nevertheless, even the CMS 105 facilitating the conditional transfer is cryptographically blocked from performing any transfer that the user did not previously approve. The user still retains the ability to cancel the conditional transfer or transfer funds out of the intermediate address 160 using the user's private key 108 and/or private key 110.

The cryptocurrency management system 102 allows conditional transfers to be made with improved timing constraints. The cryptocurrency network 106 may allow some types of timing constraints, such as time locks that can limit execution of a transaction to a specific time defined in advance or after a specific amount of time has elapsed. However, for many conditional transfers, the desired time for execution is not known in at the time the conditional transfer is set up, because the timing may depend on other events or conditions with uncertain timing. When the MCD 104 creates the set of transactions 130, the MCD 104 can create a multi-stage set of transactions to enforce time locks or time delays that are relative to any appropriate event or condition, not just based on the types of time references that the cryptocurrency network 106 natively supports. For example, a conditional transfer may be structured to enforce a delay period of a month before a recovery transaction is executed, where the month delay begins from the time the user's private key is reported to be lost. The cryptocurrency network 106 generally does not allow time locks defined relative to an off-chain event such as the report of a lost key. Nevertheless, the MCD 104 and the CMS 105 can achieve this by setting a first transaction 130a to be executed when the triggering event or condition is detected (e.g., the private key is reported lost). A second transaction, such as the recovery transaction, can include a time lock that is defined relative to the time of execution of the first transaction 130a. In effect, the set of transactions 130 together can provide a time lock that sets a delay period relative to any triggering event or condition that is defined to initiate the conditional transfer.

The example shown in FIG. 1A illustrates various actions that the CMS 105 performs to carry out a conditional transfer using a set of transactions 130 that the MCD 104 has previously created. The MCD 104 provides the set of transactions 130 over a communication network 101, such as the Internet, and the CMS 105 stores the set of transactions 130 in off-chain transaction storage without publishing any of the transactions to the cryptocurrency network 106 yet. The CMS 105 then monitors for the occurrence of the triggering event or condition that is defined for the set of transactions 130. The CMS 105 then performs a set of actions indicated in FIG. 1A as stages (A) through (E).

In stage (A), the CMS 105 detects the triggering event or condition. As a result, in stage (B), the CMS 105 retrieves the first transaction 130a (“Transaction 1”) from the set of transactions 130 in the off-chain transaction storage 140 and publishes the first transaction 130a to the cryptocurrency network 106. This has the effect of sweeping the digital assets that subject to the conditional transfer from the source address 107 to the intermediate address 160. As discussed further below, the first transaction 130a is stored with all necessary authorizing signatures already applied, so simply publishing the first transaction 130a is sufficient to cause the first transaction 130a to be executed.

In stage (C), the CMS 105 then notifies the user, e.g., the owner of the cryptocurrency address 107, that the conditional transfer has been initiated. If the conditional transfer had been started due to incorrect information, the user can use his private key 110 or private key 108 to transfer the digital assets out of the intermediate address 160 in order to cancel the conditional transfer in progress.

In stage (D), the CMS 105 also notifies one or more authorized approvers, to request that they confirm that the circumstances are appropriate for the conditional transfer to proceed. For example, a notification can be sent to devices 150a, 150b of the authorized approvers, requesting that they apply a signature using their respective private keys 152a, 152b to confirm that the triggering event or condition in fact has occurred.

In stage (E), the CMS 105 selectively publishes additional transactions from the stored set of transactions 130 based on the conditions that are satisfied. The CMS 105 then determines whether conditions are satisfied to perform the second stage of the conditional transfer, from the intermediate address 160 to the one or more destination addresses 162a-162n. For example, a time lock may restrict the execution of second stage transactions in the set of transactions 130 until a predetermined amount of time has elapsed after the execution of the first transaction 130a. As another example, a signature using a private key 115 of the CMS 105 and/or one or more of the authorized approver keys 152a, 152b may be needed. When the conditions are satisfied to authorize one or more of the second stage transactions, the CMS 105 then publishes the authorized transactions from the set of transactions 130 to the cryptocurrency network 106, which completes the conditional transfer that the user that owns the cryptocurrency account (with address 107) had intended.

In many cryptocurrency networks, if a user loses access to the private key for a cryptocurrency address, the user may permanently lose access to the cryptocurrency associated with the cryptocurrency address. The cryptocurrency management system 102 provides a way that users can create a conditional transfer to recover cryptocurrency from a cryptocurrency address 107 after the private key 108 and/or private key 110 is lost. For example, while the user still has the private key, the MCD 104 can generate a set of transactions 130 for assert recovery, when the set of transactions is configured to transfer digital assets from the original address 107 to a new recovery address as a destination address. The set of transactions 130 can be structured for execution in multiple stages, such as a first transaction 130a to initially transfer digital assets to an intermediate address 160 created for the recovery functionality, and then a second transaction to transfer digital assets from the intermediate address 160 to the user's designated recovery address. The MCD 104 can create the second transaction to include various conditions, such as an amount of time to elapse or a requirement for a cryptographic signature by one or more parties previously designated by the owner. After the set of transactions 130 are created, they are stored by the CMS 105 in the off-chain transaction storage 140, ready to be accessed by the CMS 105 and used in the event that the user's private key 110 and/or private key 108 becomes lost, or even if the user's MCD 104 is also lost.

In some implementations, the conditional transfers made possible by the cryptocurrency management system 102 can be used to provide inheritance of digital assets to heirs upon the death of the asset owner. For example, the MCD 104 can generate a set of transactions that includes (1) a first transaction 130a, which transfers digital assets from a source address 107 of the owner to an intermediate address 160, and (2) one or more second transactions making transfers to heirs, with each transaction designed to transfer a predetermined amount of the digital assets from the intermediate address 160 to a destination address 162a-162n of one of the heirs. One or more of the second transactions can be time-locked, so that they will only be executed in the cryptocurrency network 106 after a specified period of time has elapsed after the execution of the first transaction 130a. After being signed, the set of transactions 130 is sent to the CMS 105 and is stored by the CMS 105 in the off-chain transaction storage 140. The CMS 105 performs monitoring and in response to an appropriate trigger, such as a report indicating that the owner has died, the CMS 105 publishes the first transaction 130a so it executes in the cryptocurrency network. The period for the time lock is counted with reference to the time of execution of the first transaction 130a, and the second-stage transfers to heirs can be executed once the associated conditions are satisfied. The CMS 105 sends messages to notify the owner of the digital assets when the conditional transfer it triggered. If the owner's death was incorrectly reported, the owner can cancel the conditional transfer by using the owner's private key 110 and/or 108 to transfer the digital assets from the intermediate address 160 back to the original cryptocurrency address 107 (or to another address of the owner's choice).

FIG. 1B is another block diagram of the cryptocurrency management system 102. As shown by the figure, a cryptocurrency management system 102 may comprise a cryptocurrency management device (CMD) 103, a cryptocurrency management server (CMS) 105, and a mobile communication device (MCD) 104. Also shown by FIG. 1B is a cryptocurrency network 106 and a cryptocurrency address 107 associated with (one or more transactions in) the cryptocurrency network 106. In general, the MCD 104 may interact with the CMD 103 and the CMS 105 to, among other things, generate and submit valid cryptocurrency transactions. As part of this process, the CMS 105 and the MCD 104 may also interact with the cryptocurrency network 106.

Users of cryptocurrency often face a choice between third-party custody and self-custody. In third-party custody, the owner depends on a third party to hold information, such as private keys, that is used in establishing ownership and transferring cryptocurrency. Such a solution may be appealing to users who do not wish to be burdened with many of the complexities of holding, processing, and transferring information related to the cryptocurrency. However, many users may be concerned about the security measures used by third-party custodians to keep the cryptocurrency secure and also retaining the ability to access the cryptocurrency from the third-party custodians, such as during bankruptcy or other unanticipated events, as well as the loss of credentials required by the third-party custodians. With self-custody, the owner must wade through the technical complexities associated with managing cryptocurrency and also deal with security concerns. M any users may also be concerned about their ability to access cryptocurrency in the event of the loss of or damage to hardware used to store and otherwise manage the cryptocurrency. As discussed with respect to FIG. 1B, the cryptocurrency management system 102 provides options for recovering cryptocurrency if credentials are lost, an issue that many people have experienced.

During recovery of a lost private key, the cryptocurrency management system 102 may be configured to delay completion financial transactions and provide notification of pending financial transactions so that an authorized user may be notified of and then cancel any transactions that he deems to be fraudulent. In some implementations, the cryptocurrency management system 102 also enforces at least some constraints, such as spending limits, during the recovery process once the system has been notified of a lost key, thereby limiting the amount of funds that could be transferred by an unauthorized user potentially exploiting vulnerabilities in the recovery process.

In some implementations, the authorized user during registration is permitted to list social recovery contacts 121-123 who may be used for authentication in the recovery of a lost key. In this regard, when a key is lost, the CMS 105 provides codes that the authorized user may communicate to the social recovery contacts. The CMS 105 also communicates with the social recovery contacts and prompts them to provide the codes. If at least a minimum number of the social recovery contacts 1221-123 provide valid codes, the CMS 105 authenticates the user during the recovery process to permit recovery of the lost key or keys. Thus, the authorized user may be authenticated without having to provide a password, PIN, or other information to be remembered by the user, thereby facilitating recovery.

One of the potential barriers to more mainstream adoption of self-custody solutions is the need to create and physically protect sight-sensitive backup material in order to stay safe. This means moving away from reliance on long (e.g., 12- or 24-word) seed phrases that (to be secure) users record on a medium like paper or metal. For such a solution, an unauthorized user who gets even brief access to this material could use it to steal or otherwise misappropriate the cryptocurrency. Seed phrases have worked well for many experienced users. However, seed phrases can create intimidating experiences for new users of cryptocurrency and also provide relatively easy opportunity for bad actors to exploit customers who do not fully understand their importance, such as by convincing a customer to share a seed phrase over the phone, tricking a customer into entering an already-compromised seed phrase at wallet setup time, or compromising a customer's cloud storage account that contains a photo of the paper physical seed phrase card that came with their wallet. In addition, many users create secrets, like passwords, that are sometimes simple to remember but may also be vulnerable to hackers, and in some cases, users may create secrets that are more secure but difficult to remember. Techniques for providing robust security of assets, like cryptocurrency, without requiring users to remember complex secrets (e.g., passwords) are generally desired.

Towards this end, the cryptocurrency management system 102 allows recovery of a lost private key in a manner that does not require the user to maintain backup material and that also does not require the user to cede control over the cryptocurrency account to a third-party are generally desired.

In general, each of the CMD 103, MCD 104, and CMS 105 may also comprise a cryptocurrency account private key (i.e., private keys 108, 110, and 115) and control logic (i.e., control logic 109, 112, 114, and 119). As described further below, each private key 108, 110, and 115 is a cryptographic key associated with the private key of the public-private key pair (the private key of one of the public-private key pairs, for multi-signature addresses) of a cryptocurrency address (e.g., cryptocurrency address 107). As also described further below, the control logics 109, 112, 114, and 119 may contain instructions that can be executed by their device's respective processor or set of processors to perform various functions of that device.

The private key 110 may be associated with a cryptocurrency management application (app) 113 being executed by the MCD 104 for the purpose of generally managing the cryptocurrency address 107. Towards this end, the cryptocurrency management app 113 may be associated with user account info 111 that is used to authenticate the MCD 104 to the CMS 105 and generally allow interacting by the cryptocurrency management app 113 with the CMS 105 (and/or MCD 104). The cryptocurrency management app may also be associated with app control logic 112 that contain instructions that can be executed by the processor or set of processors of the MCD 104 to perform the functions of the cryptocurrency management app 113. Note that, in some implementations, the functions described herein as being performed by the app control logic 112 may be performed by the device control logic 114 and vice-versa. In some implementations, there app control logic 112 and the device control logic 114 are combined into a single control logic that can be used to orchestrate the operation of the MCD 104 and manage cryptocurrency according to the techniques described herein.

The MCD 104 may also be associated with a cloud server 115 which the MCD 104 can use to store certain data off-device, such as for storing data backups. As part of this, the cryptocurrency management app 113 may encrypt a copy of the private key 110 and store the encrypted copy on the cloud server 115 as MCD private key encrypted backup 116. The MCD 104 may provide a copy of the encryption key used to encrypt the backup 116—referred to as the MCD backup encryption key 117—to the CMS 105. The CMS 105 may associate the MCD backup encryption key 117 and store the MCD backup encryption key 117 on non-volatile memory accessible by the CMS 105. Note that the cryptocurrency management app 113 may also store other data on the cloud server 115. Also note that the cryptocurrency management app 113 may, in some implementations, maintain a local copy of the MCD backup encryption key 117.

Additionally, the private key 115 may be associated with a user account 118. The user account 118 may be managed as part of an online platform maintained by a third-party custodian, with the online platform including the CMS 105. As is described in more detail below, the user account 118 may be associated with additional information, including the cryptocurrency address 107, information about the user (also known as the owner) of the user account 118, an MCD backup encryption key 117, and various configuration options, such as a security policy 116.

At a high level, the cryptocurrency management system 102 works to manage the cryptocurrency address 107 by controlling use of the cryptocurrency funds associated with the cryptocurrency address 107 in a transaction. In this regard, the cryptocurrency management system 102 can be thought of as an association of devices or systems that (1) each have been distributed a portion of the authority to control the cryptocurrency address 107 and (2) are configured to cooperate with one another to use their collective authority to control (e.g., generate and submit a transaction involving) the cryptocurrency address 107. In other words, the ability to manage the cryptocurrency address 107 is split between the CMD 103, the MCD 104, and the CMS 105. In some implementations, the CMD 103, the MCD 104, and the CMS 105 communicate with one another and agree to a transaction before the signatures for the transaction are obtained and an authenticated transaction is generated and submitted to the cryptocurrency network 106.

In some implementations, the cryptocurrency address 107 is a multi-signature address whose private keys are used as the authenticating keys distributed across the CMD 103, the MCD 104, or the CMS 105. As an example, there may be three private keys associated with the cryptocurrency address 107 and each of the CMD 103, the MCD 104, and the CMS 105 may store a respective one of them, and each of the CMD 103, the MCD 104, and the CMS 105 may permit access to its private key only if the user is able to provide acceptable authentication credentials. Further, the cryptocurrency address 107 may be configured such that any two of the private keys can be used to generate a fully authenticated cryptocurrency transaction request for the cryptocurrency asset associated with the cryptocurrency address 107. In other implementations, other numbers of private keys may be used to generate a fully authenticated cryptocurrency transaction request.

In some implementations, the owner of the cryptocurrency asset associated with the address 107 may maintain physical possession of the CMD 103 and the MCD 104, whereas the CMS 105 is maintained by a trusted third party. Further, the owner may keep the CMD 103 in a secure location, such as at home. Thus, if the MCD 104 is stolen, an unauthorized user should be unable to use the MCD 104 to generate a fully authenticated cryptocurrency transaction involving the cryptocurrency assets associated with the cryptocurrency address 107 since the unauthorized user (1) would not have physical access to or be able to communicate with the CMD 103 (which may be designed to permit only short-range communication, as described above) and (2) would be unable to access the private key stored at the CMS 105 without providing valid authentication credentials to the CMS 105.

In addition, when the owner desires to initiate a transaction, the owner may bring the MCD 104 to the CMD 103 or the CMD 103 to the MCD 104 so that the CMD 103 and the MCD 104 may communicate to generate a fully authenticated cryptocurrency transaction. In this regard, after providing valid authentication credentials to the CMD 103, the CMD 103 may use the private key stored therein to generate an authenticating signature that is communicated to the CMD 103, and the CMD 103 may use the private key stored therein to generate an authenticating signature that can be combined with the authenticating signature from the CMD 103 in order to generate a fully authenticated request for a cryptocurrency transaction. The CMD 103 may then transmit such request to the cryptocurrency network 106. Thus, using the devices (i.e., the CMD 103 and MCD 104) within the owner's physical possession, he is able to generate a fully authenticated cryptocurrency transaction without use of the CMS 105, thereby giving the owner full control over the cryptocurrency transaction in the event that the CMS 105 becomes unavailable for any reason. However, the CMS 105 remains available for recovery in the event that the CMD 103 and/or the MCD 104 is lost, stolen, fails, or otherwise is unavailable.

Specifically, if the original MCD 104 is lost or otherwise becomes unavailable, the original MCD 104 may be replaced with a new MCD 104 that may communicate with the CMD 103 and the CMS 105 to obtain two authenticating signatures that may be combined to form a fully authenticated cryptocurrency transaction. Also, if the CMD 103 is lost or otherwise becomes unavailable, the MCD 104 may communicate with the CMS 105 (as described above for the CMD 103) to obtain an authenticating signature that may then be combined with an authenticating signature from the MCD 104 to generate a fully authenticated cryptocurrency transaction. Thus, the system 102 shown by FIG. 1B and described above provides flexibility to the owner while maintaining security and also permitting recovery in the event of a loss of any of the CMD 103, the MCD 104, or the CMS 105.

Additionally, the cryptocurrency management system 102 may also enable recovery of lost keys. In particular, in some implementations, the CMS 105 may be used to recover a lost private key 110, such as might occur through the loss or failure of the MCD 104. For example, as an example, in the event a user loses access to the private key 110, the user may retrieve the MCD private key encrypted backup 116 from the cloud server 115 and the MCD backup encryption key 117 from the CMS 105 to recover the lost private key 110. As part of this key recovery process, the CMS 105 may require the user initiating the key recovery process to prove their identity as the owner of the user account 118.

In some implementations, the CMS 105 may require a user to prove their identity as owner of the cryptocurrency address 107 through a process referred to hereafter as “Social Recovery” where information from certain trusted parties is used. In this regard, when the user is setting up the user account 118, the user may provide contact information (e.g., telephone number, email address, user handle with a service provider, or similar identifier) of at least one social recovery contacts who may be used to help recover or authenticate a recovery of a lost key. Specifically, the social recovery contacts 120—shown in FIG. 1B as social recovery contacts 121, 122, and 123—may be associated with social recovery contact information 124—shown in FIG. 1B as social recovery contact information 125, 126, and 127, with the social recovery contact 121 information, the social recovery contact 122 information, and the social recovery contact 123 information being associated with social recovery contacts 121, 122, and 123, respectively—that is stored on or otherwise kept accessible by the CMS 105.

Later, the user may utilize their user account 118 to communicate with the CMS 105 to initiate the recovery process, such as through an application on the MCD 104 or through an online web portal of the associated online platform. In response, the CMS 105 may be configured to provide a respective set of social recovery authentication information to one or more of the user's social recovery contacts. The user of the user account 118 may be instructed to request the transmitted sets of authentication information from the social recovery contacts and provide the sets of authentication information to the CMS 105. The social recovery contacts may be instructed to provide the user of the user account 118 the sets of transmitted authentication information.

After the user of the user account 118 has retrieved (a sufficient number of) the sets of social recovery authentication information, the user may provide the retrieved sets of social recovery authentication information to the CMS 105. The sets of social recovery authentication information may be provided to the CMS 105 as part of a social recovery verification message, which may include additional information from the user, such as (a hash derived from) the password associated with the user account 118. If the user provides (a sufficient number of) correct sets of social recovery authentication information—possibly along with other required information—e.g., (a hash derived from) the password associated with the user account 118—then the CMS 105 may provide the MCD backup encryption key 117 to the user, such as by directly transmitting the MCD backup encryption key 117 to the MCD 104.

Alternatively, in some implementations, the process may be reversed, with the user of the user account 118 receiving one or more sets of social recovery authentication information associated with the social recovery contacts of the user account 118. The user may be instructed to provide these codes to each of their respective social recovery contacts and to have the contact enter the code into an online website associated with an online web portal of the associated online platform. In parallel, the social recovery contacts may be provided a message indicating that a key recovery process has been initiated for the user account 118 and providing a link to a website where the social recovery contact can enter the set of social recovery authentication information they receive from the owner of the user account 118. Naturally, the willingness of the social recovery contacts to comply with entering a set of social recovery authentication information into the website will heavily depend on the contacts' assessment of whether the owner of the user account 118—as opposed to a malicious third-party—initiated the process. Once a sufficient number of the social recovery contacts have entered the sets of social recovery authentication information they received from the owner of the user account 118, then the CMS 105 may provide the MCD backup encryption key 117 to the user, such as by directly transmitting the MCD backup encryption key 117 to the MCD 104.

In some other implementations, the CMS 105 may provide the social recovery contacts a message indicating that a key recovery process has been initiated for the user account 118 and providing a link to a website where instead of entering sets of social recovery authentication information they receive from the owner of the user account 118, the contacts may instead submit that they verified, e.g., in any way they preferred, that the owner of the user account 118 initiated the process.

In still other implementations, after the owner of the user account 118 indicates the social recovery contacts and before the key recovery process has been initiated for the user account 118, the CMS 105 may provide the social recovery contacts a message indicating that the contacts were identified by the owner of the user account 118 as social recovery contacts and requesting that the contacts install an application on their mobile devices to help in a later key recovery process. The CMS 105 may then use the installed applications on the mobile devices of the social recovery contacts to authenticate that the owner of the user account 118 initiated the process. In some implementations, the installed applications may be partially installed or temporarily installed. For example, an installed application may provide application data for storage on a cloud backup, the mobile device may then uninstall the application, and when the social recovery contact is prompted to participate in a social recovery process the social recovery contact may re-install the application which may then automatically retrieve the previously stored application data from the cloud backup. In other implementations, instead of an installed application the social recovery contacts may be asked to download and execute an application that performs the functions of the installed application without installing the application.

FIG. 2 is a flowchart illustrating a process of recovering a lost private key using social recovery. For example, the process may be used after a user is re-installing (and reconfiguring) the cryptocurrency management app 113 on their original MCD 104 or is installing (and configuring) the cryptocurrency management app 113 on a new MCD 104 (e.g., which might be done after loss of the original MCD 104 and replacement with a new MCD 104). In some implementations, this process may in particular be used when access to the private key 110 is lost while access to the CMD 103 is also lost.

To start, as shown by block 202 of FIG. 2 the owner of the user account may interact with the CMS to transmit a key recovery request. In some implementations, this may involve the user logging into the user account 118 through the cryptocurrency management app 113, with the cryptocurrency management app 113 then transmitting the key recovery request from the MCD 104 to the CMS 105. Alternatively, in some implementations the user may log into the user account 118 through an online web portal associated with the CMS 105 and transmitting the key recovery request to the CMS 105 through this web portal. In some implementations, the CMS 105 may require the user to provide authenticating information indicating the request is from the owner of the user account 118 before acting on the recovery request. For example, in some implementations the CMS 105 may require the user to provide the login credentials used to access the user account 118 (e.g., a username and password). As another example, the CMS 105 may require the user to generate valid signature of a hash of data provided to the user by the CMS 105 using one of the private keys associated with the cryptocurrency address 107, such as the private key 108. The CMS 105 may then use the corresponding public key to verify the authenticity of the signature and—by also hashing the data it provided to the user—verify that the signature is for the hash sent to the user.

After the key recovery request is transmitted, the CMS may receive the request and initiate and initiate a recovery procedure according to the security policy of the user account for the cryptocurrency address. M ore precisely, as shown by block 203 of FIG. 2 the CMS may receive the key recovery request and transmits a set of social recovery authentication information to each of one or more social recovery contacts using the social recovery contact information indicated by the security policy of the user account. In general, the security policy indicates certain configuration options controlling what responses to CMS will take to certain actions and the requirements that the CMS will impose before taking those actions. For example, in some implementations, the CMS 105 is willing to participate in authenticating a cryptocurrency transaction requested by a user logged in to the user account 118 if the requested transaction is for less than a certain value. This value may be set as part of a subset of the security policy known as a transaction policy. As another example, the security policy 116 may indicate if the CMS 105 will participate in a key recovery operation (i.e., willing to act on a key recovery request) and what requirements the CMS 105 will impose before doing so. If the CMS 105 requires social recovery, the security policy 116 may also list contact information for one or more social recovery contacts.

For example, the CMS 105 may determine that the security policy 116 for the user indicates that social recovery contact 121, social recovery contact 122 and social recovery contact 123 are social recovery contacts for the user account 118 and based on that determination transmit a set of social recovery authentication information to the social recovery contacts 121, 122, and 123 using social recovery contact information 124 that is indicated by the security policy 116. Specifically, the CMS may transmit a set of social recovery authentication information to the social recovery contact using the social recovery contact information indicated by the security policy for the social recovery contact. Likewise, the CMS may transmit a set of social recovery authentication information to the social recovery contact using the social recovery contact information indicated by the security policy for the social recovery contact and may transmit a set of social recovery authentication information to the social recovery contact using the social recovery contact information indicated by the security policy for the social recovery contact.

In some implementations, a set of social recovery authentication information may comprise a numeric code. For example, in some implementations the set of social recovery authentication information transmitted to a social recovery contact 123 may comprise a six-digit number. In other implementations, a different number of digits may be utilized, such as eight-digits, eleven-digits, etc. In some implementations, the transmitted set of social recovery authentication information may comprise an alphanumeric passcode. For example, in some implementations the set of social recovery authentication information transmitted to a social recovery contact 123 may comprise a six-character alphanumeric sequence. In other implementations, a different number of characters may be utilized, such as eight letter words, nine letter words, etc.

After the sets of social recovery authentication information are sent to the social recovery contacts through their respective social recovery contact information, each of the social recovery contacts, as shown by block 204 of FIG. 2 may receive or otherwise obtain access to their respective sets of social recovery authentication information. For example, for a social recovery contact whose contact information is a phone number, the social recovery contact may receive the sets of social recovery authentication information through a smartphone device associated with that phone number. As another example, for a social recovery contact whose contact information is an email address, the social recovery contact may receive the sets of social recovery authentication information through an email received by a device (e.g., a smartphone, a tablet, a personal computer (PC), etc.) with access to the inbox associated with that email address.

After the sets of social recovery authentication information are received by the social recovery contacts, as shown by block 205 of FIG. 2 the social recovery contacts may provide their respective sets of social recovery authentication information to the owner of the user account. This may involve, for example, each social recovery contact communicating with the owner of the user account 118 to verify that the owner of the owner of the user account 118 initiated or otherwise authorized the key recovery request.

After the social recovery contacts transmit their respective sets of social recovery authentication information to the owner of the user account, as shown by block 206 of FIG. 2 the owner of the user account may receive the sets of social recovery authentication information. The owner of the user account may then transmit the received sets of social recovery authentication information to the CMS. For example, in some implementations, the owner of the user account 118 may log into the user account 118 through the cryptocurrency management app 113. The cryptocurrency management app 113 may then provide the user with an interface to enter the social recovery verification codes. After the user has entered the social recovery verification codes, the cryptocurrency management app 113 may then transmit the entered social recovery verification codes from the MCD 104 to the CMS 105. Alternatively, in some implementations the owner of the user account 118 may log into the user account 118 through an online web portal associated with the CMS 105. The online web portal may then provide the user with an interface to enter the social recovery verification codes. After the user has entered the social recovery verification codes, the online web portal associated may then transmit the entered social recovery verification codes from the device the online web portal is operating on to the CMS 105. In general, the social recovery verification codes may be transmitted to the MCD as part of a social recovery verification message.

FIGS. 3A-3B are illustrations of a graphic user interface (GUI) for using social recovery. As shown by the figures, an account owner may initiate the process of using social recovery to authenticate a backup key recovery request. In particular, as shown by FIG. 3A, the account owner may trigger the CMS 105 to transmit the social recovery authentication information to a social recovery contact specified in the security policy of the account. Here, the social recovery authentication information is shown as a four-digit numerical code. As shown by FIG. 3B, the account owner may then receive the numerical code from the social recovery contact—such as through having the social recovery contact verbally communicate the code over a video call—and input the received numerical code to complete the social recovery authentication process.

After the owner of the user account 118 transmits the social recovery verification codes to the CMS 105, as shown by block 207 of FIG. 2 the CMS 105 may receive and verify the transmitted social recovery verification codes. If (a sufficient number) of the social recovery verification codes provided by the owner of the user account 118 match the social recovery verification codes transmitted by the CMS 105 to the social recovery verification contacts 120, the CMS 105 may transmit the MCD backup encryption key 117 to the owner of the user account 118.

As shown by block 208 of FIG. 2 at some point, possibly before, during, or after any of the steps shown in blocks 202-207 of FIG. 2 the MCD 104 may retrieve the MCD private key encrypted backup 116 from the cloud server 115.

After the MCD 104 retrieves the MCD private key encrypted backup 116 and has obtained the MCD backup encryption key 117 transmitted by the CMS 105, as shown by block 209 of FIG. 2 the MCD 104 may recover the private key 110 by using the MCD backup encryption key 117 to decrypt the MCD private key encrypted backup 116.

FIG. 4 is a block diagram of a cryptocurrency management device (CMD), such as the CMD 103 of FIG. 1B. As shown by the figure, the CMD 103 may comprise at least one processor 403 that is connected to a communication interface 404 and a memory 405. The CMD 103 may be a stand-alone mobile device or other type of device, such as a desktop device that is not designed for mobility. In general, the processor 403 may interact and control these components, as well as other components of the CMD 103, to orchestrate the functioning of the device. The communication interface 404 may comprise circuitry that is configured to communicate with other devices over various communication channels.

For example, in some implementations the communication interface 404 may allow communications over only a short-range, peer-to-peer communication channel (e.g., Bluetooth, Near Field Communication (NFC), or radio frequency identification (RFID)). Alternatively, in some implementations the communication interface 404 may use networks such as the internet. As an example, the communication interface 404 may comprise modems, wireless radios (e.g., cellular transceivers), or other devices that are designed to wirelessly communicate with other devices or with network access points, such as cellular towers, network routers, Wi-Fi hots spots, or other types of access points. In general and as is relevant here, the communication interface 404 may be used to communicate with components of the cryptocurrency management system 102—such as the CMS 105 and the MCD 104—as well as with (particular nodes of) the cryptocurrency network 106.

Note that, in some implementations, the CMD 103 is deliberately designed to enable only short-range communication, such as NFC or Bluetooth, or via a direct wired connection, so that hackers are unable to access the CMD 103 from a remote location using a network, thereby enhancing security of the CMD 103 and the data stored therein.

The memory 405 is connected to and editable by the processor 403. The memory 405 may store, among other things, a cryptocurrency account private key 108 and device control logic 109. As described further below, the private key 108 is a cryptographic key associated with the private key of the public-private key pair (the private key of one of the public-private key pairs, for multi-signature addresses) of a cryptocurrency address (e.g., cryptocurrency address 107). As also described further below, the device control logic 109 may contain instructions that can be executed by the processor 403 to perform various functions of the CMD 103 described herein, including the initiation of or processing for a transaction involving the cryptocurrency address 107.

In operation, the processor 403 may execute the instructions of the device control logic 109 to manage the cryptocurrency assets associated with the cryptocurrency address 107. This may involve communicating with the CMS 105 and the MCD 104 to obtain (or produce) authorizing signatures as well as communicating with (nodes of) the cryptocurrency network 106. To obtain signatures from the CMS 105 or the MCD 104, the processor 403 may interact with the communication interface 404 to communicate with the CMS 105 and the MCD 104.

Note that the device control logic 109 can be implemented in software, hardware, firmware or any combination thereof. In the exemplary CMD 103 illustrated by FIG. 4, the device control logic 109 is implemented in software and stored in the memory 405. When implemented in software, the device control logic 109 can be stored and transported on any computer-readable medium for use by or in connection with an instruction execution apparatus that can fetch and execute instructions, such as the processor 403. In the context of this document, a “computer-readable medium” can be any means that can contain or store a computer program for use by or in connection with an instruction execution apparatus.

In some implementations the CMD 103 may have a biometric sensor 408 for authenticating an authorized user. For example, in some implementations, the biometric sensor 408 is a fingerprint sensor located on a surface of the CMD 103, but other types of biometric sensors 408 are possible in other examples. Other implementations may not have a biometric sensor.

Note that, in some implementations, the CMD 103 may not have access the internet or some other form of wireless network. Rather, in some implementations, the CMD 103 may communicate only via short-range communication channels, requiring any devices seeking to interact with the CMD 103, such as the MCD 104, to be brought into close physical proximity (e.g., within several feet) to the CMD 103. Limiting the range of the CMD 103 helps to enhance security by preventing at least some attempts by unauthorized user to access the data stored in the CMD 103. Indeed, the CMD 103 may be kept for extended times in a secure location inaccessible to many hackers. When communication with the CMD 103 is desired, such as for authorization of a transaction involving the cryptocurrency managed by the CMD 103, the MCD 104 may betaken to the CMD 103.

In some implementations, the CMD 103 may have a small, tag-like form factor that, among other things, allows the CMD 103 to be easily portable. When the CMD 103 is portable, it may be taken to a location associated with a transaction, such a location of a sale of product or service to be purchased by the cryptocurrency so that it is unnecessary to bring the MCD 104 to the secure location (e.g., home of the user) where the CMD 103 is normally kept. In other implementations, the CMD 103 may have a larger, less portable form factor.

FIG. 5 is a block diagram of a mobile communication device (MCD), such as the MCD 104 of FIG. 1B. The MCD 104 may be implemented as a smartphone, but other types of MCDs 104 are possible, such as a laptop or other type of hand-held for example.

As shown by the figure, an MCD 104 may comprise at least one processor 503 that is connected to a network interface 504, and a memory 505. In general, the processor 503 may interact and control these components, as well as other components of the MCD 104, to orchestrate the functioning of the device. The network interface 504 may comprise circuitry configured to communicate with other devices over various networks, such as the internet. As an example, the network interface 504 may comprise modems, wireless radios (e.g., cellular transceivers), or other devices that are designed to communicate with network access points, such as cellular towers, network routers, Wi-Fi hots spots, or other types of access points.

Through these access points, the MCD 104 may communicate with various networks, such as a cellular network, Wi-Fi network, the Internet, or other networks or combinations of networks. Through these various networks, the MCD 104 may communicate with components of the cryptocurrency management system 102—such as the CMD 103 and the CMS 105—as well as with (particular nodes of) the cryptocurrency network 106). Any of the components of the cryptocurrency management system 102, including the MCD 104, may include other types of interfaces, such as a short-range communication interface. The MCD 104 may also include other types of interfaces. For example, in some implementations the MCD 104 may include a short-range communication interface, such as a near field communication (NFC) or Bluetooth transceiver, for enabling wireless communication with other devices close to the MCD 104.

The memory 505 is connected to and editable by the processor 503. The memory 505 may store, among other things, a cryptocurrency account private key 110 and device control logic 114. As described further below, the private key 110 is a cryptographic key associated with the private key of the public-private key pair (the private key of one of the public-private key pairs, for multi-signature addresses) of a cryptocurrency address (e.g., cryptocurrency address 107). As also described further below, the device control logic 114 may contain instructions that can be executed by the processor 503 to perform various functions of the MCD 104 described herein, including the initiation of or processing for a transaction involving the cryptocurrency address 107.

In operation, the processor 503 may execute the instructions of the device control logic 114 to manage the cryptocurrency assets associated with the cryptocurrency address 107. This may involve communicating with the CMD 103 and CMS 105 to obtain (or produce) authorizing signatures as well as communicating with (nodes of) the cryptocurrency network 106. To obtain signatures from the CMD 103 or CMS 105, the processor 503 may interact with the network interface 504 to communicate with the CMD 103 and CMS 105.

Note that the device control logic 114 can be implemented in software, hardware, firmware or any combination thereof. In the exemplary MCD 104 illustrated by FIG. 5 the device control logic 114 is implemented in software and stored in the memory 505. When implemented in software, the device control logic 114 can be stored and transported on any computer-readable medium for use by or in connection with an instruction execution apparatus that can fetch and execute instructions, such as the processor 503. Relatedly, in some implementations the device control logic 114 may be part of a software application running on the MCD 104.

In some implementations, the MCD 104 may also comprise an input device 508 and an output device 509. Generally speaking, the output device 509 is configured to communicate information to a user through some mechanism, such as a digital display. The processor 503 may interact with the output device 509 to transmit data to the user. Conversely, the input device 508 is configured to receive input from the user of the MCD 104. For example, the input device 508 may be a touch screen that is capable of receiving user input in the form of taps, gestures, and other physical interactions with the screen. As indicated by this example, the input device 508 and the output device 509 may, in some implementations, comprise the same device (e.g., a touchscreen display). Additionally, in some implementations, either or both of the input device 508 and the output device 509 may comprise more than one physical device.

FIG. 6 is a block diagram of a cryptocurrency management server (CMS), such as the CMS 105 of FIG. 1A-1B. As shown by the figure, the CMS 105 may comprise at least one processor 603 that is connected to a network interface 604 and a memory 605. In general, the processor 603 may interact and control these components, as well as other components of the CMS 105, to orchestrate the functioning of the device. The network interface 604 may comprise circuitry configured to communicate with other devices over various networks, such as the internet. As an example, the network interface 604 may comprise modems, wireless radios (e.g., cellular transceivers), or other devices that are designed to communicate with network access points, such as cellular towers, network routers, Wi-Fi hots spots, or other types of access points. In general and as is relevant here, the network interface 604 may be used to communicate with components of the cryptocurrency management system 102—such as the CMD 103 and the MCD 104—as well as with (particular nodes of) the cryptocurrency network 106).

The memory 605 is connected to and editable by the processor 603. The memory 605 may store, among other things, a cryptocurrency account private key 115 and server control logic 119. As described further below, the private key 115 is a cryptographic key associated with the private key of the public-private key pair (the private key of one of the public-private key pairs, for multi-signature addresses) of a cryptocurrency address (e.g., cryptocurrency address 107). As also described further below, the server control logic 119 may contain instructions that can be executed by the processor 603 to perform various functions of the CMS 105 described herein, including the initiation of or processing for a transaction involving the cryptocurrency address 107.

In operation, the processor 603 may execute the instructions of the server control logic 119 to manage the cryptocurrency assets associated with the cryptocurrency address 107. This may involve communicating with the CMD 103 and the MCD 104 to obtain (or produce) authorizing signatures as well as communicating with (nodes of) the cryptocurrency network 106. To obtain signatures from the CMD 103 or the MCD 104, the processor 603 may interact with the network interface 604 to communicate with the CMD 103 and the MCD 104.

Note that the server control logic 119 can be implemented in software, hardware, firmware or any combination thereof. In the exemplary CMS 105 illustrated by FIG. 6 the server control logic 119 is implemented in software and stored in the memory 605. When implemented in software, the server control logic 119 can be stored and transported on any computer-readable medium for use by or in connection with an instruction execution apparatus that can fetch and execute instructions, such as the processor 603.

FIG. 7 is an illustration of an exemplary MCD 104 having a digital screen as previously described. Specifically, the MCD 104 of FIG. 7 (also referred to as the smartphone 702) is implemented as a smartphone having a touch screen 705 on one side of the device (i.e., device front 703) and a camera 706 on the opposite side (i.e., device back 704). The touch screen 705 covers much of the device's front side 703 and implements both the input device 508 and the output device 509 of FIG. 5. The touch screen 705 is capable of giving output by displaying images and video. The touch screen 705 is also capable of receiving user input in the form of taps, gestures, and other physical interactions with the screen. Not shown are the processor and memory internal to the MCD 104 (smartphone) 702 but which function similarly to the processor 503 and the memory 505 of FIG. 5.

During the recovery period, where a user has initiated a key recovery with the CMS 105 but has not yet completed the process, additional security procedures may be engaged by the CMS 105. As background, when a key is permanently lost, the two remaining keys may still be used to generate transactions. If desired, during the recovery process, various constraints, such as spending limits may be enforced to permit use of least some funds until the recovery process is completed. If desired, during the recovery process, various constraints, such as spending limits may be enforced to permit use of least some funds until the recovery process is completed.

For example, in some implementations, the system 102 is configured to implement a process, referred to hereafter as “Delay and Notification Process” for transactions during the recovery process. In this regard, once a notification of a permanently lost key is received, the system 102 is configured to delay transactions and provide notifications of the transactions during the delay so that the authorized user can take steps to stop or prevent unauthorized transactions. For example, in the example described above where the CMD 103 is permanently lost, the application on the MCD 104 may be configured to permit at least some transactions during the recovery period, such as transactions within certain predefined spending limits. However, when a transaction is requested, the MCD 104 is configured to delay sending a fully authenticated request to the cryptocurrency network 106 for at least a predefined amount of time in order to allow the authorized user to cancel the transaction before the request is sent to the network 106.

In some implementations, the CMS 105 may request a plurality of social recovery contacts to provide a valid code rather than a single social recovery contact in an effort to provide additional security. Additionally, some implementations may employ, until the recovery process is complete, the Delay and Notification Process described above. This may be used to enable the authorized user to cancel any fraudulent transactions that may be attempted during the recovery process. Thus, rather than rely on passwords and PIN s for recovery, the system 102 allows the authorized user to use social recovery contacts to help authenticate the user for key recovery, although it is possible for the system 102 to use passwords and PIN s as well, if desired.

Note that the system 102 may permit the authorized user to list a plurality of social recovery contacts and allow recovery if a minimum number of the social recovery contacts provide valid codes where the minimum number is less than the total number of social recovery contacts. As an example, the user may define x number of social recovery contacts, and the CMS 105 may provide its stored key for recovery if any of at least y social recovery contacts provide a valid code, wherein y is less than x. Thus, recovery is permitted even if less than all of the social recovery contacts are available for verification.

In addition, the application of the MCD 104 is configured to send one or more notifications of the transaction request to a trusted destination, such as phone number or email address, that is established by the authorized user during registration or updated by the authorized user. Such notification may include details of the requested transaction, information regarding steps that the user may take to cancel the transaction, and the amount of time remaining in the delay window until the transaction will be submitted to the cryptocurrency network 106. Thus, if a fraudulent transaction is requested, the authorized user should receive notification of the fraudulent request and information on steps that the user may take to cancel the request before it is submitted to the cryptocurrency network 106. If the delay window expires without the authorized user taking such steps to cancel the request, then the application on the MCD 104 may be configured to submit the transaction request to the cryptocurrency network 106. Thus, during the recovery process, the authorized user should be given notification of requested transactions and sufficient time to take steps to prevent fraudulent transactions before they are sent to the cryptocurrency network 106 for processing.

FIG. 8 is a flowchart illustrating a process of recovering a lost private key 108 using delay and notify, as just described. For example, the process may be used after a user to activate a new CMD 103 after access to the previous CMD 103 is lost.

To start, as shown by block 802 of FIG. 8 the owner of the user account may interact with the CMS to transmit a CMD key rotation request to the CMS. In some implementations, this may involve the user logging into the user account 118 through the cryptocurrency management app 113, with the cryptocurrency management app 113 then transmitting the CMD key rotation request from the MCD 104 to the CMS 105. Alternatively, in some implementations the user may log into the user account 118 through an online web portal associated with the CMS 105 and transmitting the CMD key rotation request to the CMS 105 through this web portal. In some implementations, the CMS 105 may require the user to provide authenticating information indicating the request is from the owner of the user account 118 before acting on the CMD key rotation request. For example, in some implementations the CMS 105 may require the user to provide the login credentials used to access the user account 118 (e.g., a username and password). As another example, the CMS 105 may require the user to generate valid signature of a hash of data provided to the user by the CMS 105 using one of the private keys associated with the cryptocurrency address 107, such as the private key 110. The CMS 105 may then use the corresponding public key to verify the authenticity of the signature and—by also hashing the data it provided to the user—verify that the signature is for the hash sent to the user.

After the key recovery request is transmitted, as shown by block 803 of FIG. 8 the CMS may receive and then verify the CMD key rotation request. This may involve, for example, the CMS verifying that the CMD key rotation request includes required authentication information.

After receiving and verifying the CMD key rotation request, as shown by block 804 of +8 the CMS may initiate a CMD key rotation countdown according to the security policy of the user account.

Additionally, after receiving and verifying the CMD key rotation request, as shown by block 805 of FIG. 8 the CMS may transmit to the owner of the account CMD key rotation-initiated messages through contact information for the owner of the account stored in the security policy.

After the CMD key rotation countdown expires without being cancelled, as shown by block 806 of FIG. 8 the CMS cooperates with the MCD to authorize a transaction transferring the funds associated with the cryptocurrency address to a new multi-signature cryptocurrency address secured by the private keys of the CMS, MCD, and the replacement CMD. For example, in some implementations, the MCD 104 may receive the public key of the replacement CMD and generate a transaction that moves the funds to a multi-signature cryptocurrency address that corresponds to the existing public keys of the CMS 105 and the MCD 104 and the new public key of the replacement CMD, sign with its own private key, and then have the replacement CMD and CMS 105 sign with their corresponding private keys so that only the private key of the replacement CMD is replaced. In another example, the CMS 105 and MCD 104 may each generate a new public/private key pair, the CMS 105 may send its new public key to the MCD 104, the MCD may receive the new public key of the replacement CMD and generate a transaction that moves the funds to a multi-signature cryptocurrency address that corresponds to the new public keys of the CMS 105, the MCD 104 the replacement CMD, sign with its own new private key, and then have the replacement CMD and CMS 105 sign with their corresponding private keys so that only the private key of the replacement CMD is replaced.

After the funds associated with the cryptocurrency address are transferred to the new multi-signature cryptocurrency address, as shown by block 807 of FIG. 8.

In some implementations, the MCD 104 and CMD 103 may work together to generate an authorization token that the CMS 105 may use to determine whether changes may be made to a user's security policy. The MCD 104 sign an authorization token with its private key and also have the CMD 103 sign the authorization token, store the token, and then transmit the authorization token to the CMS 105 whenever the MCD 104 is requesting a change in a security policy based on input from a user. For example, the user may request the spending limit be increased and the MCD 104 may then send a request for the increase along with the authorization token. The CMS 105 may authenticate that the authorization token is valid based on the public keys of the MCD 104 and the CMD 103 before completing the request.

In some implementations, the authorization token may also be used in a delay and notify and notify process. For example, where a thief steals a user's MCD 104 and is attempting to pair the MCD 104 with a different CMD. The CMS 105 may permit a MCD 104 that holds the most recently generated authorization token to initiate the delay and notify process once. If the delay and notify process is canceled, or the CMS 105 sees that another MCD has a more recently generated authorization token, the CMS 105 may require additional verification to initiate the delay and notify process. For example, the CMS 105 may require that a customer service agent provide a manual approval after the agent has received sufficiently authentication information from a user of the MCD making the request. The use of the authorization token in such a way may allow the CMS 105 to automatically prevent a thief from initiating multiple delay and notify requests using a stolen MCD 104.

In some implementations, the MCD backup encryption key 117 may be encrypted using a public-key cryptographic scheme where the corresponding private keys are known or otherwise accessible by the social recovery contacts. Specifically, a public-key encryption system may be employed using pairs of public and private keys, where public keys are used to encrypt information and private keys are used to decrypt information. At a broad level, each of the social recovery contacts may have a device associated with a pair of public and private keys. The public key may be used to encrypt information about the MCD backup encryption key 117, requiring the corresponding private key to later decrypt. This may require the participation of the social recovery contact's device, which may be configured to require the approval of the social recovery contact. Finally, this in turn may involve the owner of the user account 118 communicating with the social recovery contact in a social recovery process like the one described above.

For example, in one implementation, when the owner of the user account 118 provides the social recovery contact information 124 for the social recovery contacts 120, the CMS 105 may utilize the social recovery contact information 124 to communicate with (a device of) the social recovery contacts 120. Subsequently, the CMS 105 may prompt the social recovery contacts 120 to download and install an application on their electronic devices. After the applications are installed, the CMS 105 may interaction with the applications—specifically, the instances of the application running on each social recovery contact's respective device—to cause the applications to each generate a public/private key pair and then transmit the public key of each key pair to the CMS 105. After receiving these public keys, the CMS 105 may then forward the public keys to the MCD 104. After receiving the public keys from the CMS 105, the MCD 104 may utilize the public keys to encrypt the MCD backup encryption key 117 such that a (possibly improper) subset of the corresponding private keys is needed to decrypt the encrypted MCD backup encryption key 117.

For instance, in some implementations, the MCD 104 may employ a secret sharing scheme (e.g., Shamir's secret sharing scheme, Blakley's secret sharing scheme, etc.) to split the MCD backup encryption key 117 into a number of shares equal to the number of public keys. The secret sharing scheme distributes information among the shares such that a threshold number of the shares may be used to recover the original unencrypted MCD backup encryption key 117. Each of these shares may be assigned to one of the public keys and then encrypted using that public key, yielding an encrypted share. This encrypted share must be decrypted by the corresponding private key before it can be used with other (decrypted) shares to recover the MCD backup encryption key 117. The MCD 104 may store these encrypted shares in a cloud backup accessible to the MCD 104.

For example, if the owner of the user account 118 lists social recovery contacts 121, 122, and 123 as his only social recovery contacts. The MCD 104 may receive three public keys, one for each of the three social recovery contacts. The MCD 104 may be configured to utilize a secret sharing technique to split the MCD backup encryption key 117 into three shares where any two of the shares may be used to recover the MCD backup encryption key 117.

These three public keys may be used to generate encrypted shares where any two of the three shares—after being decrypted by their associated public keys' corresponding private key—may be used to recover MCD backup encryption key 117 the MCD 104 may then associate each share with one of the social recovery contacts 121, 122, and 123—the shares associated with different social recovery contacts- and encrypt the three shares with the public key corresponding to their associated social recovery contact. The MCD 104 may then store these three encrypted shares in a cloud backup accessible to the MCD 104.

In this implementation, when social recovery is initiated, the MCD 104 may download the corresponding encrypted shares of the MCD backup encryption key 117 and transmit those encrypted shares to the CMS 105. After it receives the encrypted shares, the CMS 105 may identify which of the social recovery contacts 120 each of the encrypted shares are associated with and then send the encrypted shares to the corresponding applications of the social recovery contacts 120. The applications of the social recovery contacts 120 may then prompt the social recovery contacts 120 to confirm the owner of the user account 118 contacted them for recovery. The applications, after receiving confirmation from their corresponding social recovery contacts, may each decrypt their respective encrypted shares with their private key (i.e., the private key from the same key pair as the public key initially transmitted to the CMS 105) and transmit their decrypted shares to the CMS 105. The CMS 105 may then reconstitute the MCD backup encryption key 117 once it receives sufficient number of decrypted shares. After it has reconstituted the MCS backup encryption key 117, the CMS 105 may transmit the now reconstituted MCD backup encryption key 117 to the MCD 104.

Note that, in some implementations, instead of transmitting a reconstituted MCD backup encryption key to the MCD 104, the CMS 105 may instead forward the decrypted shares to the MCD 104. After receiving these decrypted shares, the MCD 104 may then itself reconstitute the MCD backup encryption key 117. In yet other implementations, access to the MCD backup encryption key 117 may be limited from the MCD backup encryption key 117 by having the applications on the devices of the social recovery contacts 120 encrypt the decrypted shares with another public key that has a corresponding private key that is known to the MCD 104 but not to the CMS 105. This may allow the MCD 104 to decrypt using the now re-encrypted secrets shares and then reconstitute the MCD backup encryption key 117 while not allowing the CMS 105 to do the same.

Note that, in general, “communicating” with one of the social recovery contacts 120 using the social recovery contact information 124 may refer to either communicating with one of the social recovery contact's electronic devices or it may refer to communicating with the social recovery contact themselves (with the electronic device being a likely medium facilitating this communication). Broadly speaking, “communicating” refers to communicating with electronic devices for functional tasks such as generating and distributing cryptographic keys. When used to refer to permission or assent or to request information, “communicating” generally refers to “communicating” with the social recovery contact himself.

FIGS. 9A-9C are block diagrams of another example of a cryptocurrency management system 900. The system 900 can be used to facilitate a wide range of conditional transfers of cryptocurrency and other tokens. As shown in the figures, the cryptocurrency management system 900 includes several elements from FIG. 3A-3B, including the mobile communication device (MCD) 104 and the cryptocurrency management server (CMS 105). The cryptocurrency management device (CMD 103) may optionally be used also, but is not shown. The system 900 coordinates transfers of digital assets (e.g., cryptocurrency, tokens, etc.) through one or more blockchain networks, such as the cryptocurrency network 106. The system 900 can also include some or all of the other elements shown in FIG. 1A-3B, which are omitted simply for clarity in illustration.

The system 900 can provide users the ability to define and implement many types of conditional transfers. For example, the system 900 enables users to specify transfers of digital assets to occur automatically upon the detection of specified conditions. The system 900 can use the CMS 105 to perform monitoring and to detect when the conditions occur, to provide rapid and reliable processing. When desired by the user, the CMS 105 can execute conditional transfers that have been put in place without the need for involvement or further approval, to make sure the user's instructions are carried out.

The system 900 can enhance versatility and security of conditional transfers by structuring them in multiple stages. For each set of transactions, the system 900 can create an intermediate address to be used for temporary storage of digital assets. The first stage can include a transaction that transfers digital assets from a source address to the intermediate address. The second stage can include one or more options for transferring digital assets from the intermediate address to one or more destination addresses. For example, one transaction can be defined to transfer the digital assets from the intermediate address to a recipient if a first set of conditions are satisfied, including a time delay set relative to the completion of the first stage. Another transaction can be defined to transfer the digital assets in a different manner, such as a transfer to a different set of recipients, a transfer of a different distribution of digital assets, or a transfer with a different set of conditions (e.g., with different signatures needed, with a different time delay or no time delay, etc.).

When the system generates the transactions for the second stage, the system 900 signs the transactions with a private key for the intermediate address. The system 900 then discards the private key for the intermediate address, so that system 900 is no longer able to alter the transactions or add new alternative transactions of digital assets from the intermediate address without the private key for the source address. In effect, this limits the options for transfer so that, once the conditional transfer process is initiated, the digital assets can be transferred without the source address private key only as specified using one or more of the predefined, pre-signed transactions that have been generated and stored. This provides increased security by ensuring that the conditional transfer process will not perform any transfer of the digital assets except using the digital asset quantities, conditions on execution, and destinations that the predefined transactions specify. The arrangement retains the flexibility to respond to different conditions, because the system 900 retains the ability to selectively publish transactions to the cryptocurrency network 106, and the predefined transactions themselves provide alternative transfers for different conditions. Nevertheless, even the CMS 105 that facilitates the conditional transfer is cryptographically blocked from performing any transfer that the user did not previously approve.

The system 900 can provide the user that sets up the conditional transfer the ability to cancel or rescind the conditional transfer, even after the first stage of the transfer process has been performed. This can be achieved by placing a time delay requirement on execution of the second stage of the conditional transfer, and enabling the user to transfer digital assets back to the source address during the time delay window. For example, the intermediate address can beset up so that the user can transfer digital assets from the intermediate address back to the source address using the source address private key, without requiring any signature by the intermediate address private key. As another example, a pre-defined transaction to return digital assets from the intermediate address to the source address can be created and pre-signed using the intermediate address private key. These and other techniques allow the user to reverse the initial transfer in the first stage of the conditional transfer process. Removing the digital assets from the intermediate address will have the effect of cancelling the second stage of the conditional transfer, because the digital assets that would be transferred by the second-stage transaction options are no longer available to be transferred (e.g., no longer at the intermediate address).

Using these and other techniques, the system 900 can automatically and securely manage a set of transactions according to established rules and guidelines specified by one or more users. The system 900 combines different mechanisms, including multi-stage transfers, key deletion, off-chain storage, and time locks to regulate which transactions are broadcast to a blockchain network for execution and when the transactions are broadcast, thereby enhancing the reliability and security in transaction management. The conditional transfers can be used in many different situations. As an example, the system 900 can facilitate reliable and secure transfer of digital assets from an owner to one or more heirs after the death of the owner. As another example, the system 900 can facilitate the recovery of assets after the private key of an address is lost, by using a pre-defined conditional transfer to transfer digital assets into a different address for which the private key is known. The conditional transfer functionality enables many other uses, including complex interactions with alternative transfers that take place under different sets of conditions.

FIGS. 9-9B illustrate techniques for setting up conditional transfers, including generating and storing transactions that are at least partially signed in advance. FIG. 9C illustrates techniques used after a conditional transfer is set up, such as triggering and executing conditional transactions when appropriate conditions are satisfied. FIGS. 9-9C illustrate multiple operations and a flow of data which is represented by stages (A) to (J), which can be performed in the order labeled or in another order.

FIG. 9 shows how the MCD 104 and CMS 105 interact to set up a conditional transfer, for example, various types of transfers to be performed if certain events or conditions occur in the future. The MCD 104 and the CMS 105 each can interface with each other and with the cryptocurrency network 106 over a communication network 905, e.g., a wired or wireless communication link which may include the Internet.

The MCD 104 can create a set of transactions 920, which specify types of transfers to be performed under different conditions. The set of transactions 920 can include multiple alternative transactions that may be configured to transfer the same digital assets in different ways, depending on the circumstances. The cryptocurrency management system 900 thus provides the versatility to match the timing of transfers and the types of transfers to future-arising conditions, while also providing a secure implementation that disallows transfers other than those defined in advance or approved with the user's private key. The techniques can be used in a variety of situations, such as to enable conditional transfers, to recover digital assets in the event that a key is lost, to transfer assets in the event that an asset owner dies, and so on.

During stage (A), the MCD 104 receives transfer parameters 906 for a conditional transfer. In the example, the user of the MCD 104 is the owner of digital assets associated with a source address 910 in the cryptocurrency network 106. The owner provides user input to the MCD 104 to indicate the nature of a conditional transfer of digital assets from the source address to one or more destination addresses DA1-DAN.

For example, the owner may interact with a user interface of the cryptocurrency management app 113 (see FIGS. 1A-1B) to specify the type of transfer to beset up. For example, the owner can specify one or more recipients for digital assets and the respective amounts of digital assets to be provided to each of the one or more recipients. The recipients may be specified by user account known to the CMS 105 or through destination addresses DA1-DAN for the recipients in the cryptocurrency network 106. The amount of cryptocurrency assets to be received by each of the one or more recipients may be defined, for example, as a percentage of the total amount of cryptocurrency assets or as a fixed value (e.g., a fixed number of cryptocurrency tokens).

The owner can also specify conditions that must be satisfied in order for the conditional transfer to take effect. These can include conditions such as time delays, signatures by one or more authorized approvers designated by the user, a triggering condition such as a report to the CMS 105 related to the owner or the source address (e.g., that the owner has died, or that the source account private key is lost).

In specifying the transfer parameters 906, the owner can specify alternative sets of transactions to be performed, which may have different conditions required for execution. For example, one transaction option may provide digital assets to a recipient with a time delay (e.g., 1-month) after a triggering event or condition is reported to the CMS 105. Another transaction option may provide the digital assets to the recipient with a shorter time delay (e.g., 1 week) if an authorized approver provides a signature to confirm that the triggering event or condition actually occurred. Another transaction option may provide a different distribution of the digital assets (e.g., to different recipients or in different amounts), depending on the timing of the triggering event or condition or other variables.

In many cases, it is beneficial for transfers to be conditioned on the confirmation or approval of an outside party. This can improve security by requiring the private key of one or more individuals or systems to confirm that a conditional transfer should proceed. This way, if a malicious actor spoofs or falsely reports the triggering event or condition that would set a conditional transfer into effect, the authorized approvers can block the transfer by withholding their signatures.

In addition, it is beneficial for at least some transfers to enforce a time delay after the triggering event or condition before the conditional transfer fully take effect. Among other benefits, this provides time for the owner to cancel the conditional transfer before it takes effect. If a user is reported to have died, for example, the CMS 105 can attempt to contact the user and the delay period allows the user to cancel the conditional transaction if the user is still alive.

For common types of conditional transfers, the system 900 can provide templates or recommended transfer types to facilitate transfers for common situations. These templates can minimize the effort needed by the owner, while still allowing customizability. For example, for an asset recovery scenario, the cryptocurrency management app 113 can have a default template for creating a conditional transfer that would enable the user to recover digital assets after a private key has been lost. The template can have fields for a destination address, an amount of time delay, and the set of authorized approvers authorized to confirm the transfer. The owner can then fill in those fields to specify, e.g., a secondary address of the owner as the recovery destination, a desired duration of time delay, and one or more friends or family members (or their addresses in the cryptocurrency network 106) that will be authorized approvers. As another example, for an inheritance scenario, the cryptocurrency management app 113 can have a default template or recommended transaction framework available, so the user can specify the amounts of digital assets to be provided to each recipient (e.g., each heir), along with specifying one or more authorized approvers (e.g., executors). The template can include various other features as discussed further below.

During stage (B), the MCD 104 generates a set of transactions 920 that is configured to provide the conditional transfer the user specified using the transfer parameters 906. The transactions 920 include multiple transactions 920a-920z that together implement the type of conditional transfer the owner of the source address 910 instructed. The transactions 920a-920z are not immediately published to the cryptocurrency network 106, but are instead held in reserve for use in response to a triggering event or condition (e.g., a report of a lost source address private key, a report that the owner of the source address 910 has died, or another predetermined event or condition). Some or all of the transactions 920a-920z may be signed by one or more private keys, to facilitate future execution of the transactions 920a-920z.

The set of transactions 920 is designed to perform the conditional transfer in multiple stages, with (1) a first stage transferring digital assets from the source address 910 to an intermediate address 912 and (2) the second stage transferring the digital assets from the intermediate address 912 to one or more destination addresses 914, 916, 918. As discussed further below, the first-stage transfer to the intermediate address provides additional security and versatility. For example, the first-stage transfer can facilitate a variety of timing conditions, with the execution of the first-stage transfer serving as a reference time to start delay periods for second-stage transfers. In addition, temporarily transferring digital assets to the intermediate address can cryptographically limit the set of transfers that can be performed, while retaining the ability for the owner to cancel the conditional transfer.

To create the set of transactions 920, the cryptocurrency management app 113 creates a new intermediate address 912 with a corresponding intermediate address private key 913. A new intermediate address is generated for each conditional transfer (e.g., each set of transactions 920), so the intermediate address private key 913 is known only to the cryptocurrency management app 113 on the MCD 104 and is not known by the CMS 105 or any other device or party. The new intermediate address 912 can be created in a manner that requires transactions that transfer of digital assets out of the intermediate address 912 to require, at a minimum, a signature using the intermediate address private key 913 or the source address private key 913. Individual transactions transferring digital assets out of the intermediate address 912 can each require other conditions as well.

As discussed further below, the intermediate address 912 can be generated so that transferring digital assets out of the intermediate address 912 requires one of various different sets of conditions to be satisfied. For example, the intermediate address 912 may allow cryptocurrency to be transferred out when either (1) a signature is made using one or more of the owner's private keys are used (e.g., the source address private key 911), or (2) a signature is made using the intermediate address private key 913 and a timelock period has elapsed. Other combinations of conditions, or more or fewer sets of conditions, can be used to limit the conditions under which transfers out of the intermediate address 912 are allowed.

With the intermediate address 912 created, the cryptocurrency management app 113 creates a first transaction 920a, which is a sweep transaction configured to transfer the digital assets specified in the transfer parameters 906 from the source address 910 to the intermediate address 912. This is indicated in the figure by the indication “SA→IA.” The first transaction 920a specifies an amount 921a of digital assets to be transferred, for example, a specific amount of a specific type of cryptocurrency (e.g., 5 Bitcoin). If the transfer parameters 906 specify the digital assets in a different manner, such as a percentage of the digital assets associated with the source address, the cryptocurrency management app 113 can determine and specify the actual quantity represented. Cryptocurrency networks often require transactions to be specified with a fixed value or absolute amount, instead of a relative amount such as a percentage. As a result, the cryptocurrency management app 113 can convert or translate a general instruction from the owner into a specific amount of cryptocurrency, so the first transaction 920a can be validly published and accepted in the cryptocurrency network 106.

To be accepted in the cryptocurrency network 106, the first transaction 920a would need to be signed using the source address private key 911 corresponding to the source address 910. The first transaction 920a, and in fact the set of transactions 920 as a whole, is created so it can be used later, without further action by the owner of the source address 910. To facilitate this, the cryptocurrency management app 113 obtains a signature 922a made using the source address private key 911. The cryptocurrency management app 113 may interact with the cryptocurrency management device (CMD) 103 of FIG. 1A-1B to obtain the signature 922a if the CMD 103 stores the source address private key 911. Alternatively, if the cryptocurrency management app 113 stores the source address private key 911 as illustrated, the cryptocurrency management app 113 can generate the signature 922a.

After the signature 922a is completed, the first transaction 920a is ready to be published and accepted in the cryptocurrency network 106, with no further signatures needed. However, the first transaction 920a is not published in the cryptocurrency network 106 at this time, and is instead held in reserve by the CMS 105 until the triggering event or condition specified in the transfer parameters 906 is detected. Preparing the first transaction 920a in this way will allow the conditional transfer the owner intends to be initiated by the CMS 105 without the CMS 105 knowing the source address private key 911. The owner can thus delegate the task of monitoring for the triggering event or condition to the CMS 105, so the CMS 105 can automatically initiate the conditional transfer on behalf of the user at a future time if appropriate.

For the second stage of the conditional transfer, the cryptocurrency management app 113 generates a second transaction 920b that is configured to transfer digital assets from the intermediate address 912 to a destination address 914 for the one or more recipients specified in the transfer parameters 906. This is represented in the figure by the indication “IA→DA1,” where DA1 refers to the destination address 914. If the transfer parameters 906 indicate a user as a recipient, rather than specifying an address in the cryptocurrency network 106, the cryptocurrency management app 113 can communicate with the CMS 105 to determine the corresponding address for the user based on user profiles stored by the CMS 105. If the transfer parameters 906 indicate multiple different recipients, the transaction 920b can be configured to send appropriate amounts of digital assets to each of several different destination addresses. As an alternative, multiple transactions can be created, each to transfer the appropriate amount for a different destination address.

The second transaction 920b specifies an amount 921b of digital assets to be transferred, which is some or all of the digital assets specified by the first transaction 920a. The cryptocurrency management app 113 creates the second transaction 920b, or multiple second transactions, to distribute the digital assets from the intermediate address 912 in the amount or proportion specified in the transfer parameters 906 set by the owner. As with the amount 921a indicated in the first transaction 920a, the amount 921b is a fixed value or absolute amount rather than a relative measure. The cryptocurrency management app 113 can convert or translate a relative instruction to a fixed, absolute amount or other format accepted by the cryptocurrency network 106. Thus, if the transfer parameters 906 indicate that 50% of digital assets associated with the source address 910 should be transferred to the destination address 914, and the source account includes 5 Bitcoin, then the cryptocurrency management app 113 can generate the second transaction 920b to transfer 2.5 Bitcoin to the to the destination address 914.

The cryptocurrency management app 113 also signs the second transaction 920b using the intermediate address private key 913, to obtain signature 922b. As discussed above, to transfer digital assets from the intermediate address 912, a signature using the intermediate address private key 913 or the source address private key 911 is needed. By pre-signing the second transaction 920b with the intermediate address private key 913, this requirement is satisfied.

The second transaction 920b typically has one or more additional conditions 923b that must be satisfied for the second transaction 920b to be accepted and executed in the cryptocurrency network 106. The conditions 923b can be requirements enforced by the cryptocurrency network 106 so that, if not met, the cryptocurrency network 106 would reject, block, or at least defer execution of the second transaction 920b until the conditions 923b are satisfied. In other words, the second transaction 920b is not valid and not accepted in the cryptocurrency network 106 until the conditions 923b are satisfied. The conditions 923b represent conditions in addition to the requirement that the second transaction 920b be signed using the intermediate address private key 913 or the source address private key 911. For example, the conditions 923b can include a timing condition (e.g., transaction does not take effect until a future time) and/or a requirement for an additional signature (e.g., from an authorized approver, from the CMS 105, etc.).

The conditions 923b can be implemented in any of various different ways. For example, in some implementations, the conditions 923b are set as requirements associated with the intermediate address 912, rather than conditions set for specific transactions. For example, the mobile app 113 can create the intermediate address 912 to limit payout of cryptocurrency from the intermediate address 912 to only when at least one of multiple sets of conditions are satisfied. One example is to make the intermediate address 912 a multi-signature address for which signatures from a minimum amount of keys in a predetermined set are needed for approval. In this manner, there may several different combinations of signatures or approvals that could make a transaction valid for execution in the cryptocurrency network 106. A single second transaction 920b could thus have different pathways for approval, due to the nature of the intermediate address 912, in addition to or instead of due to the features of the specific transaction. One example set of conditions can be a signature using one or more of the owner's keys (e.g., the source address private key 911 or another key of the owner). Another example set of conditions can be a signature using the intermediate address private key 913, approval of one or more of the authorized approvers, signature by a key of the CMS 105, and a first timelock. Another example set of conditions can be a signature using the intermediate address private key 913, approval of one or more of the authorized approvers, and a second timelock that is longer than the first timelock. In this manner, some or all of the conditions 923b may be defined and/or enforced through the characteristics of the intermediate address 912, rather than through the content or properties of the second transaction 920b itself.

The conditions 923b can include a timing condition that execution should not occur until after a particular period of time. Cryptocurrency networks may support different timing conditions, such timelocks that restrict the spending of cryptocurrency until a specified time in the future. Absolute timelocks can make digital assets unspendable until a specified time, and relative timelocks can make outputs unspendable until they have been confirmed in the blockchain for a specified amount of time. The time can be specified relative to, for example, the start of the blockchain, or relative to a transaction's inclusion in the blockchain, and can be specified as a minimum block height (e.g., so that transactions using the timelock are valid only in blocks with greater height) or as a number of seconds (e.g., so that case validity is determined by looking at timestamps for blocks).

However, even the relative timelock functionality may be limited and not allow a specified amount of time delay relative to the various triggering events or conditions that users may desire to set to initiate a conditional transfer. Nevertheless, the two-stage structure of the conditional transfer overcomes this limitation by allowing the execution of the first stage (e.g., the first transaction 920a) to set the reference time that starts the desired delay time period before the second stage (e.g., the second transaction 920b) executes. In other words, the triggering event or condition causes the first transaction 920a to be executed, and a timelock for the second transaction 920b can limit its execution until after a particular number of seconds or blocks after the first transaction 920a has been confirmed in the cryptocurrency network 106. This allows the set of transactions 920, as a whole, to provide conditional transfer functionality that sets a delay period, enforced by the cryptocurrency network 106, relative to any of a wide variety of future-arising events or conditions, even if the cryptocurrency network 106 does not support such versatile timing conditions natively.

As an example, the conditions 923b may include a timing condition to delay execution by six months from the arrival of digital assets at the intermediate address 912. The timing condition can be a transaction-based timelock, such as using the nLockTime of the Bitcoin blockchain, so that the transaction 920b is not valid until the specified timing condition is satisfied. A transaction-based timelock that affects a specific transaction (rather than one that locks digital assets against all transactions) is often desirable so the owner retains the ability to immediately cancel the conditional transfer during the delay period, and so that different alternative transactions can be used to address different situations. The detection of the triggering event or condition will cause the first transaction 920a to be published and executed in the cryptocurrency network 106 (see FIG. 9C). Then, the completion of the first transaction 920a transfers digital assets to the intermediate address 912, which begins the delay period specified by the timing condition of the conditions 923b. The timing condition may be specify, for example, that the transaction 920b is not valid until a particular number of blocks or seconds after the digital assets from the first transaction 920a arrive at the intermediate address 912.

As another example, the conditions 923b can include a requirement for a signature using another private key, such as one or more signatures from one or more private keys 952a, 952b of authorized approvers indicated in the transfer parameters 906. As another example, the conditions 923b may require the CMS 105 to provide a signature using a server private key 930, which the CMS 105 may provide in the future only if appropriate transaction policies 934 are satisfied. The requirement for additional signatures can be useful in many scenarios, such as to provide a friend to act as the authorized approver before transferring digital assets in the event of a lost source address private key 911 or the report of the death of the owner of the source address 910. A requirement for additional signatures can be used to verify or corroborate the existence of the triggering event or condition that starts the conditional transfer, giving greater confidence and security that the transfer is being performed properly.

If the transfer parameters 906 identify authorized approvers by name, user account, or other similar identifier, the cryptocurrency management app 113 can communicate with the CMS 105 to obtain the appropriate addresses of other information for the approvers. The user profiles 936 can associate users with corresponding addresses in the cryptocurrency network 106 and/or public keys, so the CMS 105 can map from an address and/or public key to a user account or user name. As a result, the cryptocurrency management app 113 can obtain the information needed to make the second transaction 920b or any other second-stage transactions require a signature from the appropriate approver private key 952a, 952b as specified in the transfer parameters 906.

The second transaction 920b is generated and stored but is not published to the cryptocurrency network 106 at this time. However, unlike the first transaction 920a, the second transaction 920b is unfinalized and is not yet in a state in which it can be validly submitted to the cryptocurrency network 106. For example, although the signature 922b using the intermediate address private key 913 is present, the conditions 923b are not yet satisfied (e.g., a timing condition is not satisfied, an additional signature is still needed, etc.). This allows the conditional transfer process to incorporate additional verification steps (e.g., through subsequent signatures from authorized approvers) and intentional delay periods to allow for notification and potentially cancellation by the owner.

The cryptocurrency management app 113 can generate other transactions for the set of transactions 920 when appropriate. For example, the cryptocurrency management app 113 can generate multiple second transactions, each of which may have different sets of conditions. One transaction may require a delay period and one additional signatures, while another transaction may require two additional signatures and a shorter delay period (or no delay period) due to the multiple signatures providing greater confidence. Thus, different transactions in the set of transactions 920 can provide alternative ways to transfer the same digital assets from the intermediate address 912, with the different transactions becoming valid when different sets of conditions are satisfied.

Optionally, the cryptocurrency management app 113 may generate one or more return transactions that are configured to transfer the digital assets from the intermediate address 912 back to the source address 910, effectively reversing the first transaction 920a. A return transaction would have the effect of cancelling the conditional transfer after the first transaction 920a is executed but before the second transaction 920b or similar second-stage transactions are executed. In some implementations, the source address private key 913 enables the owner of the source address 910 to create and sign a valid return transaction at any time, so that no return transaction needs to be generated as part of the set of transactions 920 while the owner retains the source address private key 913. Nevertheless, in some implementations, if the intermediate address 912 requires a signature from the intermediate address private key 913 to transfer digital assets from the intermediate address 912, the cryptocurrency management app 113 can create, sign, and store a return transaction using the intermediate address private key 913.

Referring to FIG. 9B, during stage (C), the cryptocurrency management app 113 discards (e.g., deletes) the intermediate address private key 913 after the set of transactions 920 is created. By discarding the intermediate address private key 913, the cryptocurrency management app 113 blocks the generation of any further transactions that would transfer digital assets from the intermediate address 912. This has the effect of blocking the editing or creation of transactions of cryptocurrency assets from the intermediate address 912. The transaction 920b and other second-stage transactions from the set of transactions 920 cannot be edited, and no new second-stage transactions can be created without the source address private key 912. As a result, without the source address private key 912, the CMD 103 or any other party would be limited to making transfers as specified in the set of transactions 920.

With the intermediate address private key 913 unavailable, once the conditional transfer process is initiated, the digital assets can only be transferred from the intermediate address 912 using one or more of the predefined transactions of the set of transactions 920. This provides increased security by limiting the types of transfers that another part or system can perform to a discrete set of options included in the set of transactions 920. Even if the owner of the source address 910 allows another party or system, such as the CMS 105, to handle the conditional transfer process, no transfers out of the intermediate address 912 can be made without the source address private key 911 except using the cryptocurrency asset quantities, conditions on execution, and destinations that the predefined set of transactions 920 specifies.

During stage (D), the MCD 104 sends the set of transactions 920 to the CMS 105 over the communication network 905. The MCD 104 can also send some or all of the transfer parameters 906, such as data identifying the trigger event or condition that is specified to initiate the conditional transfer (e.g., trigger publication of the first transaction 920a to the cryptocurrency network).

When the set of transactions 920 is sent, none of the transactions 920a-920z in the set of transactions 920 have been published or executed in the cryptocurrency network 106. The CMS 105 is configured to assist the owner of the source address 910 in managing the conditional transfer, and the owner delegates to the CMS 105 the capability to initiate and carry out the conditional transfer. Once the set of transactions 920 is transferred to the CMS 105, the CMS 105 can carry out the conditional transfer that the owner desires automatically, without requiring any further involvement from the owner, the MCD 104, the cryptocurrency management app 113, and the source address private key 911.

During stage (E), the CMS 105 receives the set of transactions 920 from the MCD 104 and stores the set of transactions 920 in off-chain storage 940. The off-chain storage 940 can include one or more computer memory devices, such as a hard drive, flash drive, network-attached data storage, etc. The off-chain storage 940 is data storage that is separate from and/or independent of the cryptocurrency network 106. The CMS 105 maintains the set of transactions 920 in reserve, e.g., keeps the transaction off from the cryptocurrency network 106, until appropriate conditions are satisfied (e.g., the triggering event or condition occurs for the first transaction 920a, and for the second transaction 920b the additional conditions 923b are also satisfied).

The CMS 105 also stores information about the conditional transfer as stored transfer parameters 932. For example, CMS 105 can store the triggering event or condition that should initiate the conditional transfer (e.g., loss of the source address private key 911, or death of the owner of the source address 910), and associate it with the corresponding set of transactions 920. The CMS 105 can register many different conditional transfers for many different users, and can store the triggering events or conditions and the corresponding sets of transactions for each conditional transfer.

In the stored transfer parameters 932, the CMS 105 can also store information about the state of the source address 910 and the digital assets involved in the conditional transfer. As discussed below, if the owner transfers some of the digital assets, the set of transactions 920 may no longer be possible or may no longer provide the result the owner specified, and so the set of transactions 920 may need to be replaced with a new set of transactions (see FIG. 30. With stored information about the amount of digital assets currently associated with the source address 910, or the amount of digital assets involved in the set of transactions 920, the CMS 105 can more easily detect when a change prompts generation of new set of transactions.

At this point, the conditional transfer has been arranged, and the CMS 105 is able to act on behalf of the owner of the source address 910 to perform the conditional transfer. The CMS 105 has the ability to determine when the triggering event or condition has occurred, but due to the way the intermediate address 912 and the set of transactions 920 are arranged, the CMS 105 is limited to carrying out only the specific transfers the owner has authorized. In other words, the CMS 105 can determine when to activate the conditional transfer, but can only transfer digital assets in the specific paths or transactions in the set of transactions 920 that the owner has authorized in advance. This limitation is enforced cryptographically, due to the CMS 105 not having access to the source address private key 911 and because the intermediate address private key 913 has been discarded. In addition, the timing conditions for transactions are enforced by the cryptocurrency network 106, which can reject, block, or defer execution of any transactions that have not satisfied their timing conditions.

Arranging conditional transfers as shown in FIGS. 9A-9B can provide several significant advantages. For example, the arrangement allows complex conditional behavior, including with functionality that is not natively supported by the cryptocurrency network 106. The set of transactions 920 can include multiple alternative second-stage transactions as different options, while still preventing the CMS 105 (and any other party without the source address private key 911) from editing or adding to the options the owner specified. The owner also retains the ability to cancel the conditional transfer, even after the triggering event or condition occurs, e.g., by issuing a transaction signed using the source address private key 911 after the first transaction 920a but before the conditions for second-stage transactions (e.g., the second transaction 920b) are satisfied.

In addition, using the CMS 105 to carry out aspects of conditional transfers also provides significant advantages. For example, the CMS 105 is able to monitor and respond to wide range of events and conditions, which allows versatility in the triggers used for initiating conditional transfers. In addition, the CMS 105 can initiate and carry out conditional transfers automatically on behalf of a user, so that the user is not required to initiate or confirm the transfer. This is especially valuable when the user and/or the user's private key are not available. The way the set of transactions 920 is structured still limits the CMS 105 does not make any transfers other than those the user has specified, and also under the conditions the user has specified. As another example, the CMS 105 can provide robust notifications to the owner and others when the conditional transfer is triggered, which facilitates gathering of needed signatures and can allow the owner sufficient notice to cancel a conditional transfer in progress.

As another example, delegating management to the CMS 105 allows the conditional transfer to be kept confidential. The existence of the conditional transfer arrangement and the nature of the various transactions in the set of transactions 920 does not need to be made public until conditions are satisfied for publication in the cryptocurrency network 106. In some cases, smart contracts can be used to provide conditional transfers, but this typically requires publishing the smart contracts and making them available for public inspection which may not be desirable in all circumstances. By contrast, the CMS 105 stores the set of transactions 920 in off-chain storage 940, where the amounts of digital assets, destination addresses, source addresses, and conditions, as well as the existence of the conditional transfer itself, can all be kept confidential until the appropriate time for the conditional transfer to be executed.

Referring to FIG. 9C, after a conditional transfer has been setup, the CMS 105 can perform various actions to monitor for the conditions that would cause the conditional transfer to take effect. The CMS 105 can monitor many different types of conditions corresponding to the conditional transfers of many different users, but for clarity in illustration an example for only a single conditional transfer is shown.

The CMS 105 can provide interfaces to facilitate the detection of events and conditions that trigger conditional transfers. For example, the CMS 105 can provide a website or web application through which users can report that various events and conditions. Similarly, the CMS 105 can provide an application programming interface (API) through which reports can be made. Through any of these interfaces, a user can report, for example, that the private key for their address has been lost. Similarly, individuals may use the interfaces to report when another user has died or become incapacitated. In many cases, the triggering event or condition for a conditional transfer may be one that is reported by users. Nevertheless, in other cases, the triggering event or condition may be determined from other sources, such as another server system, a website, a database, a sensor, etc. As part of its monitoring, the CMS 105 may periodically request information from various data sources to determine if any triggering events or conditions for conditional transfers have occurred. When a triggering event or condition is detected, the CMS 105 can proceed as described in stages (F) through (J).

During stage (F), the CMS 105 detects the triggering event or condition associated with the set of transactions 920. The detection may be a result of a report from a user or through another means. For example, if the triggering event or condition is that the owner of the source address 910 has died, a user may report that the owner has died through an interface of the CMS 105 or a message to the CMS 105. As another example, the CMS 105 may obtain the same information from an obituary from a news server or a death record from a government server.

The CMS 105 can compare monitoring data it generates with the various triggering events or conditions specified in the stored transfer parameters 932. In this way, the CMS 105 can determine when one of the triggering events or conditions occurs and which of the pre-arranged conditional transfers the detected event or condition will initiate.

The CMS 105 can verify or confirm the occurrence of a triggering event or condition by contacting the authorized approvers. For example, the authorized approvers can be users that the owner of the source address trusted to act on the owner's behalf if the owner dies or becomes incapacitated. If the owner is reported to have died, the CMS 105 can contact the authorized approvers (e.g., by email, SMS text message, or another communication mode), asking them if the owner is alive and well, and allowing them to indicate if the owner has died. The CMS 105 can delay or block initiating the conditional transfer until a predetermined amount of the authorized approvers (e.g., at least one, two out of three, all approvers, etc.) confirm that the owner has died. This process allows for greater verification and certainty of the triggering conditions, based on the input of users that the owner of the source address trusted and designated in advance.

During stage (G), in response to detecting the triggering event or condition, the CMS 105 initiates or activates the conditional transfer by publishing (e.g., broadcasting) the first transaction 920a from the set of transactions 920 to the cryptocurrency network 106. As a result, the cryptocurrency network 106 executes the first transaction 920a, which transfers the specified amount 921a of digital assets from the source address 910 to the intermediate address 912. Executing the first transaction 920a requires a signature 922a using the source address private key 911, but that signature 922a was previously generated and is included in the first transaction 920a as stored in the off-chain storage 940.

During stage (H), the CMS 105 notifies the owner of the source address 910 that the conditional transfer has been initiated. The CMS 105 can store contact information for the owner, as well as for other users, in the user profiles 936. The CMS 105 may notify the owner through any of various communication modes, such as through the cryptocurrency management app 113, a messaging application, email, short message service (SMS) text message, and so on.

By notifying the owner, the CMS 105 gives the owner the opportunity to cancel the conditional transfer if needed. For example, if a malicious actor might falsify data or falsely report that the triggering condition or event had occurred. After being notified, the owner would have an opportunity to cancel the conditional transfer, such as by issuing a return transaction (signed using the source address private key 911) that would transfer digital assets from the intermediate address 912 back to the source address 910. In some implementations, to cause the CMS 105 to cancel the conditional transfer, the owner simply needs to respond to a message or interact with the mobile app 113 (e.g., selecting a user interface element).

During stage (I), the CMS 105 notifies authorized approvers whose signatures are needed to meet the conditions for one or more transactions in the set of transactions 920. In the example, there are two authorized approvers, each with a different device 950a, 950b and different private key 952a, 952b. The set of transactions 920 includes at least one second-stage transaction that requires a signature from one of the authorized approvers in order to be valid. The CMS 105 determines that, for example, the second transaction 920 requires signature by either the approver 1 private key 952a or the approver 2 private key 952b, and so the CMS 105 looks up the contact information for the authorized approvers using the user profiles 936. The CMS 105 then sends notifications to the approvers, such as through a cryptocurrency management application, a messaging application, email, short message service (SMS) text message, and so on. The notification may include an indication of the triggering event or condition that the approver is requested to verify. The notification may also include, or may provide a link or U R L to access, an interface to initiate a signing process so the approver receiving the message can apply the signature needed.

By involving the approvers, the conditional transfer arrangement can limit the risk of falsely triggered conditional transfers. For example, approvers can limit the risk of digital assets being transferred from a fake or inadvertent request to recover assets due to a lost private key. A s another example, to address a report of a user's death, the approvers can corroborate the report.

During stage (J), the CMS 105 selectively publishes additional transactions from the set of transactions 920 as the conditions for those transactions are satisfied. The set of transactions 920 can include multiple second-stage transactions, some of which may be configured to transfer the same digital assets based on different sets of conditions. This can be beneficial, for example, to allow the same transfer to occur under any of multiple different sets of conditions. For example, one transaction may perform a transfer after a timing condition and an approver signature is provided. Another transaction may perform the same transfer with a shorter timing condition (or no timing condition) if multiple approver signatures are provided. This ability for different transactions to provide different options for transfers enables a high degree of versatility in structuring conditional transfers.

The CMS 105 checks the various second-stage transactions in the set of transactions 920 to determine when any of the transactions become valid for execution in the cryptocurrency network 106. For example, the CMS 105 determines when approver signatures are received and/or when timing constraints are satisfied. When additional signatures are still needed, the CMS 105 can periodically or repeatedly contact the authorized approvers to request the signatures needed.

In general, a signature can be verified by using a public key that corresponds to the private key used to generate the signature. For example, the CMS 105 can use a public key that corresponds to an authorized approver's address, to determine whether a valid and appropriate signature has been received.

The CMS 105 can publish second-stage transactions in the order that their respective sets of conditions are satisfied. In general, when the set of transactions 920 includes multiple alternative options for transferring digital assets, the CMS 105 resolves which transactions should take effect by publishing the transactions in the order that their associated conditions are satisfied (e.g., the order that they respectively become valid for execution in the cryptocurrency network 106). Thus, after the first transaction 920a is executed, the CMS 105 publishes the second transaction 920b as soon as the conditions 923b for the second transaction 920b are determined to be satisfied. If the CMS 105 attempts to publish the second transaction 920b before the conditions 923b are satisfied, the second transaction 920b will be rejected by the cryptocurrency network 106 for being invalid. If another transaction from the set of transactions 920 has its conditions satisfied before the second transaction 920b, then that other transaction is published before the second transaction 920b. As a result, the order in which the conditions are satisfied determines which transactions in the set of transactions 920 are published and executed, and which transactions in the set of transactions 920 are not (e.g., due to earlier-executed transactions removing the digital assets from the intermediate address 912).

In some implementations, one or more transactions in the set of transactions 920 may include, as a condition, a requirement for a signature using a private key 930 of the CMS 105. This type of requirement may be used to delegate certain verification functions to the CMS 105, such as to verify conditions that cannot directly be represented through timelocks, signatures, or other elements supported by the cryptocurrency network 106. Thus, the signature from the CMS 105 can be used to represent the satisfaction of one or more conditions that the owner of the source address 910 specifies or which are used generally to provide additional security or verification. When a signature using the server private key 930 is needed and the CMS 105 determines that the criteria for signature are satisfied, the CMS 105 applies a signature using the server private key 930.

The CMS 105 is limited in the transfers that it can perform, so that only transactions from the set of transactions 920 that have their associated conditions satisfied can be executed in the cryptocurrency network 106. The CMS 105 still retains the ability to control some aspects of the conditional transfer, however, such as when or whether to publish individual transactions from the set of transactions 920. The CMS 105 can use this ability to enhance security, such as to withhold transactions that would cause transfers to destination addresses that are known to be compromised or for which keys are lost, even if the conditions for the transactions are satisfied. In general, the CMS 105 can store transaction policies 934 for managing transaction publication, for example, rules that indicate when to publish transactions, lists of whitelisted or blacklisted destination addresses, and so on. The transaction policies 934 can also specify criteria for the CMS 105 to determine when it is appropriate to sign a transaction using the server private key 930.

After the first transaction 920a is executed, and before the second-stage transactions are executed, the owner may issue a new transaction to cancel the conditional transfer. For example, the owner may generate a return transaction signed using the source address private key 911 to transfer digital assets from the intermediate address 912 back to the source address 910, or to another address the owner chooses. In some implementations, if the intermediate address private key 913 is required for all transfers out of the intermediate address 912, the owner can publish a previously-generated return transaction that was previously signed using the intermediate address private key 913 before the intermediate address private key 913 was discarded. Executing a return transaction in this manner can return the digital assets from the intermediate address 912 to the source address 910 and thus effectively disallow or cancel the overall conditional transfer by blocking the second-stage transactions from being subsequently executed (e.g., because the cryptocurrency assets are no longer at the intermediate address 132).

When a conditional transfer process is initiated, the CMS 105 can repeatedly attempt to contact the owner of the source address 910 account, giving multiple opportunities for the owner to cancel the conditional transfer. If the time conditions (e.g., timelocks) elapse and the owner hasn't either responded to the CMS 105 or swept the funds (e.g., returned them to the source address 910), then the CMS 105 will cosign the transaction 920b, if needed, and will publish the transaction 920b to be executed. Note that the CMS 105 cannot change the recipients of the transaction 920b and also cannot change the amounts of cryptocurrency to be distributed, because that transaction was already pre-signed by an ephemeral key (e.g., the intermediate address private key 913) that no longer exists. The CMS 105 can sign and broadcast the transaction 920b or not, but cannot make any distribution the owner did not approve in advance.

In some cases, there is a risk that the CMS 105 could either refuse to cooperate or could be unavailable. One way that this risk can be mitigated is by having the authorized approvers install an app and have their instances of the apps hold keys for signing the second transaction 920b. These keys would be useful only to cosign already locked-in transactions, which limits risk. In that case, the conditional transfer can be arranged with a spend-path where a quorum (e.g., a predetermined minimum number or predetermined amount) of the authorized approvers can authorize the transaction 920b without the CMS 105 having to sign. For example, one path for executing the transaction 920b can include a signature from the server private key 930 of the CMS 105 and a short timelock, and another path can omit the need for a signature from the CMS 105 but may include a longer timelock. Additionally, mobile apps on the devices 950a-950b of the authorized approvers can download encrypted copies of the set of transactions 920. For example, the set of transactions 920 can be encrypted so that at least a particular number or percentage of the authorized approvers have to work together to decrypt the set of transactions 920 and initiate the conditional transfer process.). This would allow the entire conditional transfer process to work even if the CMS 105 were unavailable. For this functionality, each of the authorized approvers would need a device 950a-950b with a copy of the mobile app 113, but this would provide additional resilience. As an alternative, the CMS 105 can store the appropriate keys (as done for social recovery discussed above from FIGS. 1-8) and the authorized approvers can simply authorize the activation of the conditional transfer and/or the transaction 920b specifically. In either case (e.g., whether authorized approvers have a mobile app 113 or they do not have a mobile app 113), because the arrangement can generate the unfinalized pre-signed transaction each time the amount of cryptocurrency in the source address 910 changes. The owner can change destination addresses for recipient, and/or can change the keys used by authorized approvers, at any time without involving any of the other parties.

The conditional transfer techniques discussed for FIGS. 9A-9C can be used to automatically and securely have cryptocurrency transferred to a user's specified heirs when the user is incapacitated or dead. At the same time, the arrangement allows the user to avoid cryptocurrency being stolen, through the user's ability to cancel the transfer or stop a fraudulent initiation of the transfer by issuing a return transaction before the end of a time lock period.

As an example, the mobile app 113 and/or the CMS 105 can prompt or guide a user to designate cryptocurrency addresses of their heirs and a percentage of cryptocurrency in one or more addresses to transfer to each heir. The mobile app 113 and/or the CMS 105 also prompt or guide the user to designate one or more contacts as authorized approvers, who may act in some cases similar to executors in verifying or certifying information. The user's mobile app 113 generates the intermediate address 912 and a temporary key, e.g., the intermediate address private key 913). The mobile app 113 creates one or more first transactions 920a that are configured to move all applicable cryptocurrency to the intermediate account 912, and signs the one or more first transactions 920a with the temporary key, without broadcasting the first transactions 920a to the cryptocurrency network 106 (e.g., blockchain) for execution. The mobile app 113 also creates one or more second transactions 920b that are configured to pay out to each heir the appropriate amount of cryptocurrency from the intermediate address 912, and signs each of the one or more second transactions 920b with the temporary key, again without broadcasting the one or more second transactions. The mobile app 113 then deletes the temporary key.

The intermediate address 912 can be set to allow transactions under certain conditions, such as if (i) signed by 2 of 3 of the user's keys or (ii) signed by the temporary key and the keys of authorized approvers and if a timelock has expired. The signed transactions 920 are then stored by the CMS 105. The CMS 105 can provide an interface for an heir to start an inheritance process, and when that happens, the CMS 105 notifies the authorized approvers of the report of the user's death. When the authorized approvers confirm to the CMS 105 that the user is dead, the CMS 105 broadcasts the one or more first transactions 920a (e.g., that move cryptocurrency to the intermediate account) to the cryptocurrency network where they are executed. The CMS 105 also causes the user to be notified of the activation of the conditional transfer, and that a timelock for execution has begun. If the user is still alive, the user can immediately move cryptocurrency back from the intermediate address 910 to the source address 910 using the user's keys, which terminates the conditional transfer. For example, the user may respond to a notification or tap a user interface element “I'm still here” on the mobile app 113, which may cancel the conditional transfer and which may also invalidate the designation of heirs. On the other hand, if the user does not respond, after the timelock period is over, the CMS 105 may send the funds out from the intermediate account to the heirs by publishing the one or more second transactions.

In some implementations, each time the user makes a transaction, and thus changes the amount of cryptocurrency in the source address 910 account, the MCD 104 and CMS 105 can create a new set of transactions that would appropriately distribute the newly present amount of cryptocurrency.

FIG. 10 is a block diagram that illustrates techniques for refreshing or updating the set of transactions 920 for a conditional transfer. The set of transactions 920 incorporates many details about the conditional transfer that is desired. Various aspects specified by the set of transactions 920 may change between the time the set of transactions 920 is created and when the triggering event or condition occurs. When this occurs, the CMS 105 and/or the MCD 104 can perform operations to generate an updated set of transactions 970 that updates the conditional transfer for the current circumstances.

For example, the total amount of the cryptocurrency assets of the owner may change, e.g., the owner may receive extra cryptocurrency assets that previously did not belong to the owner at the time the set of transactions were created, or may alternatively spend existing cryptocurrency assets such that some cryptocurrency assets that belonged to the owner at the time of creation of the set of transactions no longer belongs to the owner. As an example, the conditional transfer may be arranged at a time when the source address 910 has a particular amount of digital assets (e.g., 5 Bitcoin). Over time, the amount of digital assets at the source address 910 may change (e.g., decrease to 4 Bitcoin, or increase to 6 Bitcoin). As a result, a first transaction 920a configured to transfer 5 Bitcoin from the source address 910 to the intermediate address 912 would not be appropriate. The first transaction 920a would not be able to be completed if the stated amount 921a is more than the actual amount available, or else would not fully transfer all digital assets as the owner intended if the stated amount 921a is less than the actual amount available. Other reasons for replacing the set of transactions 920 include a change in the recipients for the transfer, a change in address of a recipient, a change in conditions to be applied for the transfer, a change in the amount or proportion transferred to each recipient, and so on.

In FIG. 31 various operations and a flow of data are shown as stages (A) through (E), which may occur in the order labeled or in another order. Overall, these operations involve detecting the need for a new set of transactions 970 to represent a conditional transfer, and creating and storing the newly generated set of transactions 970 using techniques as described with respect to FIGS. 9A-9B.

During stage (A), the CMS 105 detects a change that indicates that the current set of transactions 920 in off-chain storage 940 is outdated. The CMS 105 can store information about the various conditional transfer arrangements in the stored transfer parameters 932 and can periodically verify whether the stored information is consistent with other records. For example, from the stored transfer parameters 932 (or from the stored set of transactions 920 itself), the CMS 105 can determine the amount of digital assets involved in a conditional transfer. The CMS 105 can compare this amount with a current amount at the source address 910, as indicated by the cryptocurrency network 106 (e.g., as indicated by a blockchain). If the two amounts differ, or differ by more than a predetermined threshold amount, the CMS 105 can determine to create a new set of transactions 970. As another example, the CMS 105 can determine when the authorized approvers or recipients of transfers change the addresses they use in the cryptocurrency network 106 based on updates to their user profiles 936. Similarly, the owner of the source address 910 may indicate a change to the nature of the conditional transfer (e.g., recipients, amounts, conditions, triggering events or conditions, etc.). The CMS 105 can determine to create a new set of transactions 970 for any of these changes, or for others that affect the ability of the set of transactions 920 to be executed and to be consistent the owner's specified conditional transfer.

To improve efficiency, the CMS 105 can apply criteria to limit how often new sets of transactions are generated, and thus limit the processing burden of keeping conditional transfers up to date. For example, increases in the amount of digital assets present may only prompt generation of a new set of transactions when the increase is above a particular threshold (e.g., greater than 10%, or greater than 0.25 Bitcoin, etc.). Similarly, the original set of transactions 920 can be generated to apply to less than all of the digital assets of the source address 910 (e.g., 80%), to leave a buffer to allow some spending of cryptocurrency assets before a new set of transactions 970 is needed.

During stage (B), the CMS 105 notifies the MCD 104 that a new set of transactions is needed for the conditional transfer involving the source address 910. The CMS 105 can indicate the change that prompted the update, as well as provide current information such as the current amount of digital assets at the source address 910.

In the illustrated example, the CMS 105 monitors and determines when the set of transactions 920 should be replaced. In other implementations, the cryptocurrency management app 113 on the MCD 104 may additionally or alternatively monitor and determine when a change occurs that creates a need for a new set of transactions.

During stage (C), the cryptocurrency management app 113 at the MCD 104 generates a new set of transactions 970 that is based on the current set of digital assets at the source address 910, and any other current items that may have changed. The cryptocurrency management app 113 performs the same set of operations described for stage (B) of FIG. 9A. This includes generating an new intermediate address 962 with an associated intermediate address private key 963. The previous intermediate address 912 is not used for the new set of transactions 970. Because the intermediate address private key 913 was discarded, new transactions from the previous intermediate address 912 cannot be generated with the appropriate signatures. As a result, each time a new set of transactions 970 is generated to update a conditional transfer, a new intermediate address 962 with a new corresponding intermediate address private key 963 is generated.

Generating the set of transactions 970 includes creating a first transaction 970a to transfer digital assets from the source address 910 to the intermediate address 962, and creating one or more second transactions 970b-970z to transfer funds from the intermediate address 962. The first transaction 970a includes a specified amount of digital assets 971a, and the first transaction 970a includes a signature 972a made using the source address private key 911. The second transaction 970b includes an amount of digital assets 971b, a signature 972b made using the intermediate address private key 913, and one or more additional conditions 973b.

During stage (D), the cryptocurrency management app 113 discards (e.g., deletes) the intermediate address private key 963 for the new intermediate address 963. As discussed above, this makes the intermediate address private key 963 unavailable to the MCD 104, the CMS 105, and all other devices, so that additional second-stage transactions cannot be made without the source address private key 911, and second-stage transactions in the set of transactions 970 cannot be altered without becoming invalid for execution in the cryptocurrency network 106.

During stage (E), the cryptocurrency management app 113 causes the MCD 104 to send the new set of transactions 970 to the CMS 105 over the communication network 905.

During stage (F), the CMS 105 receives the new set of transactions 970 and stores the new set of transactions 970 in the off-chain storage 940. The previous set of transactions 920, which is now outdated, is discarded. If the change that prompted the update in stage (A) altered transfer parameters for the conditional transfer, those changes are updated in the stored transfer parameters 932.

FIGS. 11A-11B illustrate examples of user interfaces 1100, 1110 showing notifications to users who are authorized to approve transactions as part of conditional transfers. For example, second-stage transactions, such as the second transaction 920b of FIG. 9A, can include conditions that require signature using the private key of one or more authorized approvers before the transaction is valid and will be executed by the cryptocurrency network 106. When a conditional transfer is initiated, the CMS 105 can cause a notification, such as shown in user interfaces 1100, 1110 to be provided on a device of the approver, as discussed with respect to stage (I) of FIG. 9C.

In FIG. 11A, the triggering event or condition is the death of a user named Joe. The user interface 1100 informs the approver of the report that Joe has died, and asks the approver to confirm and sign with the approver's private key if this is correct.

In FIG. 11B, the triggering event or condition is the initiation of a recovery process for an address of a user named Joe. The user interface 1110 informs the approver that the recovery process for Joe's account has been initiated, and asks the approver to confirm and sign with the approver's private key the approver agrees that the recovery process should proceed.

FIG. 12 shows an example of various transactions and addresses that can be used to implement a conditional transfer. As discussed above, the MCD 104 and CMS 105 can arrange conditional transfers in a way that allows the CMS 105 to act on behalf of an owner to carry out conditional transfers, even when the owner or the owner's private key may not be available. While allowing this, the arrangement also prevents the CMS 105 and any other party without the source address private key from transferring the digital assets involved in the conditional transfer except as approved in advance by the owner. This provides greater security and confidence that any digital assets involved in the conditional transfer arrangement will not be provided to any unauthorized party. The owner retains the ability to undo or cancel the conditional transfers, even after the conditional transfer process has been initiated.

In the example, digital assets subject to a conditional transfer are originally stored at a source address 1202. The owner specifies a conditional transfer that should result upon a particular condition, such as the death of the owner. In this example, the owner specifies that a portion of the digital assets should be transferred to destination address A 1206, and another portion of the digital assets should be transferred to destination address B 1208. The owner indicates the amounts or proportions of digital assets to be provided to each destination or recipient, as well as conditions that may be required for the transfers to be carried out. For example, the owner may designate one or more authorized approvers that must sign with their corresponding keys for the transfer to take effect.

Based on the owner's preferences, the owner's device generates a set of transactions that are stored but not immediately published to the blockchain network. These transactions include a first transaction 1210 configured to transfer a specified amount of digital assets from the source address 1202 to the intermediate address 1204. The set of transactions also includes two other transactions 1212, 1214 that provide alternative ways of transferring digital assets from the intermediate address 1204 to destination addresses 1206, 1208. For example, the transaction 1212 and the transaction 1214 each describe transfer of the same set of digital assets from the intermediate address 1204, so only one of the transactions 1212, 1214 can actually be carried out. Nevertheless, by creating multiple transactions 1212, 1214 to transfer the same digital assets, the CMS 105 can enable different paths or options for a transfer, with each option being dependent on a different set of conditions or providing a different transaction result (e.g., transferring digital assets to different destinations or in different amounts).

Each of the transactions 1210, 1212, 1214 has a corresponding set of conditions 1211, 1213, 1215 that must be met for the transaction to be processed in the cryptocurrency network 106. In other words, each of the transactions 1210, 1212, 1214 has a cryptographic requirement for one or more signatures in order for the corresponding transaction to be valid and accepted. Each of the transactions 1210, 1212, 1214 is also pre-signed with at least one private key, represented by signatures 1210a, 1212a, 1214a. These signatures 1210a, 1212a, 1214a meet one of the conditions for each of the transactions 1210, 1212, 1214, but depending on the transaction other conditions may still need to be satisfied, such as signature with another private key or an amount of elapsed time.

The transactions 1210, 1212, 1214 are stored in off-chain storage 940 but are not published to the cryptocurrency network 106 until a trigger, e.g., a predetermined event or condition, is detected. Once the trigger occurs, the CMS 105 can begin publishing the transactions. This set of transactions 1210, 1212, 1214 is structured so that the CMS 105 is cryptographically limited to the predefined paths set by the predefined transactions illustrated. In other words, once the first transaction 1210 transfers digital assets from the source address 1202 to the intermediate address 1204, no new transactions can be made to transfer the digital assets out of the intermediate address 1204, unless the source address private key is used. As a result, the CMS 105 is limited by the requirements of the cryptocurrency network 106 to the limited, discrete set of transactions pre-approved by the owner. This enables the CMS 105 to act on the owner's behalf, including to provide different transfers under different sets of conditions, while still avoiding the possibility of the CMS 105 transferring digital assets out of the intermediate address 1204 to a recipient address or under conditions not specified by the owner.

The transactions 1210, 1212, 1214 that are used to provide the conditional transfer functionality can be arranged to take effect in multiple stages. For example, a first stage involves the first transaction 1210 that sweeps digital assets from the source address 1202 to an intermediate address 1204. A second stage involves transfer of digital assets from the intermediate address 1204 to one or more destination addresses 1206, 1208, although these can be prevented by a return transaction transferring the digital assets back to the source address 1202.

In more detail, the first transaction 1210 has associated conditions 1211, which require signature by the source address private key for the transaction to be valid and accepted in the blockchain network. This condition is already satisfied when the set of transactions is created, because the first transaction 1210 is pre-signed with the source address private key. This enables the CMS 105 to store the transaction record for the first transaction 1210 and publish it without further involvement of the owner when an appropriate triggering event or condition is detected.

For the second stage, the transactions 1212, 1214 each separately transfer the same digital assets from the intermediate address 1204. In other words, the two transactions 1212, 1214 provide alternative options for transferring the digital assets that are transferred to the intermediate address 1204 by the first transaction 1210. For example, if the first transaction 1210 transfers 25 Bitcoin to the intermediate address 1204, then the second-stage transaction 1212 can be configured to transfer the 25 Bitcoin, with 12.5 Bitcoin going to address A 1206 and 12.5 Bitcoin going to address B 1208. Similarly, the transaction 1214 is also configured to transfer the same 25 Bitcoin from the intermediate address 1204 to the destination address 1206 and the destination address 1208, in the same amounts.

In the example, both transactions 1212, 1214 are intended to distribute the same amount of digital assets in the same proportions to the destination address is 1206, 1208, and simply to be able to be completed using different sets of conditions 1213, 1215. Nevertheless, the transactions 1212, 1214 could be created to alternatively transfer the digital assets in different proportions (e.g., transaction 1212 providing 70% to destination address 1206 and 30% to destination address 1208, and transaction 1214 providing 40% to destination address 1206 and 60% to destination address 1208), or to different destination addresses all together (e.g., transaction 1212 providing all digital assets to destination address 1206, and transaction 1214 providing all digital assets to destination address 1208).

Each of the transactions 1212, 1214 has a corresponding set of conditions 1213, 1215. The transaction 1212 has associated conditions 1213, which represent cryptographic requirements for the transaction 1212 to be valid and accepted in the blockchain network. The conditions 1213 include the need for signature with the intermediate address private key, a signature with the private key of one or more authorized parties (e.g., authorized approvers designated in advance by the owner), and a signature from the CMS 105. Of these three conditions, only the first (signature with the intermediate address Private key) is satisfied when the set of transactions is created and stored. After the conditional transfer process is activated, the CMS 105 contacts the authorized approvers to request their signatures, and the management CMS 105 applies its policies 934 to determine if the CMS 105 can appropriately sign with the server private key 930.

Although only two different transaction options are illustrated, more or fewer transactions can be defined as alternatives. Similarly, each predefined transaction does not need to transfer all of the digital assets from the intermediate address. 1204. For example, different groups of predefined transactions can together transfer the digital assets from the intermediate address 1204.

After the first transaction 1210 is executed, the owner can still cancel the conditional transfer using a return transaction 1216. For example, if the owner is reported to be dead, the CMS 105 attempts to contact the owner. If the report is incorrect, then the owner can create a return transaction 1216 that transfers the digital assets from the intermediate address 1204 back to the source address 1202 or to another address of the owner's choice. The conditional transfer is arranged to allow the source address private key to authorize transfers from the intermediate address 1204, without the need for signature from the intermediate address private key, which will be discarded before a return transaction 1216 is needed. Alternatively, if a signature with the intermediate address private key is needed for the return transaction 1216, the return transaction 1216 can be generated and retained by the owner, signed with the intermediate address private key in advance before the intermediate address private key is discarded.

By structuring the overall transaction scheme in multiple stages, the system gains versatility to provide for multiple alternative transactions and routes of authorization, while also limiting the possible transactions that can be performed without the source address private key to a predefined set of transactions. In this manner, the owner of the source address 1202 can authorize a server or other system to perform conditional transactions on the owner's behalf, while ensuring that no transactions other than those specifically anticipated and authorized by the owner can be performed in the future.

The use of an intermediate address 1204 to temporarily store digital assets provides a number of advantages. First, control of the intermediate address private key can be used to limit the transaction options that transfer digital assets. All transactions that transfer digital assets out of the intermediate address require either the source address private key or the intermediate address private key. The authorized transactions intended to be performed without the source address private key are signed with the intermediate address private key. The intermediate address private key is then discarded, making it impossible to create other transfers out of the intermediate address without the source address private key. This limits the possible transfers to a defined set that the owner approves in advance.

As another advantage, using the intermediate address, 1204 provides greater versatility in setting timing conditions for the execution of transactions. For example, it may be desirable to set a timing condition that is relative to the triggering event or condition that activates the conditional transfer process. To do this, one or more of the transactions 1212, 1214 can include a relative timing condition, such as limiting execution to 6 months after the digital assets arrive at the intermediate address 1204. As a result, when the conditional transfer scheme is activated, the first transaction 1210 provides digital assets to the intermediate address 1204, and the execution of the first transaction 1210 (arrival of those digital assets) provides a reference time from which to start measuring for the timing conditions of the other transactions 1212, 1214. Thus, the two-stage arrangement with an initial transfer to the intermediate address 1204 enables relative time constraints with respect to a wide variety of conditions, in effect, any triggering event or condition that is used to initiate the first transaction 1210.

FIG. 13 shows another example of various transactions and addresses that can be used to implement a conditional transfer. This example shows a different use cases, where the owner of a source address 1302 may arrange a conditional transfer to be able to recover digital assets if the private key for the source address 1302 is lost.

For this example, a first transaction 1310 is generated to transfer digital assets from the source address 1302 to an intermediate address 1304. The first transaction 1310 includes a signature 1310a using the source address private key. The signature 1310a completes all of the conditions 1311 required for the first transaction 1310 to be valid and executed by the cryptocurrency network 106.

A single second-stage transaction 1314 is also generated to transfer digital assets from the intermediate address 1304 to a destination address 1308. The destination address 1308 can be a secondary address controlled by the owner of the source address 1302. The second-stage transaction 1314 includes a signature 1314a made using the private key for the intermediate address 1304. The signature 1314a is required for the second-stage transaction 1314 to be executed, but the conditions 1315 for the second-stage transaction 1314 provide additional requirements. For example, a time lock enforces a time delay between the transfer of digital assets to the intermediate address 1304 and the execution of the second-stage transaction 1314. In addition, a signature using the private key of one or more authorized parties selected by the owner (e.g., a friend, family member, or other trusted party) is also required.

After the first transaction 1310 and second stage transaction 1314 are generated and signed as illustrated, the intermediate address private key is discarded so no further transfers from the intermediate address 1304 can be created without the source address private key. The first transaction 1310 and second stage transaction 1314 are stored, such as by the CMS 105, to be used to recover assets out of the source address 1302 in the event that the owner reports the source address private key to be lost.

Once the recovery process is initiated, as a result of the conditions 1315, the digital asset recovery process is not completed until the end of the time delay period as well as receipt of the additional signature from an authorized approver. During the delay period (and/or before the approver's signature is obtained), the owner still has an opportunity to cancel the recovery process if the owner finds the private key for the source address 1302, or if the recovery process was incorrectly triggered. For example, if the owner has the source address private key, the owner may generate a return transaction 1316 to transfer digital assets from the intermediate address 1304 back to the source address 1302. The return transaction 1316 has associated conditions 1317, requiring a signature using the private key for the source address. Unlike the first transaction 1310, the return transaction 1316 is not pre-signed in advance, so the source address private key is needed to cancel the recovery process in this way. This is desirable to avoid the risk that the recovery process is cancelled while the source address private key is actually lost, which would transfer the digital assets back to an unusable address.

After the conditions 1315 for the second-stage transaction 1314 are satisfied and the second-stage transaction 1314 is executed, the digital assets are at the destination address 1318. The recovery process does not make the source address 1302 usable again or provide a key for the source address 1302. Nevertheless, because of the transactions created before the source address private key is lost, the recovery process can transfer the digital assets out of the source address 1302 an into the destination address 1308 for which the private key is known. This helps avoid digital assets becoming unavailable in the source address 1302 due to loss of the source address private key.

FIG. 34 is a flow diagram that illustrates a process 1400 for implementing conditional transfers. The process 1400 may be performed by one or more computers, such as a client device, a server system, a data center, etc. As an example, the process 1400 may be performed by the MCD 104, the CMS 105, or a combination of both the MCD 104 and the CMS 105. The process 1400 can be used to set up a conditional transfer, which may later be executed as shown in FIG.

The process 1400 includes identifying a source address that is associated with a source address private key (1402). For example, a user can specify a source address having digital assets to be subject to a conditional transfer. As discussed above with respect to FIG. 9A, a user can provide various types of transfer parameters 906 that can indicate, for example, the source address, an amount of digital assets to be involved in a conditional transfer, recipients for the digital assets, authorized approvers, one or more triggering events or conditions for initiating the conditional transfer, additional conditions for the transfer, and so on.

The process 1400 includes generating an intermediate address and an associated intermediate address private key (1404). As described above with respect to FIG. 9, a new intermediate address can be created and used for each conditional transfer. By structuring a conditional transfer to route digital assets through an intermediate address, additional versatility and security is obtained. For example, the arrival of digital assets at the intermediate address can serve as the reference time that starts a delay period (e.g., time lock). This allows greater control over the beginning of the delay period than the cryptocurrency network 106 may permit. In addition, the private key for the intermediate address can be carefully managed to limit the set of transfers that are possible without the source address private key.

The process 1400 includes generating a set of transactions that are at least partially signed (1406). As described above with respect to FIG. 9A, the set of transactions can include a first transaction to transfer digital assets recorded by the cryptocurrency network 106 (e.g., on a blockchain) from the source address to the intermediate address. The first transaction is signed using the source address private key. The set of transactions can include a second transaction to transfer a predetermined amount of the digital assets from the intermediate address to a destination address. The second transaction is signed using the intermediate address private key. The second transaction can include one or more additional conditions that must be satisfied for the second transaction to be accepted in and executed by the cryptocurrency network 106. For example, the second transaction can include a timing constraint that prevents the transfer to the destination address until a predetermined amount of time after the first transaction is completed. As another example, the second transaction can include a condition requiring a signature by one or more authorized approvers designated by the owner of the source address. Multiple second transactions can be generated to provide different options for transfers, e.g., in different amounts of digital assets, to different destination addresses, or with different sets of conditions.

The process 1400 includes storing the set of transactions in off-chain storage without broadcasting the set of transactions to the cryptocurrency network 106 (e.g., a blockchain network) (1408). As described above with respect to FIG. 9B, After being generated, the set of transactions can be stored and held in reserve, before any of the transactions are published to the cryptocurrency network 106. The transactions can be stored and deferred until the triggering event or condition designated for the conditional transfer has been detected.

The process 1400 includes discarding the intermediate address private key to limit generation of further transactions to transfer digital assets from the intermediate address (1410). As described above with respect to FIG. 9B, by discarding the intermediate address private key, further transactions out of the intermediate address can be blocked unless the further transactions are signed using the source address private key. By discarding the intermediate address private key, the generated set of transactions enables a system to perform the conditional transfer on behalf of the owner of the source address, while the system (which does not have the source address private key) is prevented from any transfer of digital assets from the intermediate address except using one or more of the specific second transactions in the set of transactions. In addition, the discrete set of transactions that is generated can only be executed when the respective conditions defined for those transactions are satisfied.

FIG. 15 is a flow diagram that illustrates a process 1500 for managing conditional transfers. The process 1500 may be performed by one or more computers, such as a client device, a server system, a data center, etc. As an example, the process 1500 may be performed by the MCD 104, the CMS 105, or a combination of both the MCD 104 and the CMS 105. In some implementations, it is preferable for the MCD 104 to create

The process 1500 includes creating and storing a new set of transactions (block 1502). For example, the process 1400 of FIG. 34 can be used to generate a set of transactions that, collectively, implement a conditional transfer in response to a triggering event or condition. The CMS 105 can store the set of transactions in off-chain transaction storage 940 and publish them to the cryptocurrency network 106 when appropriate, as discussed further in the process 1500.

The process 1500 includes performing monitoring (block 1504) after the set of transactions is created. For example, the CMS 105 can monitor to detect the occurrence of the triggering event or condition that a user has set for initiating the conditional transfer. This can include monitoring for reports from users of events such as the loss of a key, the death or incapacity of a user, and so on. The CMS 105 can also monitor to detect changes in the amount of digital assets associated with the source address involved in the set of transactions. For example, the CMS 105 can use information from the cryptocurrency network 106 to determine when transactions are executed that add or remove digital assets for the source address.

The process 1500 includes determining whether a change in the digital assets associated with the source address has occurred (block 1506). If not, then the CMS 105 can continue monitoring by returning to block 1504.

If a change in the digital assets associated with the source address has occurred, a determination is made whether the change exceeds a threshold level (block 1508). For example, the CMS 105 may determine whether the magnitude of the change (e.g., amount of cryptocurrency added or removed) satisfies a predetermined threshold set by the user. If so, the stored set of transactions that was made previously may no longer be appropriate. As a result, when the change satisfies the threshold, the CMS 105 can cause a new set of transactions to be created and stored in block 1502.

For example, if the set of transactions is configured to transfer of 5 BTC, and an unrelated transaction reduces the total in the source account at only 4 BTC, the previously-generated set of transactions would not be able to be completed in the amounts as defined previously. Similarly, if the set of transactions is intended to transfer all of the cryptocurrency at the source account, and the amount of cryptocurrency increases, a new set of transactions may need be created to achieve this objective (e.g., to replace the stored set of transactions with transactions for the higher amount, or to add an additional set of transactions to be able to transfer the recently added cryptocurrency).

In general, adding a threshold for the change in digital assets reduces the frequency at which stored sets of transactions need to be refreshed. This can increase the overall efficiency of the cryptocurrency management system 102. For example, the system 102 can avoid the computational work of generating new sets of transactions in response to frequent small transactions, and instead generate new sets of transactions when a threshold is reached. The threshold may be based on the amount of digital assets in a source address (e.g., generate new transactions when the cryptocurrency at the source address reaches 5 BTC, or 4 BTC, or some other amount). As another example, the threshold may be based on the total or aggregate change in digital assets with respect to a reference amount (e.g., generate a new set of transactions when the cryptocurrency at the source address changes by at least 0.5 BTC, or 1 BTC, or some other amount compared to the amount when the stored set of transactions was generated).

In addition, based on the monitoring performed in block 1504, the CMS 105 can determine whether the triggering event or condition defined for the conditional transfer has occurred (block 1510). If not, the CMS 105 continues monitoring in block 1504. If the triggering event or condition is detected, the CMS 105 begins to execute the transactions in the stored set of transactions.

In response to detecting the triggering event or condition is detected, the CMS 105 publishes the first transaction from the set of transactions (block 1512). For example, the first transaction can be a sweep transaction that transfers digital assets from the source address to an intermediate address. As discussed above, the first transaction can be stored with the signature for the private key of the source address already applied, so the CMS 105 can publish the first transaction and have it executed.

The CMS 105 can then perform various other actions to verify that the conditional transfer should proceed and to prepare other transactions for execution. These additional actions are shown as blocks 1514, 1516, 1518, 1520, 1522.

The CMS 105 sends a notification to the user that is the owner of the source address involved in the set of transactions (block 1514). For example, if a recovery process is started, the CMS 105 informs the user that recovery of the digital assets has been initiated. Similarly, if the conditional transfer is set up to be used in the event of the user's death, the CMS 105 can notify the user that the user has been reported to have died. By notifying the user, the CMS 105 gives the user the opportunity to intervene and cancel the conditional transfer if the conditional transfer was erroneously started. The user can perform a cancellation by reversing the first transaction to remove the digital assets from the intermediate address. In some implementations, the CMS 105 provides an option in a web page, mobile application, or other user interface to enable the user to cancel the conditional transfer that was triggered. If the user does respond and cancel the conditional transfer, then the process 1500 may terminate, or it may return to block 1502 to create a new set of transactions to replace the conditional transfer that the user cancelled.

The CMS 105 requests a signature from one or more authorized approvers (block 1516). As discussed above, one of the conditions on completing the conditional transfer may be the approval of one or more authorized approvers that the user designated in advance. The CMS 105 can send notifications to the authorized approvers and request that they apply signatures with their private keys to verify that the conditional transfer should be carried out (e.g., verify that the triggering event or condition actually occurred).

In some implementations, one or more of the conditions on executing a second transaction from the stored set of transactions is a signature using a private key of the CMS 105. Obtaining this signature may be one of several different ways to approve the second transaction. For example, one path to approval of the second transaction may be signature with the private key of the CMS 105 and expiration of a timelock, while another path to approval may not require signature using the private key of the CMS 105 but may include a timelock of a longer duration.

The CMS 105 determines whether its policy allows for signature of the second transaction with a private key of the CMS 105 (block 1518). As discussed above, the CMS 105 can store transaction policies 934 that specify circumstances in which the CMS 105 will sign and circumstances in which the CMS 105 will not sign. These policies may specify whether to sign based on, such as, the reliability or source of the information specifying the triggering event or condition, the ownership or status of the cryptocurrency addresses involved (e.g., whether the owner is known and verified, or if the account is on a blacklist, etc.), and so on. If the transaction policies 934 allow the second transaction to be signed, the CMS 105 applies a signature with the private key of the CMS 105 (block 1520). If not, the CMS 105 does not sign the second transaction, but the set of transactions may still provide alternative paths for the second transaction to be approved (e.g., through signatures of other keys, through expiration of timelocks, etc.).

The CMS 105 determines whether the conditions have been satisfied for the second transaction to be published and executed in the cryptocurrency network 106 (block 1522). As discussed above, there may be several different alternative sets of conditions for the second transaction, where any of the different sets of conditions being satisfied will enable the second transaction to be executed. This can be achieved by structuring the intermediate address as a multi-signature address, where a set of private keys are associated with the address, and different sub-combinations of the private keys may authorize a transaction (e.g., two of three keys, or three of five keys, etc.). In addition, or as an alternative, different sets of conditions can be imposed through different alternative transactions, e.g., multiple different second transactions that have different timelock durations or other conditions. For either technique, satisfying any one of the sets of conditions places the second transaction in condition to be executed.

If the CMS 105 determines that conditions for executing the second transaction are satisfied, the CMS 105 publishes the second transaction to the cryptocurrency network 106 (1524). The execution of the second transaction completes the conditional transfer, which carries out the digital asset recovery, inheritance transfer, or other transfer that the user had arranged.

If the CMS 105 determines that the conditions for executing the second transaction have not been satisfied, then the CMS 105 repeats the interactions and evaluations to determine whether the second transaction should be executed. For example, the CMS 105 may again notify the user (block 1514), request signatures from one or more authorized approvers (block 1516), determine whether the CMS 105 should sign (block 1518) and apply a signature if appropriate (block 1520), and again determine whether the conditions for issuing the second transaction have been satisfied (block 1522).

FIG. 6 is a block diagram that illustrates a process 1600 for setting up a transfer of key material to a beneficiary. The transfer of key material can allow access to a wallet and/or account to transfer from one user to another user. This can be useful, for instance, to set up an inheritance, where a transferor's key is automatically transferred to a transferee upon a condition (e.g., the transferor passes away). The transferor can be referred to as the benefactor. The transferee can be referred to as the beneficiary.

A secure key material transfer feature can make it easy and secure for benefactors to not only pass on cryptocurrencies (e.g., bitcoin) and/or other digital assets to a friend or loved one, but to also give beneficiaries the same security, usability, and recovery tools that cryptocurrency wallets (e.g., secured with hardware wallet device(s)) offer.

Key material transfer can be set up and/or performed using the process 1600, the process 1700, the process 1800, or a combination thereof. Key material transfer can involve upload of encrypted key material to the CMS 105, and transfer of the encrypted key material to a device associated with the transferee or beneficiary from the 105.

The key material transfer processes discussed herein provide several technical improvements over other key transfer methods. First, the CMS 105 never sees the benefactor's unencrypted private key. The CMS 105 only stores an encrypted copy of the beneficiary's private key, and does not have access to the decryption key. Upon completion of an inheritance claim (or other condition for transfer), this encrypted key material is provided to the device of the beneficiary directly, without ever being decrypted on the CMS 105. The device of the beneficiary decrypts this key material locally on their device. In this way, the key material transfer processes discussed herein provide improved security and privacy.

Second, the beneficiary does not receive any key material or the inheritance amount until the inheritance (or other condition for transfer) is complete. The beneficiary of a wallet or account that is set up for conditional transfer (e.g., inheritance) does not receive any key material or the inheritance amount until an inheritance claim (or other condition for transfer) has completed an associated waiting period. In this way, the key material transfer processes discussed herein provide improved security and customizability.

Third, the key material transfer processes discussed herein (e.g., for inheritance) leverages cryptographic structures used for other functions to provide improved security without creating any new user interface or user experience challenges. By leveraging the encryption patterns and secure channels exchanged when creating a trusted contact for social recovery, conditional key material transfer (e.g., for inheritance) gains the same design benefits of cryptographic communication without the need for identity verification or secrets to remember.

Fourth, beneficiaries can leverage wallet and/or account recovery mechanisms. In some examples, the key material transfer processes discussed herein can require the beneficiary to have their own wallet, account, or hardware wallet device. This can provide the beneficiary with multiple recovery options for the bitcoin they inherit, for instance using their own wallet, account, or hardware wallet device for recovery using a threshold signature scheme (e.g., in which different devices have different shares of a private key, and signatures generated by at least a threshold number of the key shares are needed for authentication and/or recovery), using a trusted contact for recovery, using a delay and notify system, or a combination thereof. Using such recovery mechanisms, the beneficiary can regain access to their inheritance even if they lose their phone, cloud, or hardware wallet device.

To facilitate a conditional key transfer transaction (e.g., for an inheritance or other condition)—to transfer a benefactor's wallet balance to a beneficiary on the benefactor's behalf—the beneficiary ultimately needs one of a set of private keys (e.g., three private keys) to use with the server key of the CMS 105. It is important that the CMS 105 itself never has access to this key to ensure privacy, and that the beneficiary does not have access to this key until the condition is satisfied (e.g., the inheritance process is completed) to ensure that the rules (conditionality) of the transfer are preserved.

To ensure the benefactor's private key material (PKMat 1610) is never accessible to the CMS 105, the benefactor's device first encrypts the PKM at 1610 with a Private Key Encryption Key (PKEK 1620) on their app to generate a PKEK-encrypted PKM at, indicated in FIG. 16 as the PKEK(PKMAT) 1615. Once the private key material key is encrypted to generate PKEK(PKMAT) 1615, it is safe to upload the PKEK(PKMAT) 1615 to the CMS 105—an arrangement that also prevents the beneficiary from having access to the PKM at 1610 until the condition for the key transfer is satisfied (e.g., the inheritance process is completed).

To ensure that this PKEK 1620 can ultimately be given to the beneficiary in a way that allows for a balance transfer once the condition for the key transfer is satisfied (e.g., the inheritance process is completed), the benefactor's device or the trusted contact's device encrypts the PKEK 1620 with the beneficiary's Trusted Contact Encryption Key (TCEK)—a key that is created during the inheritance invitation process—to generate a TCEK-encrypted PKEK, indicated in FIG. 16 as the TCEK(PKEK) 1625. Both of these encrypted keys—the PKEK(PKMAT) 1615 and the TCEK (PKEK) 1625—are safe to upload to the CMS 105 by the benefactor's device.

FIG. 17 is a flow diagram that illustrates a process 1700 for performing a transfer of key material to a beneficiary 1710. The beneficiary 1710, in the context of the process 1700, should be understood to refer to a device of the beneficiary 1710, such as a mobile device (e.g., running an app) or a hardware wallet device. The setup in the process 1600 allows the process 1600 to be reversed by the beneficiary 1710 upon satisfaction of a condition for the key transfer (e.g., an inheritance claim of the beneficiary 1710 is successful), at which point the beneficiary 1710 device's TCEK can decrypt the TCEK(PKEK) 1625 to obtain the PKEK 1620, which the beneficiary 1710 device can ultimately use to decrypt the PKEK (PKMAT) 1615 to obtain the benefactor's PKMat 1610 and allow a balance transfer to occur.

The PKMat 1610 refers to Private Key Material. The PKMat 1610 is the benefactor's mobile app key. This is used to facilitate the conditional key transfer transaction (e.g., inheritance key transfer transaction) upon satisfaction of a condition for the key transfer (e.g., an inheritance claim of the beneficiary 1710 is successful).

The PKEK 1620 refers to a Private Key Encryption Key. The PKEK 1620 is a key that is used to encrypt and/or obscure the private key material (PKM at 1610) while at rest on the CMS 105 (as the PKEK(PKMAT) 1615). The PKEK 1620 encrypts PKM at from the benefactor's device (to form the PKEK (PKMAT) 1615), to be later decrypted from the beneficiary 1710 device.

The TCEK refers to a Trusted Contact Encryption Key. The TCEK is an asymmetric keypair is generated by the beneficiary 1710 device. The TCEK includes a public key that is used (e.g., by the benefactor's device) to encrypt the PKEK 1620 to form the TCEK (PKEK) 1625 before sending the TCEK(PKEK) 1625 to the CMS 105 for storage. The beneficiary 1710 device uses the beneficiary's TCEK private key 1715 (of the TCEK key pair) to decrypt the TCEK (PKEK) 1625 to obtain the PKEK 1620 upon satisfaction of a condition for the key transfer (e.g., an inheritance claim of the beneficiary is successful). The beneficiary 1710 device then uses the decrypted PKEK 1620 to decrypt the PKEK (PKMAT) 1615 to obtain the benefactor's original PKM at 1610. The beneficiary 1710 device can then use the PKM at 1610 to access the funds, perform transfers, and so forth.

While the CMS 105 cannot access the keys (e.g., the 1610 or the PKEK 1620) to transfer inheritance funds directly, the CMS 105 does facilitate the dispersal of encrypted keys to a beneficiary 1710. The CMS 105 ensures that beneficiaries do not receive any sensitive information until the condition for the key transfer is satisfied (e.g., the inheritance is approved). This entire process is called an inheritance claim.

Claim approval is done via a delay and notify system. This system, also used in the recovery processes discussed herein, can creates a waiting period of a predetermined length (e.g., six months) before the CMS 105 can proceed with an inheritance transaction. During this time, the CMS 105 attempts to contact the benefactor via all contact methods the benefactor has set up, such as push notifications, simple message service (SMS), multimedia message service (MMS), rich communication service (RCS), other text message formats, messaging through an app-based platform, messaging through a web-based platform, and/or email. If the benefactor denies the claim at any point during the six-month waiting period, the claim stops, no key material is given to the beneficiary 1710, and no conditional key transfer (e.g., inheritance transaction) occurs.

If and when the Delay and Notify period (e.g., six months) expires, the CMS 105 provides the beneficiary 1710 with the two encrypted keys—PKEK (PKMAT) 1615 (encrypted form of PKM at 1610) and TCEK (PKEK) 1625 (encrypted form of PKEK 1620)—as well as a wallet descriptor for the benefactor. As noted above, the beneficiary 1710 device can decrypt the TCEK (PKEK) 1625 with the TCEK private key 1715 to obtain the PKEK 1620, and can decrypt the PKEK(PKMAT) 1615 with the PKEK 1620 to obtain the PKMat 1610. Thus, with these keys, the beneficiary 1710 can begin the process of transferring the benefactor's full wallet balance to their own wallet, using the benefactor's decrypted app key (PKM at 1610) and server key (in CMS 105) as signers.

At this point, the beneficiary 1710 gains access to the benefactor's wallet information for the first time. The beneficiary 1710 uses this information to create a full balance transfer from the benefactor's wallet to their own, using the benefactor's decrypted private key (PKMat 1610) to sign it.

Once a transaction has been created and signed in the app, it is sent to the CMS 105 to be signed by the benefactor's server key (at the CMS 105). The CMS 105 is only permitted to cosign a transaction that is both (1) a claim associated with a completed Delay and Notify period and (2) sent to the wallet address of the beneficiary 1710. This dual validation protects the benefactor's funds and/or assets from being transferred for any reason other than an approved conditional transfer claim (e.g., an approved inheritance claim), to any other address, without requiring full control of the signing process.

In some examples, the conditional key transfer described in the process 1600 and/or the process 1700 requires a hardware wallet device. Requiring the hardware wallet device can improve security, flexibility, and reliability for the beneficiary 1710, as methods that do not rely on a hardware wallet device can instead rely on another third-party server system that neither the benefactor nor the beneficiary 1710 fully control. Requiring the hardware wallet device also saves a beneficiary 1710 from the added step of assessing and choosing among many possible means of holding the cryptocurrency they inherit after you've passed, which is particularly beneficial for a beneficiary 1710 who isn't knowledgeable about cryptocurrency when they inherit it.

The design used for conditional key transfer (in the process 1600 and/or the process 1700) is called Direct Key Distribution, where the CMS 105 distributes one (encrypted) private key directly to the beneficiary 1710 device to facilitate the transfer of funds. In order to safely transfer funds to a beneficiary, there needs to be some proof of the benefactor/beneficiary relationship. In some examples, the direct key distribution processes discussed herein accomplish this by storing a decryption key in a cloud backup of the beneficiary 1710, along with authorization keys that can start the conditional transfer (e.g., inheritance) process. A hardware wallet device can improve security in storing and/or retrieving this.

For hardware wallet devices, sensitive cloud data is encrypted by the hardware wallet device before it is stored in the cloud backup of the beneficiary 1710. This ensures no third party can access the benefactor's (or beneficiary's) wallet in the event that the cloud data is compromised or otherwise accessed by someone other than the benefactor or beneficiary. The hardware wallet device thus improves security of the contents of the cloud backup.

Additionally, in some examples, a user (e.g., benefactor and/or beneficiary 1710) may use the same account for their cloud provider as and their email. This reality presents a unique attack scenario. If a user's cloud data is compromised, their email could be as well. With only the beneficiary 1710's cloud data as authentication, an attacker with access to the beneficiary 1710's account could restore the account and change the contact information. This could allow an attacker to claim an inheritance without the beneficiary 1710's knowledge. Accounts secured additionally with a hardware wallet device, however, are recovered with a key that is encrypted with hardware. When recovering without a hardware wallet device, a delay period is required. This means an attacker cannot gain access to the account with temporary access, but would need to maintain it through the security delay period, increasing the difficulty of this type of attack.

Inheritance, by definition, is a feature that needs to last a lifetime, so its design needs to be durable for long periods of time. Over a lifetime, it's not uncommon for people to change service providers, phones and email accounts. When this happens, users sometimes lose their cloud data. Requiring a hardware wallet device solves these problems. It allows the CMS 105 to securely authenticate the beneficiary 1710 when starting an inheritance claim, as well as recover user data should the beneficiary 1710 lose their cloud backup, by encrypting their inheritance decryption keys with the hardware wallet device before backing up on CMS 105. These backups—which can only be decrypted by hardware wallet device—allow inheritance relationships to be restored even if the beneficiary 1710's app and cloud are lost. If the beneficiary 1710's hardware wallet device is lost, the beneficiary 1710 (e.g., with the help of the CMS 105, their cloud backup, and/or a trusted contact) can help replace it using various recovery mechanisms, keeping the data needed for inheritance safe by re-encrypting it with a replacement hardware wallet device.

The conditional key transfer used for inheritance transfers is built on the technologies associated with social recovery discussed herein. However, the security model is different. Inheritance is, effectively, a reverse social recovery. In social recovery, the protected user is in control of starting the process. For inheritance, it's not possible for the benefactor to start the key transfer process, so the beneficiary 1710 is in control of starting the inheritance process.

While a beneficiary 1710 should be someone the benefactor trusts, the secure systems discussed herein do not take the word of anyone who initiates the inheritance process without verification, and have built in protections for the benefactor. While only the beneficiary 1710 (previously identified to the CMS 105 by the benefactor) can start the inheritance process, the CMS 105 uses a delay and notify period to ensure the benefactor and beneficiary 1710 both have an opportunity to indicate they have not been compromised in some way. During this time, the CMS 105 uses every contact method available (that the benefactor has previously identified to the CMS 105) to try to reach the benefactor to ensure that the attempt is valid.

Unlike Social Recovery, no access is granted until after the Delay and Notify period is completed. This means that the beneficiary 1710 cannot gain any balance information by simply starting the process, keeping the benefactor in control of their funds and privacy, if they are still able to do so.

In the Direct Key Distribution model discussed herein, the CMS 105 effectively distributes one private key directly to the beneficiary 1710—the PKM at 1610 (once all decryption operations are complete)—to facilitate the transfer of funds when the full inheritance process is complete. The CMS 105 facilitates the policy for this operation, after being triggered by the beneficiary 1710.

In some examples, a Server-driven Covenants model can be used in place of the Direct Key Distribution model. Under a Server-driven Covenants model, the benefactor's device generates a set of inheritance transactions whenever they receive or send funds from their wallet. The set of transactions include: (1) an escrow transaction to an ephemeral wallet that is spendable with a short time lock, and (2) a transaction of inheritance funds per beneficiary from the ephemeral wallet to a pre-specified receive address for that beneficiary. Upon triggering the conditional key transfer (e.g., the inheritance claim)—which requires a quorum of people to coordinate and inform the CMS 105 under the Server-driven Covenants model—the escrow transaction is broadcast and beneficiaries (e.g., beneficiary 1710) informed. If the claim was illegitimate, the benefactor could claw back the funds into their own account within the transaction time lock period. After the time lock expired, the server (e.g., CMS 105) broadcasts the pre-generated transactions from the ephemeral wallet to the pre-specified receive addresses for each beneficiary (e.g., beneficiary 1710) and broadcast the transaction(s).

The Direct Key Distribution model provides improvements over the Server-driven Covenants model. First, under the Server-driven Covenants model, the beneficiary 1710 must ensure the wallet associated with the address receiving the inheritance is always accessible and in their control. In situations where the inheritance transaction is being sent to another wallet or an exchange, the transaction can end up transferring funds and/or key(s) to an account or wallet that is not associated with the beneficiary 1710 at the time of the transfer. This is not an issue with the Direct Key Distribution model, which relies on key material (e.g., the TCEK private key 1715) of the beneficiary 1710, and/or a hardware wallet device of the beneficiary 1710. Second, under the Server-driven Covenants model, the funds available to the beneficiary 1710 are those contained in the benefactor-generated transaction. If the benefactor doesn't update their inheritance transactions before the inheritance flow is triggered, the beneficiary 1710 is left with only part of the inherited funds. Again, this is not an issue with the Direct Key Distribution model, which provides the beneficiary 1710 with the key material (PKMat 1610) to fully access the benefactor's account and/or wallet.

FIG. 18 is a flow diagram illustrating a process 1800 for key material transfer. The process 1800 is performed by a key management system. The key management system can include, fort instance, the communication network 101, the cryptocurrency management system 102, the CMD 103, the MCD 104, the CMS 105, the cryptocurrency network 106, the cloud server 115, the social recovery contacts 120, the devices 150a-150b, a system that performs the process of FIG. 2, the device with the GUIs of FIGS. 3A-3B, the smartphone 702, the network 707, a system that performs the process of FIG. 8 the communication network 905, the devices 950a-950b, the device with the GUIs of FIGS. 1A-11B, a system that performs the process of FIG. 12 a system that performs the process of FIG. 1 a system that performs the process of FIG. 34 a system that performs the process of FIG. 15, a system that performs the process 1600, a system that performs the process 1700, the environment 1900 for application interface customization, the environment 2000, the system 2100, a system, an apparatus, a point of sale (POS) system or terminal, a transaction instrument reader device, a processor that performs instructions stored in a non-transitory computer-readable storage medium, any subsystems or components of any of the above-listed systems, any other computing systems disclosed herein, or a combination thereof.

At operation 1805, the key management system is configured to, and can, receive an encrypted private key (e.g., PKEK (PMAT) 1615) that is encrypted using a private key encryption key (e.g., PKEK 1620). The encrypted private key (e.g., PKEK (PMAT) 1615) and the private key encryption key (e.g., PKEK 1620) are associated with a transferor.

At operation 1810, the key management system is configured to, and can, receive an encrypted private key encryption key (e.g., TCEK (PKEK) 1625) that is encrypted using a trusted contact encryption key (e.g., TCEK public key). The encrypted private key encryption key (e.g., TCEK (PKEK) 1625) is an encrypted variant of the private key encryption key (e.g., PKEK 1620).

At operation 1815, the key management system is configured to, and can, check whether a condition is satisfied. If not (e.g., if the key management system fails to receive an indication that the condition is satisfied), the key management is configured to, and can, continue to check whether a condition is satisfied at operation 1815. If so (e.g., if the key management system receives an indication that the condition is satisfied), the key management proceeds to operation 1820, or alternately skips to operation 1830.

In some aspects, the condition is associated with an inheritance from the transferor to the transferee. The transferor can be referred to as a benefactor, and the transferee can be referred to as a beneficiary. In some aspects, the condition is associated with a death of the transferor. In some aspects, the indication that the condition is satisfied (that results in a “yes” for operation 1815) is an inheritance claim. In some aspects, the key management system is configured to, and can, receive an indication that the condition is satisfied at operation 1815, for instance by receiving the inheritance claim from at least one of the transferee device or a second device associated with the transferee.

In some aspects, the condition is associated with an event that has a plurality of possible outcomes. In some aspects, the indication that the condition is satisfied (that results in a “yes” for operation 1815) is an indication of a specific outcome of the event. The plurality of possible outcomes includes the specific outcome. For instance, the event can be a sporting event in which multiple teams could win, or a race in which multiple racers could win, or a day in the future in which multiple weather conditions are possible, and the like.

At operation 1820, the key management system is configured to, and can, send, to the transferor, a communication that includes an interactive element that is configured to trigger an alert (e.g., to trigger sending of the alert to the key management system). The communication may be a delay and notify communication as discussed herein.

In some aspects, sending the communication to the transferor includes sending the communication to the transferor through at least one of email, text messaging, a phone call, or an application. In some aspects, the interactive element is a hyperlink that leads to a network address that triggers the alert.

At operation 1825, the key management system is configured to, and can, check whether the alert has been received after a predetermined period of time (e.g., a delay and notify period, for instance six months). If so (if the key management system has received the alert within the predetermined period of time), then the transferor cancels the transfer by triggering the alert through the interaction with the communication, and the process 1800 ends at operation 1845. If not (if the key management system has not received the alert within the predetermined period of time), the key management proceeds to operation 1830.

At operation 1830, the key management system is configured to, and can, send the encrypted private key (e.g., PKEK(PMAT) 1615) and the encrypted private key encryption key (e.g., TCEK (PKEK) 1625) to transferee device associated with the transferee.

A t operation 1835, the key management system is configured to, and can, receive, from the transferee device (e.g., beneficiary 1710), a request for a transfer of funds from a transferor account associated with the transferor. The request is signed using a private key (e.g., PKM at 1610). The private key (e.g., PKM at 1610) is decrypted (e.g., by the transferee device) from the encrypted private key (e.g., PKEK(PMAT) 1615) using the private key encryption key (e.g., PKEK 1620). The private key encryption key (e.g., PKEK 1620) is decrypted (e.g., by the transferee device) from the encrypted private key encryption key (e.g., TCEK (PKEK) 1625) using a trusted contact decryption key (e.g., TCEK private key 1715) corresponding to the trusted contact encryption key (e.g., TCEK public key).

In some aspects, the trusted contact encryption key (e.g., TCEK public key) is a public key, and the trusted contact decryption key (e.g., TCEK private key 1715) is a private key corresponding to the public key.

At operation 1840, the key management system is configured to, and can, facilitate the transfer of funds from the transferor account in response to the request.

In some aspects, facilitating the transfer of funds (as in operation 1840) includes causing a block to be appended to a distributed ledger (e.g., a blockchain ledger). The block includes a payload with data indicative of the transfer of funds. In some aspects, the key management system is configured to, and can, generate the block. In some aspects, the key management system is configured to, and can, cause another device to generate the block. In some aspects, the key management system is configured to, and can, append the block to the distributed ledger. In some aspects, the key management system is configured to, and can, cause another device to append the block to the distributed ledger.

In some aspects, the transfer of funds is a transfer of a cryptocurrency. In some aspects, the transfer of funds is a transfer from the transferor account to a transferee account associated with the transferee.

FIG. 19 illustrates an example environment 1900 for application interface customization. The environment 1900 includes server(s) 1902 that can communicate over a network 1904 with end user devices 1906 and/or server(s) 1908 associated with third-party service provider(s). In various examples, the end user devices 1906 may comprise one or more merchant devices 1906(A), one or more user devices 1906(B) and/or 1906(C) in a peer network, one or more content consumption devices 1906(D), one or more artist user devices 1906(E), combinations of these examples, or other categories of user devices. The server(s) 1902 can be associated with one or more service providers that can provide one or more services for the benefit of users 1916, as described below. For example, the server(s) 1902 may enable services of service providers such as in association with a merchant platform 1910 (which may further include a buyer platform), a peer-to-peer (P2P) payment platform 1912, a media content platform 1914, a combination of these platforms, or other platforms associated with other service providers. While services and features are referenced throughout in connection with a particular one of the merchant platform 1910, the P2P payment platform 1912, or the media content platform 1914, it should be understood that any of these platforms may perform the functionality described in relation to any of the other platforms. Actions attributed to the service provider(s) can be performed by the server(s) 1902.

In some examples, the end user devices 1906, merchant platform 1910, P2P platform 1912, and/or media content platform 1914 can be examples of the communication network 101, the cryptocurrency management system 102, the CMD 103, the MCD 104, the CMS 105, the cryptocurrency network 106, the cloud server 115, the social recovery contacts 120, the devices 150a-150b, a system that performs the process of FIG. 2, the device with the GUIs of FIGS. 3A-3B, the smartphone 702, the network 707, a system that performs the process of FIG. 8 the communication network 905, the devices 950a-950b, the device with the GUIs of FIGS. 11A-11B, a system that performs the process of FIG. 12, a system that performs the process of FIG. 13, a system that performs the process of FIG. 34 a system that performs the process of FIG. 15, a system that performs the process 1600, a system that performs the process 1700, a key management system that performs the process 1800, or a combination thereof. The users 1916 (individually referred to herein as “user 1916”) can be referred to as miners, customers, buyers, merchants, sellers, borrowers, employees, employers, payors, payees, couriers, artists, musicians, listeners, fans, supervisors, hosts, audience members, and so on. The users 1916 can interact with the end user devices 1906 via user interfaces presented via the end user devices 1906. In at least one example, a user interface can be presented via a web browser, or the like. Alternatively or additionally, a user interface can be presented via an application, such as a mobile application or desktop application, which can be provided by the merchant platform 1910, the P2P payment platform 1912, and/or the media content platform 1914, or which can be an otherwise dedicated application. In some examples, individual end user devices 1906 can have an instance or versioned instance of an application, which can be downloaded from an application store, for example, which can present the user interface(s) described herein.

In at least one example, the users 1916 can include merchants that can operate the seller device(s) 1906(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1906(A) can have an instance of a point of sale (“POS”) application 1920 stored thereon. The POS application 1920 can configure the seller device 1906(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1920 can determine transaction data associated with the POS transactions. Transaction data can include payment information, which can be obtained from a reader device 1922 associated with the seller device 1906(A), user authentication data, purchase amount information, point-of-purchase information (e.g., item(s) purchased, date of purchase, time of purchase, subscription type, etc.), etc. The POS application 1920 can send transaction data to the server(s) 1902 such that the server(s) 1902 can track transactions of the customers, merchants, and/or the users 1916 over time. Furthermore, the POS application 1920 can present a UI to enable the merchant to interact with the POS application 1920 and/or the merchant platform 1910 via the POS application 1920.

In at least one example, the seller device 1906(A) can be a special-purpose computing device configured as a POS terminal (via the execution of the POS application 1920). In at least one example, the POS terminal may be connected to a reader device 1922, which is capable of accepting a variety of payment instruments, such as credit cards, debit cards, gift cards, short-range communication based payment instruments, and the like, as described below. In at least one example, the reader device 1922 can plug in to a port in the seller device 1906(A), such as a microphone port, a headphone port, an audio-jack, a data port, or other suitable port. In additional or alternative examples, the reader device 1922 can be coupled to the seller device 1906(A) via another wired or wireless connection, such as via Bluetooth®, BL E, and so on. In some examples, the reader device 1922 can be a software solution executing on the POS terminal, e.g., a mobile phone. In some examples, the reader device 1922 can read information from alternative payment instruments including, but not limited to, wristbands and the like.

In some examples, the reader device 1922 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1922, and communicate with the merchant platform 1910, which can provide, among other services, a payment processing service. The server(s) 1902 associated with the merchant platform 1910 can communicate with server(s) 1908, as described below. In this manner, the POS terminal and reader device 1922 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1922 of the POS system 1924 are shown as separate devices, in additional or alternative examples, the POS terminal and the reader device 1922 can be part of a single device. In some examples, the reader device 1922 can have a display integrated therein for presenting information to customers of a merchant. In additional or alternative examples, the POS terminal can have a display integrated therein for presenting information to the customers of the merchant. POS systems, such as the POS system 1924, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1922, whereby the reader device 1922 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1924, the server(s) 1902, and/or the server(s) 1908 may exchange payment information and transaction data to determine whether transactions are authorized. For example, the POS system 1924 may provide encrypted payment data, user authentication data, purchase amount information, point-of-purchase information, etc. (collectively, transaction data) to server(s) 1902 over the network(s) 1904. The server(s) 1902 may send the transaction data to the server(s) 1908.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). A n acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1908 associated therewith) can forward the fund transfer request to an issuing bank (e.g., “issuer”). The issuer is a bank or financial institution that offers a financial account (e.g., credit or debit card account) to a user. The issuer (e.g., the server(s) 1908 associated therewith) can make a determination as to whether the customer has the capacity to absorb the relevant charge associated with the payment transaction. In at least one example, the merchant platform 1910 can serve as an issuer and/or can partner with an issuer. The transaction is either approved or rejected by the issuer and/or the card payment network (e.g., the server(s) 1908 associated therewith), and a payment authorization message is communicated from the issuer to the POS device via a path opposite of that described above, or via an alternate path.

The server(s) 1908 may send an authorization notification over the network(s) 1904 to the server(s) 1902, which may send the authorization notification to the POS system 1924 over the network(s) 1904 to indicate whether the transaction is authorized. The server(s) 1902 may also transmit additional information such as transaction identifiers to the POS system 1924. In one example, the server(s) 1902 may include a merchant application and/or other functional components for communicating with the POS system 1924 and/or the server(s) 1908 to authorize or decline transactions (e.g., the API 1918). In examples, the merchant platform 1910 can enable the merchants to receive cash payments, payment card payments, and/or electronic payments from customers for POS transactions and the service provider can process transactions on behalf of the merchants.

Based on the authentication notification that is received by the POS system 1924 from server(s) 1902, the merchant may indicate to the customer whether the transaction has been approved. In some examples, approval may be indicated at the POS system 1924, for example, at a display of the POS system 1924. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 1910 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the end user devices 1906 can access all of the services. In some cases, the end user devices 1906 can have gradated access to the services, which can be based on risk tolerance, IDV outputs, subscriptions, and so on. In at least one example, access to such services can be availed to the merchants via the POS application 1920. In additional or alternative examples, each service can be associated with its own access point (e.g., application, web browser, etc.).

As the merchant platform 1910 processes transactions on behalf of the merchants, the merchant platform 1910 can maintain accounts or balances for the merchants in one or more ledgers. For example, the merchant platform 1910 can analyze transaction data received for a transaction to determine an amount of funds owed to a merchant for the transaction and deposit funds into an account of the merchant. The account can have a stored balance, which can be managed by the merchant platform 1910. The account can be different from a conventional bank account at least because the stored balance is managed by a ledger of the merchant platform 1910 and the associated funds are accessible via various withdrawal channels including, but not limited to, scheduled deposit, same-day deposit, instant deposit, and a linked payment instrument.

A scheduled deposit can occur when the merchant platform 1910 transfers funds associated with a stored balance of the merchant to a bank account of the merchant that is held at a bank or other financial institution (e.g., associated with the server(s) 1908). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 1910 to the bank account of the merchant.

In at least one example, the merchant platform 1910 may provide inventory management services. That is, the merchant platform 1910 may provide inventory tracking and reporting. Inventory management services may enable the merchant to access and manage a database storing data associated with a quantity of each item that the merchant has available (i.e., an inventory). Furthermore, in at least one example, the merchant platform 1910 can provide catalog management services to enable the merchant to maintain a catalog, which can be a database storing data associated with items that the merchant has available for acquisition (i.e., catalog management services). The merchant platform 1910 can offer recommendations related to pricing of the items, placement of items on the catalog, and multi-party fulfillment of the inventory, to name a few examples.

In at least one example, the merchant platform 1910 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 1910 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 1910 can provide financing services for offering and/or lending a loan to a borrower that is to be used for, in some instances, financing the borrower's short-term operational needs (e.g., a capital loan). Additionally or alternatively, the merchant platform 1910 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The merchant platform 1910 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 1910 can provide web-development services, which enable users 1916 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 1910 can recommend and/or generate content items to supplement omni-channel presences of the merchants.

Furthermore, the merchant platform 1910 can provide payroll services to enable employers to pay employees for work performed on behalf of employers. In at least one example, the merchant platform 1910 can receive data that includes time worked by an employee (e.g., through imported timecards and/or POS interactions), sales made by the employee, gratuities received by the employee, and so forth. Based on such data, the merchant platform 1910 can make payroll payments to employee(s) on behalf of an employer via the payroll service. For instance, the merchant platform 1910 can facilitate the transfer of a total amount to be paid out for the payroll of an employee from the bank of the employer to the bank of the merchant platform 1910 to be used to make payroll payments. In at least one example, when the funds have been received at the bank of the merchant platform 1910, the merchant platform 1910 can pay the employee, such as by check or direct deposit.

Moreover, in at least one example, the merchant platform 1910 can provide employee management services for managing schedules of employees. Further, the merchant platform 1910 can provide appointment services for enabling users 1916 to set schedules for scheduling appointments and/or users 1916 to schedule appointments.

In some examples, the merchant platform 1910 can provide restaurant management services to enable users 1916 to make and/or manage reservations, to monitor front-of-house and/or back-of-house operations, and so on. In such examples, the seller device(s) 1906(A) and/or server(s) 1902 can be configured to communicate with one or more other computing devices, which can be located in the front-of-house (e.g., POS device(s)) and/or back-of-house (e.g., kitchen display system(s) (KDS)). In at least one example, the merchant platform 1910 can provide order management services and/or fulfillment services to enable restaurants (or other merchant types) to manage open tickets, split tickets, and so on and/or manage fulfillment services.

In some examples, the merchant platform 1910 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 1910 can leverage other merchants and/or sales channels that are part of the merchant platform 1910 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 1910 can enable conversational commerce via conversational commerce services, which can use one or more machine learning mechanisms to analyze messages exchanged between two or more users 1916, voice inputs into a virtual assistant or the like, to determine intents of user(s) 1916. In some examples, the merchant platform 1910 can utilize determined intents to automate customer service, offer promotions, provide recommendations, or otherwise interact with customers in real-time. In at least one example, the merchant platform 1910 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1916 may be new to the merchant platform 1910 such that the user 1916 that has not registered (e.g., subscribed to receive access to one or more services offered by the merchant platform 1910) with the merchant platform 1910. The merchant platform 1910 can offer onboarding services for registering a potential user 1916 with the merchant platform 1910. In some examples, onboarding can involve presenting various questions, prompts, and the like to a potential user 1916 to obtain information that can be used to generate a profile for the potential user 1916. In at least one example, the merchant platform 1910 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 1910 can be transitioned to more permissive (e.g., less limited) or longer-term access to such services.

The merchant platform 1910 can be associated with IDV services, which can be used by the merchant platform 1910 for compliance purposes and/or can be offered as a service, for instance to third-party service providers (e.g., associated with the server(s) 1908). That is, the merchant platform 1910 can offer IDV services to verify the identity of users 1916 seeking to use or using their services. Identity verification may involve requesting a customer (or potential customer) to provide information that is used by compliance departments to prove that the information is associated with an identity of a real person or entity (e.g., an artist). In at least one example, the merchant platform 1910 can perform services for determining whether identifying information provided by a user 1916 accurately identifies the customer (or potential customer).

Techniques described herein can be configured to operate in both real-time/online and offline modes. “Online” modes refer to modes when devices are capable of communicating with the merchant platform 1910 while offline mode refers to modes when devices are unable to communicate with the server(s) 1908 due to network connectivity issue, for example. In such examples, devices may operate in “offline” mode where at least some payment data is stored (e.g., on the seller device(s) 1906(A)) and/or the server(s) 1902 until connectivity is restored and the payment data can be transmitted to the server(s) 1902 and/or the server(s) 1908 for processing.

In at least one example, the merchant platform 1910 can be associated with a hub, such as an order hub, an inventory hub, a fulfillment hub and so on, which can enable integration with one or more additional service providers (e.g., associated with the additional server(s) 1908). In some examples, such additional service providers can offer additional or alternative services and the service provider can provide an interface or other computer-readable instructions to integrate functionality of the service provider into the one or more additional service providers.

Turning now to the P2P functionality provided by the environment 1900, the P2P platform 1912 can provide a peer-to-peer payment service that enables peer-to-peer payments between two or more of the users 1916. Two or more of the users 1916 may be considered “peers” in a peer-to-peer interaction, such as a payment. In at least one example, the P2P platform 1912 can communicate with instances of a payment application 1926 (or other access point) installed on end user devices 1906 configured for operation by the users 1916. In an example, an instance of the payment application 1926 executing on a first user device 1906(B) operated by a payor (e.g., one of the users 1916) can send a request to the P2P platform 1912 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1916) via a peer-to-peer payment. In some examples, assets associated with an account of the payor are transferred to an account of the payee. In some examples, assets can be held at least temporarily in an account of the P2P platform 1912 prior to transferring the assets to the account of the payee.

In some examples, the P2P platform 1912 can utilize a ledger system to track transfers of assets between users 1916. FIG. 2Q below, provides additional details associated with such a ledger system. The ledger system can enable users 1916 to own fractional shares of assets that are not conventionally available. For instance, a user can own a fraction of a Bitcoin, an NFT, or a stock. Additional details are described herein.

In at least one example, the P2P platform 1912 can facilitate transfers and can send notifications related thereto to instances of the payment application 1926 executing on user device(s) of payee(s). As an example, the P2P platform 1912 can transfer assets from an account of a first user to an account of a second user and can send a notification to the user device 1906(B) of the second user for presentation via a user interface. The notification can indicate that a transfer is in process, a transfer is complete, or the like. In some examples, the P2P platform 1912 can send additional or alternative information to the instances of the payment application 1926 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1912 funds the request to payee on behalf of the payor, to speed up the transfer process and compensate for lags that may be attributed to the payor's financial network.

In some examples, the P2P platform 1912 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1902 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1926 executing on the end user devices 1906. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1912 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 19 or a third-party service provider associated with the server(s) 1908. In examples where the content provider is a third-party service provider, the server(s) 1908 can be accessible via one or more APIs 1918 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1912 (e.g., the P2P platform 1912 offers a chat or messaging service that is within the payment application or accessible via the payment application). In some examples, the messaging application can be external to the P2P platform 1912. (e.g., the messaging application is hosted by a third-party service provider associated with the server(s) 1908, which can be accessible via one or more of the APIs 1918 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1912 can enable users 1916 to perform banking transactions via instances of the payment application 1926. For example, users can configure direct deposits, recurring deposits, or other deposits (e.g., tax refunds, loans, etc.) for adding assets to their various ledgers/balances. In some examples, users can deposit physical cash via ATM s or other deposit sources, which can include merchants, such as those merchants that utilize the payment processing system described above. In some examples, the P2P platform 1912 can enable users to allocate funds between different accounts, sub-accounts, or balances (e.g., spending, saving, different assets, different currencies), etc. Further, users 1916 can configure bill pay, recurring payments, and/or the like using assets associated with their accounts. In some examples, the P2P platform 1912, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1912 enables users to buy and/or sell assets via asset networks such as cryptocurrency networks, securities networks, and/or the like. In some examples, acquisition of such assets can be in whole or fractional shares. The ledger system described below with reference to FIG. 2D can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1912 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1912 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1912 can automatically apply the amount of funds associated with the gift card to the transaction.

In some examples, users can configure their account such that when they use their payment instruments, the P2P platform 1912 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1912 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1912 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1912 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1912.

In some examples, components of the environment 1900 may be integrated to enable payments at the point-of-sale using assets associated with user accounts of the P2P platform 1912. As illustrated in the environment 1900, the components can communicate with one another via the network 1904, where one or more APIs 1918 or other functional components can be used to facilitate such communication.

In at least one example, an integration can enable a customer to participate in a transaction via their own computing device (e.g., user device 1906(B)) instead of interacting with a merchant device of a merchant, such as the seller device 1906(A). In such an example, the POS application 1920, associated with a payment processing platform and executable by the seller device 1906(A) of the merchant, can present a Quick Response (QR) code, or other code that can be used to identify a transaction (e.g., a transaction code), in association with a transaction between the customer and the merchant. The QR code, or other transaction code, can be provided to the POS application 1920 via an API 1918 associated with the peer-to-peer payment platform. In an example, the customer can utilize their own computing device, such as the user device 1906(B), to capture the QR code, or the other transaction code, and to provide an indication of the captured QR code, or other transaction code, to server(s) 1902.

Based at least in part on the integration of the peer-to-peer payment platform and the payment processing platform (e.g., via the API 1918), the server(s) 1902 of the merchant platform 1910 can exchange communications with a payment application 1926 associated with the P2P platform 1912 and/or the POS application 1920 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1912 and merchant platform 1910 (which can be a first- or third-party integration) such that a QR code, or other transaction code, specific to the transaction can be used for providing transaction details, location details, customer details, or the like to a computing device of the customer, such as the user device 1906(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1906(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1920 and the payment application 1926, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1906(B), can be specially configured as a buyer-facing device having functionality similar to the functionality described above in the brick-and-mortar example.

In some examples, based at least in part on capturing the QR code, or other transaction code, the merchant platform 1910 can provide transaction data to the P2P platform 1912 for presentation via the payment application 1926 on the computing device of the customer, such as the user device 1906(B), to enable the customer to complete the transaction via their own computing device. In some examples, in response to receiving an indication that the QR code, or other transaction code, has been captured or otherwise interacted with via the customer computing device, the P2P platform 1912 can determine that the customer authorizes payment of the transaction using funds associated with a stored balance of the customer that is managed and/or maintained by the P2P platform 1912. Such authorization can be implicit such that the interaction with the transaction code can imply authorization of the customer. Alternatively or additionally, the P2P platform 1912 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1912 can transfer funds from the stored balance of the customer to the merchant platform 1910. In at least one example, the merchant platform 1910 can deposit the funds, or a portion thereof, into a stored balance of the merchant that is managed and/or maintained by the merchant platform 1910. In such an example, the merchant platform 1910 can be a “peer” to the customer in a peer-to-peer transaction.

In some examples, techniques described herein can enable the customer to interact with the transaction after payment for the transaction has been settled. For example, in at least one example, the merchant platform 1910 can cause a total amount of a transaction to be presented via a user interface associated with the payment application 1926 such that the customer can provide gratuity, feedback, loyalty information, or the like, via an interaction with the user interface. In another example, the merchant platform 1910 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1912, if the customer inputs a tip and/or an event affecting the total amount of the transaction is triggered, the P2P platform 1912 can transfer additional funds, associated with the tip or event, to the merchant platform 1910. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1926 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1912 as described herein (e.g., a debit card linked to a stored balance of a customer) such that when the payment instrument is caused to interact with a payment reader, the merchant platform 1910 can exchange communications with the P2P platform 1912 to authorize payment fora transaction and/or provision associated transaction data to a computing device of the customer associated with the transaction.

Turning now to media content functionality provided by the environment 1900, the media content platform 1914 can provide digital media to a content consumption device 1906(D) where playback may occur using “streaming.” In examples, “streaming” media content involves encoding the media content and transmitting the encoded media content over the network 1904 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1914 can provide a digital media streaming service (e.g., subscription-based, non-subscription-based) that enables a content consumption device 1906(D) to stream and/or download digital media content via a listener application 1928 installed on the content consumption device 1906(D). For instance, the media content platform 1914 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1906(D), the listener application 1928 may verify access rights to the digital media content items at time intervals, for instance intermittently (e.g., when the content consumption device 1906(D) has a network connection with the media content platform 1914 via the network(s) 1904), and/or at regular intervals (e.g., daily, weekly, monthly, etc.). In examples, access rights to the digital media content items may be provided when a subscription to the media content platform 1914 is active, while access rights to the digital media content items may be withheld when the subscription to the media content platform 1914 is terminated. Enabling storage on the end user devices 1906 and subsequent access to digital media content items via the listener application 1928 provides the users 1916 with the ability to access the digital media content items “offline” such as when a connection to the media content platform 1914 via the network(s) 1904 is unavailable or unreliable.

In some examples, the media content platform 1914 may additionally or alternatively provide an artist management service that enables the users 1916 to manage aspects of artist business via an artist application 1930 installed on the artist device 1906(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1916 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1916 may have access to a single user account via respective end user devices 1906, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1930 and the listener application 1928 may be distinct applications having differing user experiences and verification processes for access, such as illustrated in the environment 1900. For instance, the media content platform 1914 may request additional verification, such as a link to an artist website, a sample of an artist's work, a verified credential supplied by a third party, etc. to grant access to the artist application 1930 in addition to information requested to access the listener application 1928. Further, the artist application 1930 may provide the artist management services described herein, without the subscription-based digital media streaming services described herein, and vice versa. However, examples are also considered in which functionality provided by the artist application 1930 and the listener application 1928 partially or fully overlap, and/or where verification processes for access are substantially similar.

In at least some examples, the media content platform 1914 enables interaction between the users 1916 utilizing the listener application 1928 installed on the content consumption devices 1906(D), and the users 1916 utilizing the artist application 1930 installed on the artist end user devices 1906(E). For example, the media content platform 1914 may provide interconnectivity between the subscription-based digital media streaming service and the artist management service. Functionality provided by the media content platform 1914 in such instances may include a communication channel between one or more of the users 1916 (e.g., a listener, fan, music supervisor, publisher, etc.) utilizing the listener application 1928 and another user (e.g., an artist) of the users 1916 utilizing the artist application 1930. The communication channel may include, for instance, a messaging platform (also referred to as a “messaging application” herein), a live streaming platform, a videoconferencing or teleconferencing platform, and/or a combination of these.

Additionally, in some cases, the media content platform 1914 may facilitate a resource transfer between the listener application 1928 and the artist application 1930. In an example, the media content platform 1914 may direct a resource, such as a portion of a subscription fee paid by one of the users 1916 designated as a listener, to one or more of the users 1916 designated as artists based on a number of instances that the listening user consumed (e.g., streamed, downloaded, etc.) content created by respective ones of the artist users. Alternatively or additionally, the media content platform 1914 may direct a resource, such as funds, from an account associated with a listening user to an account associated with an artist user (or vice versa), in accordance with transfers between accounts as described herein. The media content platform 1914 may facilitate resource transfers in examples such as merchandise purchases, event ticket purchases, “tipping” an artist, payments for royalties or other fees, and so forth.

In some examples, the media content platform 1914 enables interaction between individual ones of the users 1916 with one another via the listener application 1928 installed on the content consumption device 1906(D) and other of the content consumption devices 1906(D) via a communication channel as described above. In an example, the listener application 1928 may provide functionality via a communication channel fora user to stream an individual digital media item, a playlist, or the like to an audience comprising other ones of the content consumption devices 1906(D). Alternatively or additionally, the communication channel may facilitate sharing of individual digital media items, playlists, user and/or artist profiles, and the like between the users 1916 via messages, uniform resource locators (URLs), quick response (QR) codes, and so forth.

In some cases, the media content platform 1914 enables interaction between individual ones of the users 1916 with one another via the artist application 1930 installed on the artist device 1906(E) and other of the artist end user devices 1906 via a communication channel as described above. In some instances, the media content platform 1914 may provide recommendations for a particular user indicating which of the other users 1916 to communicate with. Such a recommendation may be based on a similarity (or dissimilarity) of content created by two or more of the users 1916, an overlap (or lack thereof) of audience members of the users 1916, a geographic location of the users 1916, a coinciding event location of the users 1916, and so forth. In some examples, a user may input parameters for a desired connection via the artist application 1930, and the media content platform 1914 may filter which of the users 1916 to surface for recommendations to the user based on the input parameters. Alternatively or additionally, the media content platform 1914 may implement one or more machine learning models to filter which of the users 1916 to surface for recommendations to the user. The recommendations provided by the media content platform 1914 may be data driven and thus increase relevance of communications presented to the users 1916 and reduce unsolicited communications that may be received by the users 1916.

The media content platform 1914 may interact with the server(s) 1908 associated with the third-party service providers to, for instance, ingest digital media items, report digital media consumption data, pay royalties, and the like. In some examples, the server(s) 1908 may be accessible by the media content platform 1914 via one or more APIs 1918 or other integrations. In some cases, the third-party service provider may be a digital media content provider (e.g., a record label, a performance rights organization (PRO), an independent artist, etc.). In such cases, the media content platform 1914 may receive digital media content items from the server(s) 1908, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1914 may use the metadata to associate the digital media content item as being created by a particular user, to provide search results to the users 1916, to generate playlists, and so forth. Further, the media content platform 1914 may provide payments (e.g., royalties) to the third-party service provider based on a number of streams and/or downloads of individual digital media content items by the users 1916 via the listener application 1928.

Techniques described herein are directed to services provided via a distributed system of end user devices 1906 that are in communication with server(s) 1902 of the service provider. That is, techniques described herein are directed to a specific implementation—or, a practical application—of utilizing a distributed system of end user devices 1906 that are in communication with server(s) 1902 of the merchant platform 1910, the P2P platform 1912, and/or the media content platform 1914 to perform a variety of services, as described above. The unconventional configuration of the distributed system described herein enables the server(s) 1902 that are remotely-located from end-users (e.g., users 1916) to intelligently offer services based on aggregated data associated with the end-users, such as the users 1916 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 1910, the P2P platform 1912, and/or the media content platform 1914, and those outside of the control of these service providers, to track the standing (payables, receivables, payroll, invoices, appointments, capital, balances, collaborations, etc.) of the users 1916. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1916 and end user devices 1906. Furthermore, such features are changed dynamically based on the profiles of the users involved interacting with the GUIs. As such, techniques described herein are directed to improvements to computing systems.

The merchant platform 1910, the P2P platform 1912, and/or the media content platform 1914 are capable of providing additional or alternative services, and the services described above are offered as a sampling of services. In at least one example, the merchant platform 1910, the P2P platform 1912, and/or the media content platform 1914 can exchange data with the server(s) 1908 associated with third-party service providers. Such third-party service providers can provide information that enables the merchant platform 1910, the P2P platform 1912, and/or the media content platform 1914 to provide services, such as those described above. In additional or alternative examples, such third-party service providers can access services of the merchant platform 1910, the P2P platform 1912, and/or the media content platform 1914. That is, in some examples, the third-party service providers can be subscribers, or otherwise access, services of the merchant platform 1910, the P2P platform 1912, and/or the media content platform 1914.

FIG. 20 illustrates an example environment 2000 including a service provider system 2002 which may be associated with the server(s) 1902 of FIG. 19. The environment 2000 may also include a user device 2004, which may correspond to any of the end user devices 1906 described in relation to FIG. 19. In examples, the service provider system 2002 may include one or a combination of the merchant platform 1910, the P2P platform 1912, or the media content platform 1914, as well as one or more data store(s) 2006 that can store assets in an asset storage 2008, as well as data in user account(s) 2010. In some examples, the environment 2000 may also include a public blockchain 2014, one or more nodes 2016, and/or a hardware wallet 2018. The service provider system 2002, the user device 2004, public blockchain 2014, the node(s) 2016, and the hardware wallet 2018 may be connected and able to communicate via one or more networks 2020, which may have the same or similar functionality described in relation to the network 1904 of FIG. 19.

In some examples, user account(s) 2010 can include merchant account(s), customer account(s), media content subscriber account(s), artist account(s), and so forth. In at least one example, the asset storage 2008 can be used to record whether individual assets are registered to a user account 2010. For example, the asset storage 2008 can include asset wallet(s) 2022 for storing records of assets owned by the service provider system 2002, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1908 of FIG. 19 can be associated therewith.

The asset wallet 2022 can be associated with one or more addresses and can vary addresses used to acquire assets (e.g., from the asset network(s)) so that its holdings are represented under a variety of addresses on the asset network. In examples where the service provider system 2002 has holdings of cryptocurrency (e.g., in the asset wallet 2022), a user can acquire cryptocurrency directly from the service provider system 2002. In some examples, the service provider system 2002 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 2002 can provide the same or similar functionality for securities or other assets.

The asset storage 2008 may contain ledgers that store records of assignments of assets to users 1916. Specifically, the asset storage 2008 may include asset ledger 2024, fiat currency ledger 2026, and/or other ledger(s) 2028, which can be used to record transfers of assets between users 1916 and/or one or more third-parties (e.g., merchant network(s), payment card network(s), A C H network(s), equities network(s), the asset network, securities networks, etc.). In doing so, the asset storage 2008 can maintain a running balance of assets managed by the service provider system 2002. The ledger(s) of the asset storage 2008 can further indicate some of the running balance for individual ledger(s) stored in the asset storage 2008 are assigned or registered to one or more user account(s) 2010.

In at least one example, the asset storage 2008 can include transaction logs 2030, which can include, as transaction data, records of past transactions involving the service provider system 2002 and/or the user account 2010. In some examples, the data store(s) 2006 can store a private blockchain 2032. A private blockchain 2032 can function to record sender addresses, recipient addresses, public keys, values of cryptocurrency transferred, and/or can be used to verify ownership of cryptocurrency tokens to be transferred. In some examples, the service provider system 2002 can record transactions involving cryptocurrency until the number of transactions has exceeded a determined limit (e.g., number of transactions, storage space allocation, etc.). Based at least in part on determining that the limit has been reached, the service provider system 2002 can publish the transactions in the private blockchain 2032 to the public blockchain 2014 (e.g., associated with the asset network), where miners can verify the transactions and record the transactions to blocks on the public blockchain 2014. In at least one example, the service provider system 2002 can participate as miner(s) at least for transactions to which the respective platform is a party to, to be posted to the public blockchain 2014.

In some cases, the data store(s) 2006 can store and/or manage multiple user accounts, an example of which is described in relation to the user account 2010. In at least one example, the user account 2010 can include user account data 2034, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 2034 can include account activity 2036 and user wallet key(s) 2038. In some examples, the user wallet key(s) 2038 can include a public-private key-pair and a respective address associated with the asset network or other asset networks. In some examples, the user wallet key(s) 2038 may include one or more key pairs, which can be unique to the asset network or other asset networks.

In addition to the user account data 2034, the user account 2010 can include ledger(s) for account(s) managed by the service provider system 2002, for the user. For example, the user account 2010 may include an asset ledger 2024, a fiat currency ledger 2026, and/or one or more other ledgers 2028. The ledger(s) can indicate that a corresponding user utilizes the service provider system 2002 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 2002.

In some examples, the asset ledger 2024 can store a balance for each of one or more cryptocurrencies (e.g., Bitcoin, Ethereum, Litecoin, etc.) registered to the user account 2010. In at least one example, the asset ledger 2024 can further record transactions of cryptocurrency assets associated with the user account 2010. For example, the user account 2010 can receive cryptocurrency from the asset network using the user wallet key(s) 2038. In some examples, the user wallet key(s) 2038 may be generated for the user upon request. User wallet key(s) 2038 can be requested by the user in order to send, exchange, or otherwise control the balance of cryptocurrency held by the service provider system 2002 (e.g., in the asset wallet 2022) and registered to the user. In some examples, the user wallet key(s) 2038 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 2002 and the value is credited as a balance in asset ledger 2024), by purchasing currency in the form associated with the account using currency in a different form (e.g., buying a value of cryptocurrency from the service provider system 2002 using a value of fiat currency reflected in fiat currency ledger 12391226, and crediting the value of cryptocurrency in asset ledger 2024), or by conducting a transaction with another user (customer or merchant) of the service provider system 2002 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 2002 (i.e., an external account). Such a transaction can request that the user to transfer an amount of the cryptocurrency in a message signed by user's private key to an address provided by the service provider system 2002. In at least one example, the transaction can be sent to miners to bundle the transaction into a block of transactions and to verify the authenticity of the transactions in the block. Once a miner has verified the block, the block is written to the public blockchain 2014 where the service provider system 2002 can then verify that the transaction has been confirmed and can credit the user's asset ledger 2024 with the transferred amount. When an account is funded by transferring cryptocurrency from a third-party cryptocurrency wallet, an update can be made to the public blockchain 2014. In some cases, this update of the public blockchain 2014 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 2002. As described above, in some examples, the service provider system 2002 can acquire cryptocurrency from a third-party source. In examples where the service provider system 2002 has its own cryptocurrency assets, cryptocurrency transferred in a transaction (e.g., data with address provided for receipt of transaction and a balance of cryptocurrency transferred in the transaction) can be stored in an asset wallet 2022 associated with the service provider system 2002. In at least one example, the service provider system 2002 can credit the asset ledger 2024 of the user. Additionally, while the service provider system 2002 recognizes that the user retains the value of the transferred cryptocurrency through crediting the asset ledger 2024, an inspection of the blockchain will show the cryptocurrency as having been transferred to the service provider system 2002. In some examples, the asset wallet 2022 can be associated with many different addresses. In such examples, an inspection of the blockchain may not necessarily associate all cryptocurrency stored in asset wallet 2022 as belonging to the same entity. The presence of a private ledger used for real-time transactions and maintained by the service provider system 2002, combined with updates to the public ledger at other times, allows for extremely fast transactions using cryptocurrency to be achieved. In some examples, the “private ledger” can refer to the asset ledger 2024, which in some examples, can utilize the private blockchain 2032, as described herein. The “public ledger” can correspond to the public blockchain 2014 associated with the asset network.

In at least one example, an asset ledger 2024, fiat currency ledger 2026, or the like associated with the user account 2010 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 2024. In some examples, a user can receive fiat currency or another currency in the form of payment for a transaction with another user. In at least one example, at least a portion of such funds can be converted into cryptocurrency by the service provider system 2002 and used to fund the asset ledger 2024 of the user.

In examples, a user can also have an account in U.S. dollars, which can be tracked, for example, via the fiat currency ledger 2026. Such an account can be funded by transferring money from a bank account at a third-party bank to an account maintained by the service provider system 2002 as is conventionally known. In some examples, a user can receive fiat currency in the form of payment for a transaction with another user. In such examples, at least a portion of such funds can be used to fund the fiat currency ledger 2026.

In some examples, a user can have one or more internal payment cards registered with the service provider system 2002. Internal payment cards can be linked to one or more of the accounts associated with the user account 2010. In some embodiments, options with respect to internal payment cards can be adjusted and managed using an application (e.g., the payment application 1926, a wallet application 2012, etc.).

In at least one example, the user account 2010 can be associated with the asset wallet accessible via a wallet application 2012 of the user device 2004, or a stored balance for use in payment transactions, peer-to-peer transactions, payroll payments, etc. In at least one example, the asset wallet 2022 can store data indicating an address provided for receipt of a cryptocurrency transaction. In at least one example, the balance of the asset wallet 2022 can be based at least in part on a balance of the asset ledger 2024. In at least one example, funds availed via the asset wallet 2022 can be stored in the asset wallet 2022. Funds availed via the asset wallet 2022 can be tracked via the asset ledger 2024. The asset wallet 2022, however, can be associated with additional cryptocurrency funds.

In at least one example, when the service provider system 2002 includes a private blockchain 2032 for recording and validating cryptocurrency transactions, the asset wallet 2022 can be used instead of, or in addition to, the asset ledger 2024. For example, a merchant can provide the address of the asset wallet 2022 for receiving payments. In an example where a customer is paying in cryptocurrency and the customer has their own cryptocurrency wallet account associated with the service provider system 2002, the customer can send a message signed by its private key including its wallet address (i.e., of the customer) and identifying the cryptocurrency and value to be transferred to the merchant's asset wallet 2022. The service provider system 2002 can complete the transaction by reducing the cryptocurrency balance in the customer's cryptocurrency wallet and increasing the cryptocurrency balance in the merchant's asset wallet 2022. In addition to recording the transaction in the respective cryptocurrency wallets, the transaction can be recorded in the private blockchain 2032 and the transaction can be confirmed. A user can perform a similar transaction with cryptocurrency in a peer-to-peer transaction as described above.

While the asset ledger 2024 and/or asset wallet 2022 are each described above with reference to cryptocurrency, the asset ledger 2024 and/or asset wallet 2022 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 2002 is an aspect of the technology disclosed that enables technical advantages of increased processing speed and improved security.

The description of the environment 2000 above generally relates to a centralized service provider system 2002 that at least partially facilitates storing and managing assets in the data store 2006. However, the environment 2000 may also facilitate decentralized storage and management of assets alternatively or in addition to centralized storage and management as described above. For instance, the environment 2000 may include a decentralized platform implemented using a plurality of nodes (e.g., web nodes), an example of which is illustrated as node 2016. The node 2016 is representative of a computer or other device tasked with validating transactions and/or maintaining a copy of a blockchain ledger, such as a ledger associated with the public blockchain 2014. The decentralized platform may be implemented via the environment 2000 through use of decentralized identifiers and verifiable credentials that are stored and managed by user devices 2004. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 2002). The decentralized identity referenced by a decentralized identifier gives an entity control over what data can be accessed, stored, modified, and so forth by other entities, such as the service provider system 2002.

The node 2016, as representative of one of a plurality of decentralized nodes (e.g., decentralized web nodes), supports data storage and relays that allows entities, service provider systems, individuals, organizations and so forth to send, store, and receive encrypted or public messages and data. The node 2016 is universally addressable and is “crawlable” using data addressing in relation to the decentralized identifiers. The node 2016 is also configured to support decentralized replication of data across the nodes that is consistent across multiple nodes overtime through continued data communication between the nodes in the decentralized platform. The node 2016 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 2004 may be an issuer, a holder, and/or a verifier, as can the service provider system 2002.

In some examples, the user device 2004 may implement a wallet application 2012 configured to manage decentralized identifiers and/or verifiable credentials. For instance, the wallet application 2012 may provide a user interface for implementation of access controls to various data associated with the decentralized identifier by the service provider system 2002, to other user devices, and so forth. Additionally, the wallet application 2012 may be configured to provide functionality for resource transfers (e.g., cryptocurrency, fiat currency, etc.) with the service provider system 2002, other user devices, and the like, based on techniques described herein.

In some examples, the hardware wallet 2018 may store cryptocurrency assets in combination with the wallet application 2012 and the service provider system 2002. For instance, the hardware wallet 2018, the wallet application 2012, and the service provider system 2002 may each store a respective, different private key, where a transaction with the cryptocurrency assets is signed by at least two of the three private keys. The user interface provided by the wallet application 2012 may allow a user to request a transaction. The wallet application 2012 may then sign the transaction with the private key of the wallet application 2012, have either the hardware wallet 2018 or the service provider system 2002 use a second of the three private keys to sign the transaction, and then provide the transaction with two signatures to the public blockchain 2014 for processing.

FIG. 21 depicts an illustrative block diagram illustrating a system 2100 for performing techniques described herein. The system 2100 includes a user device 2102, that communicates with server computing device(s) (e.g., server(s) 2104) via network(s) 2106 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 2102 is illustrated, in additional or alternate examples, the system 2100 can have multiple user devices, as described above with reference to FIG. 19.

In some examples, the client device 2102 and/or the server 2104 can include, and/or be examples of, communication network 101, the cryptocurrency management system 102, the CMD 103, the MCD 104, the CMS 105, the cryptocurrency network 106, the cloud server 115, the social recovery contacts 120, the devices 150a-150b, a system that performs the process of FIG. 2, the device with the GUIs of FIGS. 3A-3B, the smartphone 702, the network 707, a system that performs the process of FIG. 8 the communication network 905, the devices 950a-950b, the device with the GUIs of FIGS. 11A-11B, a system that performs the process of FIG. 12, a system that performs the process of FIG. 13, a system that performs the process of FIG. 14, a system that performs the process of FIG. 15, a system that performs the process 1600, a system that performs the process 1700, a key management system that performs the process 1800, or a combination thereof. The user interface 2120 can be an example of user interfaces associated with cryptocurrency and/or key transfer, such as the user interfaces of FIGS. 3A-3B, the user interfaces of FIGS. 11A-11B, other user interfaces discussed herein, or vice versa.

In at least one example, the user device 2102 can be any suitable type of computing device, e.g., portable, semi-portable, semi-stationary, or stationary. Some examples of the user device 2102 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 2102 can be any computing device capable of sending communications and performing the functions according to the techniques described herein. The user device 2102 can include devices, e.g., payment card readers, or components capable of accepting payments, as described below. The user device 2102 may be representative of, and provide functionality for, the user devices 1906 described in relation to FIG. 19.

In the illustrated example, the user device 2102 includes one or more processors 2108, one or more computer-readable media 2110, one or more communication interface(s) 2112, one or more input/output (I/O) devices 2114, a display 2116, sensor(s) 2118, one or more encoders 2146, and one or more decoders 2148.

In at least one example, each processor 2108 can itself comprise one or more processors or processing cores. For example, the processor(s) 2108 can be implemented as one or more microprocessors, microcomputers, microcontrollers, digital signal processors, central processing units, state machines, logic circuitries, and/or any devices that manipulate signals based on operational instructions. In some examples, the processor(s) 2108 can be one or more hardware processors and/or logic circuits of any suitable type specifically programmed or configured to execute the algorithms and processes described herein. The processor(s) 2108 can be configured to fetch and execute computer-readable processor-executable instructions stored in the computer-readable media 2110.

Depending on the configuration of the user device 2102, the computer-readable media 2110 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 2110 can include, but is not limited to, RAM, ROM, EEPROM, flash memory, solid-state storage, magnetic disk storage, optical storage, and/or other computer-readable media technology. Further, in some examples, the user device 2102 can access external storage, such as RA ID storage systems, storage arrays, network attached storage, storage area networks, cloud storage, or any other medium that can be used to store information and that can be accessed by the processor(s) 2108 directly or through another computing device or network. Accordingly, the computer-readable media 2110 can be computer storage media able to store instructions, components or components that can be executed by the processor(s) 2108. Further, when mentioned, non-transitory computer-readable media exclude media such as energy, carrier signals, electromagnetic waves, and signals per se.

The computer-readable media 2110 can be used to store and maintain any number of functional components that are executable by the processor(s) 2108. In some implementations, these functional components comprise instructions or programs that are executable by the processor(s) 2108 and that, when executed, implement operational logic for performing the actions and services attributed above to the user device 2102. Functional components stored in the computer-readable media 2110 can include a user interface 2120 to enable users to interact with the user device 2102, and thus the server(s) 2104 and/or other networked devices. In some examples, the user interface 2120 can include a UI associated with a mining application used to perform, control, and/or monitor the mining operations disclosed herein, as performed using the mining ASIC(s) of the hashboard(s) disclosed herein. In at least one example, a user can interact with the user interface via touch input, spoken input, gesture, or any other type of input. The word “input” is also used to describe “contextual” input that may not be directly provided by the user via the user interface 2120. For example, user's interactions with the user interface 2120 are analyzed using, e.g., natural language processing techniques, user movement tracking techniques, eye tracking techniques, etc. to determine context or intent of the user, which may be treated in a manner similar to “direct” user input.

Depending on the type of the user device 2102, the computer-readable media 2110 can also optionally include other functional components and data, such as other components and data 2122, which can include programs, drivers, etc., and the data used or generated by the functional components. In addition, the computer-readable media 2110 can also store data, data structures and the like, that are used by the functional components. Further, the user device 2102 can include many other logical, programmatic and physical components, of which those described are merely examples that are related to the discussion herein.

In at least one example, the computer-readable media 2110 can include additional functional components, such as an operating system 2124 for controlling and managing various functions of the user device 2102 and for enabling user interactions.

The communication interface(s) 2112 can include one or more interfaces and hardware components for enabling communication with various other devices, such as over the network(s) 2106 or directly. For example, communication interface(s) 2112 can enable communication through one or more network(s) 2106, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 2106 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be disclosed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 2102 can further include one or more input/output (I/O) devices 2114. The I/O devices 2114 can include speakers, a microphone, a camera, and various user controls (e.g., buttons, a joystick, a keyboard, a keypad, etc.), a haptic output device, and so forth. The I/O devices 2114 can also include attachments that leverage the accessories (audio-jack, USB-C, Bluetooth, etc.) to connect with the user device 2102.

In at least one example, user device 2102 can include a display 2116. Depending on the type of computing device(s) used as the user device 2102, the display 2116 can employ any suitable display technology. For example, the display 2116 can be a liquid crystal display, a plasma display, a light emitting diode display, an OLED (organic light-emitting diode) display, an electronic paper display, or any other suitable type of display able to present digital content thereon. In at least one example, the display 2116 can be an augmented reality display, a virtual reality display, or any other display able to present and/or project digital content. In some examples, the display 2116 can have a touch sensor associated with the display 2116 to provide a touchscreen display configured to receive touch inputs for enabling interaction with a graphic interface presented on the display 2116. Accordingly, implementations herein are not limited to any particular display technology. In some examples, the user device 2102 may not include the display 2116, and information can be presented by other means, such as aurally, haptically, etc.

In addition, the user device 2102 can include sensor(s) 2118. The sensor(s) 2118 can include a global positioning system (“GPS”) device able to indicate location information. Further, the sensor(s) 2118 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 1910, the P2P platform 1912, and/or the media content platform 1914, described above, to provide one or more services. That is, in some examples, the service provider can implement geofencing to provide particular services to users by the merchant platform 1910, the P2P platform 1912, and/or the media content platform 1914.

In examples, the user device 2102 includes a codec system, which may comprise an encoder 2146 and/or a decoder 2148. The encoder 2146 is configured to encode a data stream or signal from an analog signal (e.g., an analog audio signal, an analog video signal, etc.) to a digital signal for transmission or storage. The decoder 2148 is configured to convert the digital signal back to an analog signal, such as for playback or editing. In some cases, the encoder 2146 may be configured to encode the data stream or analog signal in an encrypted format, and the decoder 2148 may accordingly be configured to decrypt the digital signal as part of the decoding process (e.g., using a cryptographic key). Additionally, in some examples, the encoder 2146 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 2146 and/or the decoder 2148 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 2100, the server 2104 may include an encoder 2146 and/or a decoder 2148 as well.

Additionally, the user device 2102 can include various other components that are not shown, examples of which include removable storage, a power source, such as a battery and power control unit, a barcode scanner, a printer, a cash drawer, and so forth.

In addition, as described in relation to FIG. 19, the user device 2102 can include, be connectable to, or otherwise be coupled to a reader device 2126, for reading payment instruments and/or identifiers associated with payment objects. The reader device 2126 can include a read head for reading a magnetic strip of a payment card, and further can include encryption technology for encrypting the information read from the magnetic strip. Additionally or alternatively, the reader device 2126 can be an EMV payment reader, which in some examples, can be embedded in the user device 2102. Moreover, numerous other types of readers can be employed with the user device 2102 herein, depending on the type and configuration of the user device 2102.

The reader device 2126 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 2126 may include hardware implementation, such as slots, magnetic tracks, and rails with one or more sensors or electrical contacts to facilitate detection and acceptance of a payment instrument. That is, the reader device 2126 may include hardware implementations to enable the reader device 2126 to interact with a payment instrument via a swipe, a dip, or a tap to obtain payment data associated with a customer. Additionally or optionally, the reader device 2126 may also include a biometric sensor to receive and process biometric characteristics and process them as payment instruments, given that such biometric characteristics are registered with the payment service and connected to a financial account with a bank server. The reader device 2126 may include processing unit(s), computer-readable media, a reader chip, a transaction chip, a timer, a clock, a network interface, a power supply, and so on. That is, the reader device 2126 may include any of the computing components described herein with reference to the user device 2102 to implement the functionality provided by the reader device 2126.

In examples, the reader device 2126 includes a reader chip, which may perform functionality to control the power supply, among other functionality of the reader device 2126. The power supply may include one or more power supplies such as a physical connection to AC power or a battery. Power supply may include power conversion circuitry for converting AC power and generating a plurality of DC voltages for use by components of reader device 2126. When power supply includes a battery, the battery may be charged via a physical power connection, via inductive charging, or via any other suitable method.

The reader device 2126 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 2102, which can be a POS terminal, and the reader device 2126 are shown as separate devices, in additional or alternative examples, the user device 2102 and the reader device 2126 can be part of a single device, which may be a battery-operated device. In some examples, the reader device 2126 can have a display integrated therewith, which can be in addition to (or as an alternative of) the display 2116 associated with the user device 2102.

The server(s) 2104 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 2104 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 2104 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 2104 can include one or more processors 2128, one or more computer-readable media 2130, one or more I/O devices 2132, and one or more communication interfaces 2134. Each processor 2128 can be a single processing unit or a number of processing units, and can include single or multiple computing units or multiple processing cores. The processor(s) 2128 can be implemented as one or more microprocessors, microcomputers, microcontrollers, digital signal processors, central processing units, state machines, logic circuitries, and/or any devices that manipulate signals based on operational instructions. For example, the processor(s) 2128 can be one or more hardware processors and/or logic circuits of any suitable type specifically programmed or configured to execute the algorithms and processes described herein. The processor(s) 2128 can be configured to fetch and execute computer-readable instructions stored in the computer-readable media 2130, which can program the processor(s) 2128 to perform the functions described herein.

The computer-readable media 2130 can include volatile and nonvolatile memory and/or removable and non-removable media implemented in any type of technology for storage of information, such as computer-readable instructions, data structures, program components, or other data. Such computer-readable media 2130 can include, but is not limited to, RA M, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 2104, the computer-readable media 2130 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 2130 can be used to store any number of functional components that are executable by the processor(s) 2128. In many implementations, these functional components comprise instructions or programs that are executable by the processors 2128 and that, when executed, specifically configure the one or more processors 2128 to perform the actions attributed above to the merchant platform 1910, the P2P platform 1912, and/or the media content platform 1914. Functional components stored in the computer-readable media 2130 can optionally include a cryptography component 2136, a transfer component 2138, and one or more other components and data 2140. The computer-readable media 2130 can additionally include an operating system 2142 for controlling and managing various functions of the server(s) 2104.

In some examples, the cryptography component 2136 can encryption, decryption, key generation, key share generation, signature generation, signature verification, or a combination thereof.

In some examples, the transfer component 2138 can perform secure transfers of key data, data assets (e.g., cryptocurrencies), or a combination thereof.

The payment component can be configured to receive transaction data from POS systems. The payment component can transmit requests (e.g., authorization, capture, settlement, etc.) to payment service server computing device(s) to facilitate POS transactions between merchants and customers. The payment component can communicate the successes or failures of the POS transactions to the POS systems.

The training component can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 2102 and/or the server(s) 2104 for use at a time after the data models have been trained (e.g., at runtime).

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 2134 can include one or more interfaces and hardware components for enabling communication with various other devices, such as over the network(s) 2106 or directly. For example, communication interface(s) 2134 can enable communication through one or more network(s) 2106, which can include, but are not limited any type of network known in the art, as described herein.

The server(s) 2104 can further be equipped with various I/O devices 2132. Such I/O devices 2132 can include a display, various user interface controls (e.g., buttons, joystick, keyboard, mouse, touch screen, biometric or sensory input devices, etc.), audio speakers, connection ports and so forth.

In at least one example, the system 2100 can include a datastore 2144 that can be configured to store data that is accessible, manageable, and updatable. In some examples, the datastore 2144 can be integrated with the user device 2102 and/or the server(s) 2104. In other examples, as shown in FIG. 23, the datastore 2144 can be located remotely from the server(s) 2104 and can be accessible to the server(s) 2104. The datastore 2144 can comprise multiple databases and/or servers connected locally and/or remotely via the network(s) 2106. In at least one example, the datastore 2144 can store user profiles, which can include merchant profiles, customer profiles, artist profiles, and so on.

In some implementations, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPU s), an input/output interface, a network interface, and/or a memory.

The devices, modules, and other functional units described in this disclosure can be implemented by hardware, or software, or a combination of hardware and software. In some embodiments, functions described as being implemented in hardware may instead be implemented in software or a combination of hardware and software. Likewise, in some embodiments, functions described as being implemented in software may instead be implemented in hardware or a combination of hardware and software. If something is implemented by software, it may be stored in a non-transitory computer-readable media, like the computer-readable media described above. Such software, when executed by a processor, may perform the function of the device, module or other functional unit the software is implementing. The above-described devices, modules, and other functions units may also be combined or may be further divided into a plurality of sub-units.

In some places reference is made to standards, including standard methods of performing some task. These standards are revised from time to time, and, unless explicitly stated otherwise, reference to standards in this disclosure refer to the most recent published standard as of the time of filing.

Spatially relative terms, such as “under”, “below”, “lower”, “over”, “upper” and the like, may be used herein for ease of description to describe one element or feature's relationship to another when the apparatus is right side up.

When a feature is referred to as being “on” another feature, the feature may be directly on the other feature with no intervening features present or it may be indirectly on the other feature with intervening features being present. In contrast, when a feature is referred to as being “directly on” another feature, the feature is directly on the other feature with no intervening features present. It will also be understood that, when a feature is referred to as being “connected”, “attached” or “coupled” to another feature, the feature may be directly connected, attached or coupled to the other feature with no intervening features present or it may be indirectly connected, attached or coupled to the other feature with intervening features being present. In contrast, when a feature is referred to as being “directly connected”, “directly attached” or “directly coupled” to another feature, the feature is directly connected, directly attached, or directly coupled to the other feature with not intervening features present.

The terms “about” and “approximately” shall generally mean an acceptable degree of error or variation for the quantity measured given the nature or precision of the measurements. Typical, exemplary degrees of error or variation are within 20%, preferably within 10%, more preferably within 5%, and still more preferably within 1% of a given value or range of values. Numerical quantities given in this description are approximate unless stated otherwise, meaning that the term “about” or “approximately” can be inferred when not expressly stated.

Ordinal numbers or terms such as “first” and “second” are used only to differentiate an entity or operation from another entity or operation, and do not require or imply any actual relationship or sequence between these entities or operations. Thus, a first feature or element could be termed a second feature or element, and similarly, a second feature or element could be termed a first feature or element without departing from the teachings of the present disclosure. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the terms “or” and “at least one of” encompasses all possible combinations, except where infeasible. For example, if it is stated that a component may include “A or B,” then, unless specifically stated otherwise or infeasible, the component may include “A,” “B,” or “A and B.” As a second example, if it is stated that a component includes “at least one of A, B, or C,” then, unless specifically stated otherwise or infeasible, the component may include “A,” “B,” “C,” “A and B,” “A and C,” “B and C,” or “A, B, and C.” This same construction applies to longer lists (e.g., “may include A, B, C, or D”).

As used herein, the singular forms “a”, “an,” and “the” are intended to include the plural forms as well, unless the context clearly indicates otherwise.

Any statements in this disclosure criticizing or disparaging aspects of the prior art are not intended to indicate that what is claimed excludes any of those criticized or disparaged aspects of the prior art.

Any given element or step of the embodiments disclosed above may be embodied in a single element or step or may be embodied in multiple elements or steps. Moreover, any given element or step of the embodiments disclosed above may be combined and embodied in single element or step or may be combined and embodied in multiple elements or steps.

The sequence of steps shown in the various figures are only for illustrative purposes and do not necessarily indicate that embodiments of the present disclosure are limited to any particular sequence of steps. As such, steps performed by various embodiments of the present disclosure can be performed in a different order while implementing the same method.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

Embodiments of the present disclosure can be implemented at least according to the following clauses:

Clause 1. A method for transferring key data associated with a cryptocurrency wallet, the method comprising: receiving, at a server, an encrypted private key that is encrypted using a private key encryption key, wherein the encrypted private key and the private key encryption key are associated with a benefactor; receiving, at a server, an encrypted private key encryption key that is encrypted using a trusted contact encryption key, wherein the encrypted private key encryption key is an encrypted variant of the private key encryption key; receiving, at a server, an inheritance claim associated with a beneficiary; sending, from the server to the benefactor, a communication, wherein the communication includes an interactive element that is configured to trigger an alert to be sent to the server; sending the encrypted private key and the encrypted private key encryption key from the server to a beneficiary device associated with the beneficiary automatically in response to a lack of receipt of the alert for a predetermined amount of time after the sending of the communication; receiving, at the server and from the beneficiary device, a request for a transfer of funds from a benefactor account associated with the benefactor, wherein the request is signed using a private key, the private key having been decrypted from the encrypted private key by the beneficiary device using the private key encryption key, the private key encryption key having been decrypted from the encrypted private key encryption key by the beneficiary device using a trusted contact decryption key corresponding to the trusted contact encryption key; and facilitating, by the server, the transfer of funds from the benefactor account in response to the request.

Clause 2. The method of Clause 1, wherein the trusted contact encryption key is a public key, and wherein the trusted contact decryption key is a private key corresponding to the public key.

Clause 3. The method of any one of Clauses 1 to 2, wherein receiving the inheritance claim includes receiving the inheritance claim from at least one of the beneficiary device or a second device associated with the beneficiary.

Clause 4. The method of any one of Clauses 1 to 3, wherein facilitating the transfer of funds includes causing a block to be generated and appended to a distributed ledger, wherein the block includes a payload with data indicative of the transfer of funds.

Clause 5. The method of any one of Clauses 1 to 4, wherein the transfer of funds is a transfer of a cryptocurrency from the benefactor account to a beneficiary account associated with the beneficiary.

Clause 6. A method for transferring cryptographic data, the method comprising: receiving an encrypted private key that is encrypted using a private key encryption key, wherein the encrypted private key and the private key encryption key are associated with a transferor; receiving an encrypted private key encryption key that is encrypted using a trusted contact encryption key, wherein the encrypted private key encryption key is an encrypted variant of the private key encryption key; receiving an indication that a condition is satisfied; sending the encrypted private key and the encrypted private key encryption key to a transferee device associated with the transferee; receiving, from the transferee device, a request for a transfer of funds from a transferor account associated with the transferor, wherein the request is signed using a private key, the private key having been decrypted from the encrypted private key using the private key encryption key, the private key encryption key having been decrypted from the encrypted private key encryption key using a trusted contact decryption key corresponding to the trusted contact encryption key; and facilitating the transfer of funds from the transferor account in response to the request.

Clause 7. The method of Clause 6, wherein the condition is associated with an inheritance from the transferor to the transferee.

Clause 8. The method of any one of Clauses 6 to 7, wherein the condition is associated with a death of the transferor.

Clause 9. The method of any one of Clauses 6 to 8, wherein the indication that the condition is satisfied is an inheritance claim.

Clause 10. The method of Clause 9, wherein receiving the indication that the condition is satisfied includes receiving the inheritance claim from at least one of the transferee device or a second device associated with the transferee.

Clause 11. The method of any one of Clauses 6 to 10, wherein the condition is associated with an event that has a plurality of possible outcomes, wherein the indication that the condition is satisfied is an indication of a specific outcome of the event, and wherein the plurality of possible outcomes includes the specific outcome.

Clause 12. The method of any one of Clauses 6 to 11, wherein the trusted contact encryption key is a public key, and wherein the trusted contact decryption key is a private key corresponding to the public key.

Clause 13. The method of any one of Clauses 6 to 12, further comprising: sending, to the transferor, a communication, wherein the communication includes an interactive element that is configured to trigger an alert, wherein sending the encrypted private key and the encrypted private key encryption key to the transferee device is performed automatically in response to a lack of receipt of the alert for a predetermined amount of time after the sending of the communication.

Clause 14. The method of Clause 13, wherein sending the communication to the transferor includes sending the communication to the transferor through at least one of email, text messaging, a phone call, or an application.

Clause 15. The method of any one of Clauses 13 to 14, wherein the interactive element is a hyperlink that leads to a network address that triggers the alert.

Clause 16. The method of any one of Clauses 6 to 15, wherein facilitating the transfer of funds includes causing a block to be appended to a distributed ledger, wherein the block includes a payload with data indicative of the transfer of funds.

Clause 17. The method of any one of Clauses 6 to 16, wherein the transfer of funds is a transfer of a cryptocurrency from the transferor account to a transferee account associated with the transferee.

Clause 18. A system for transferring cryptographic data, the system comprising: a memory that stores instructions; and a processor, wherein execution of the instructions by the processor causes the processor to: receive an encrypted private key that is encrypted using a private key encryption key, wherein the encrypted private key and the private key encryption key are associated with a transferor; receive an encrypted private key encryption key that is encrypted using a trusted contact encryption key, wherein the encrypted private key encryption key is an encrypted variant of the private key encryption key; receive an indication that a condition is satisfied; send the encrypted private key and the encrypted private key encryption key to transferee device associated with the transferee; receive, from the transferee device, a request for a transfer of funds from a transferor account associated with the transferor, wherein the request is signed using a private key, the private key having been decrypted from the encrypted private key using the private key encryption key, the private key encryption key having been decrypted from the encrypted private key encryption key using a trusted contact decryption key corresponding to the trusted contact encryption key; and facilitate the transfer of funds from the transferor account in response to the request.

Clause 19. The system of Clause 18, wherein the condition is associated with an inheritance from the transferor to the transferee.

Clause 20. The system of any one of Clauses 18 to 19, wherein the execution of the instructions by the processor causes the processor to: send, to the transferor, a communication, wherein the communication includes an interactive element that is configured to trigger an alert, wherein sending the encrypted private key and the encrypted private key encryption key to the transferee device is performed automatically in response to a lack of receipt of the alert for a predetermined amount of time after the sending of the communication.

Clause 21. The system of Clause 18, further comprising any of the limitations of any one of Clauses 7 to 16.

Clause 22. A non-transitory computer-readable medium having stored thereon instructions that, when executed by one or more processors, cause the one or more processors to perform operations according to any one of Clauses 1 to 21.

Clause 23. An apparatus comprising one or more means for performing operations according to any one of Clauses 1 to 21.

1. A method for transferring key data associated with a cryptocurrency wallet, the method comprising:
receiving, at a server, an encrypted private key that is encrypted using a private key encryption key, wherein the encrypted private key and the private key encryption key are associated with a benefactor;
receiving, at a server, an encrypted private key encryption key that is encrypted using a trusted contact encryption key, wherein the encrypted private key encryption key is an encrypted variant of the private key encryption key;
receiving, at a server, an inheritance claim associated with a beneficiary;
sending, from the server to the benefactor, a communication, wherein the communication includes an interactive element that is configured to trigger an alert to be sent to the server;
sending the encrypted private key and the encrypted private key encryption key from the server to a beneficiary device associated with the beneficiary automatically in response to a lack of receipt of the alert for a predetermined amount of time after the sending of the communication;
receiving, at the server and from the beneficiary device, a request for a transfer of funds from a benefactor account associated with the benefactor, wherein the request is signed using a private key, the private key having been decrypted from the encrypted private key by the beneficiary device using the private key encryption key, the private key encryption key having been decrypted from the encrypted private key encryption key by the beneficiary device using a trusted contact decryption key corresponding to the trusted contact encryption key; and
facilitating, by the server, the transfer of funds from the benefactor account in response to the request.

2. The method of claim 1, wherein the trusted contact encryption key is a public key, and wherein the trusted contact decryption key is a private key corresponding to the public key.

3. The method of claim 1, wherein receiving the inheritance claim includes receiving the inheritance claim from at least one of the beneficiary device or a second device associated with the beneficiary.

4. The method of claim 1, wherein facilitating the transfer of funds includes causing a block to be generated and appended to a distributed ledger, wherein the block includes a payload with data indicative of the transfer of funds.

5. The method of claim 1, wherein the transfer of funds is a transfer of a cryptocurrency from the benefactor account to a beneficiary account associated with the beneficiary.

6. A method for transferring cryptographic data, the method comprising:
receiving an encrypted private key that is encrypted using a private key encryption key, wherein the encrypted private key and the private key encryption key are associated with a transferor;
receiving an encrypted private key encryption key that is encrypted using a trusted contact encryption key, wherein the encrypted private key encryption key is an encrypted variant of the private key encryption key;
receiving an indication that a condition is satisfied;
sending the encrypted private key and the encrypted private key encryption key to a transferee device associated with the transferee;
receiving, from the transferee device, a request for a transfer of funds from a transferor account associated with the transferor, wherein the request is signed using a private key, the private key having been decrypted from the encrypted private key using the private key encryption key, the private key encryption key having been decrypted from the encrypted private key encryption key using a trusted contact decryption key corresponding to the trusted contact encryption key; and
facilitating the transfer of funds from the transferor account in response to the request.

7. The method of claim 6, wherein the condition is associated with an inheritance from the transferor to the transferee.

8. The method of claim 6, wherein the condition is associated with a death of the transferor.

9. The method of claim 6, wherein the indication that the condition is satisfied is an inheritance claim.

10. The method of claim 9, wherein receiving the indication that the condition is satisfied includes receiving the inheritance claim from at least one of the transferee device or a second device associated with the transferee.

11. The method of claim 6, wherein the condition is associated with an event that has a plurality of possible outcomes, wherein the indication that the condition is satisfied is an indication of a specific outcome of the event, and wherein the plurality of possible outcomes includes the specific outcome.

12. The method of claim 6, wherein the trusted contact encryption key is a public key, and wherein the trusted contact decryption key is a private key corresponding to the public key.

13. The method of claim 6, further comprising:
sending, to the transferor, a communication, wherein the communication includes an interactive element that is configured to trigger an alert, wherein sending the encrypted private key and the encrypted private key encryption key to the transferee device is performed automatically in response to a lack of receipt of the alert for a predetermined amount of time after the sending of the communication.

14. The method of claim 13, wherein sending the communication to the transferor includes sending the communication to the transferor through at least one of email, text messaging, a phone call, or an application.

15. The method of claim 13, wherein the interactive element is a hyperlink that leads to a network address that triggers the alert.

16. The method of claim 6, wherein facilitating the transfer of funds includes causing a block to be appended to a distributed ledger, wherein the block includes a payload with data indicative of the transfer of funds.

17. The method of claim 6, wherein the transfer of funds is a transfer of a cryptocurrency from the transferor account to a transferee account associated with the transferee.

18. A system for transferring cryptographic data, the system comprising:
a memory that stores instructions; and
a processor, wherein execution of the instructions by the processor causes the processor to:
receive an encrypted private key that is encrypted using a private key encryption key, wherein the encrypted private key and the private key encryption key are associated with a transferor;
receive an encrypted private key encryption key that is encrypted using a trusted contact encryption key, wherein the encrypted private key encryption key is an encrypted variant of the private key encryption key;
receive an indication that a condition is satisfied;
send the encrypted private key and the encrypted private key encryption key to transferee device associated with the transferee;
receive, from the transferee device, a request for a transfer of funds from a transferor account associated with the transferor, wherein the request is signed using a private key, the private key having been decrypted from the encrypted private key using the private key encryption key, the private key encryption key having been decrypted from the encrypted private key encryption key using a trusted contact decryption key corresponding to the trusted contact encryption key; and
facilitate the transfer of funds from the transferor account in response to the request.

19. The system of claim 18, wherein the condition is associated with an inheritance from the transferor to the transferee.

20. The system of claim 18, wherein the execution of the instructions by the processor causes the processor to:
send, to the transferor, a communication, wherein the communication includes an interactive element that is configured to trigger an alert, wherein sending the encrypted private key and the encrypted private key encryption key to the transferee device is performed automatically in response to a lack of receipt of the alert for a predetermined amount of time after the sending of the communication.
